(19) United States
(12) Patent Application Publication
(10) Pub. No.: US 2025/0086408 A1
(43) Pub. Date: Mar. 13, 2025

(54) DATA ADAPTION FOR SIGN LANGUAGE TRANSLATION

(71) Applicant: Sorenson IP Holdings, LLC, Salt Lake City, UT (US)

(72) Inventors: David Thomson, Bountiful, UT (US); Mason Acree, American Fork, UT (US)

(21) Appl. No.: 18/957,561

(22) Filed: Nov. 22, 2024

Related U.S. Application Data
(60) Provisional application No. 63/602,301, filed on Nov. 22, 2023.

(51) Int. Cl. G06F 40/58; G06V 20/40; G06V 40/20; G09B 21/00; G11B 27/02

(52) U.S. Cl. CPC G06F 40/58; G06V 20/46; G06V 40/28; G09B 21/009; G11B 27/02

(57) ABSTRACT

A method may include obtaining a first video that includes sign language content. In some embodiments, the sign language content may include one or more video frames of a figure performing sign language. The method may also include obtaining language data that represents the sign language content in the first video and creating a second video including sign language content by altering the first video. The method may further include training a machine learning model of a translation system configured to translate between sign language and language data using the second video and the language data.

### CROSS-REFERENCE TO RELATED APPLICATION

This application claims priority to U.S. Provisional Patent Application No. 63/602,301 filed on Nov. 22, 2023, the disclosure of which is incorporated herein by reference in its entirety.

### FIELD

The embodiments discussed herein are related to data adaption for sign language translation.

### BACKGROUND

Traditional communication systems, such as standard and cellular telephone systems, enable verbal communications between people at different locations. Communication systems for hard-of-hearing individuals may also enable non-verbal communications instead of, or in addition to, verbal communications. Some communication systems for hard-of-hearing people enable communications between communication devices for hard-of-hearing people and communication systems for hearing users.

The subject matter claimed herein is not limited to embodiments that solve any disadvantages or that operate only in environments such as those described above. Rather, this background is only provided to illustrate one example technology area where some embodiments described herein may be practiced.

### SUMMARY

A method may include obtaining a first video that includes sign language content. In some embodiments, the sign language content may include one or more video frames of a figure performing sign language. The method may also include obtaining language data that represents the sign language content in the first video and creating a second video including sign language content by altering the first video. The method may further include training a machine learning model of a translation system configured to translate between sign language and language data using the second video and the language data.

### BRIEF DESCRIPTION OF THE DRAWINGS

Example embodiments will be described and explained with additional specificity and detail through the use of the accompanying drawings in which:

FIG. 1 illustrates an example environment for sign language processing;

FIGS. 2A-2C illustrates example environments for training machine learning models;

FIG. 3 illustrates a flowchart of an example method to train a sign language recognition system;

FIG. 4 illustrates a flowchart of an example method to train a sign language generation system;

FIG. 5 illustrates a flowchart of another example method to train a sign language recognition system;

FIG. 6 illustrates a flowchart of another example method to train a sign language recognition system;

FIG. 7 illustrates a flowchart of another example method for sign language processing;

FIG. 8 illustrates a flowchart of example method for training machine learning models;

FIG. 9 illustrates an example environment for data augmentation;

FIG. 10 illustrates a flowchart of example method for data augmentation;

FIG. 11 illustrates an example environment for text adaptation for sign language generation;

FIG. 12 illustrates an example environment for context-enhanced translation;

FIG. 13 illustrates a flowchart of an example method for context-enhanced translation;

FIG. 14 illustrates an example environment for training via voice messages;

FIG. 15 illustrates a flowchart of an example method for training via voice messages;

FIG. 16 illustrates an example environment for switching between translation processes;

FIG. 17 illustrates a flowchart of an example method for switching between translation processes;

FIG. 18 illustrates an example environment for sign language processing;

FIG. 19 illustrates a flowchart of an example method for sign language processing;

FIG. 20 illustrates an example environment for sign language processing between parties;

FIG. 21 illustrates a flowchart of an example method for sign language processing between parties; and

FIG. 22 illustrates an example system that may be used during sign language processing.

### DETAILED DESCRIPTION

Systems may be designed to allow persons with hearing or speech disabilities, such as those using sign language, to use video equipment to communicate with others via a typical voice telephone service, such as a phone call on a mobile device. As an example, these systems may be referred to as a video relay service (VRS). For example, in a video relay service, a deaf person may engage in a communication session with a hearing person. Video may be captured that includes sign language content generated by the deaf person and sent to an interpreter. The interpreter may interpret the sign language content and generate audio that includes an audio interpretation of the sign language content (e.g., spoken words). The audio may be sent to a hearing person. The hearing person may respond by generating audio that is sent to the interpreter. The interpreter may listen to the audio and generate sign language content that is captured in a video and provided back to the deaf person. In this manner, the deaf person may communicate via a phone call with a hearing person.

Some embodiments in the present disclosure relate to systems and/or methods of sign language processing with respect to a VRS system or other systems. Sign language processing may include converting one form of language data to another form of language data. Language data may include data that represents or encodes human language. For example, language data may include text data, audio data, and sign language data. More specifically, sign language processing may include sign language generation that includes generating sign language data from other forms of language data. Sign language processing may also include sign language recognition that includes converting sign language data to other forms of language data.

Some embodiments in the present disclosure may also relate to systems and/or methods of training automated sign language processing systems in the context of a VRS system. For example, to train automated sign language processing, data sets of examples of sign language generation and sign language recognition may be used. Some embodiments in the present disclosure relate to methods to capture examples of sign language generation and sign language recognition in a VRS system for use in training automated sign language processing systems.

Some embodiments in the present disclosure may also relate to systems and/or methods for improving automated sign language processing by providing data in addition to language data in an automated sign language processing system. The additional data may improve an ability to process the language data. For example, contextual data, historical data, summarizations, or other information may be provided along with language data to improve converting language data from one form to another.

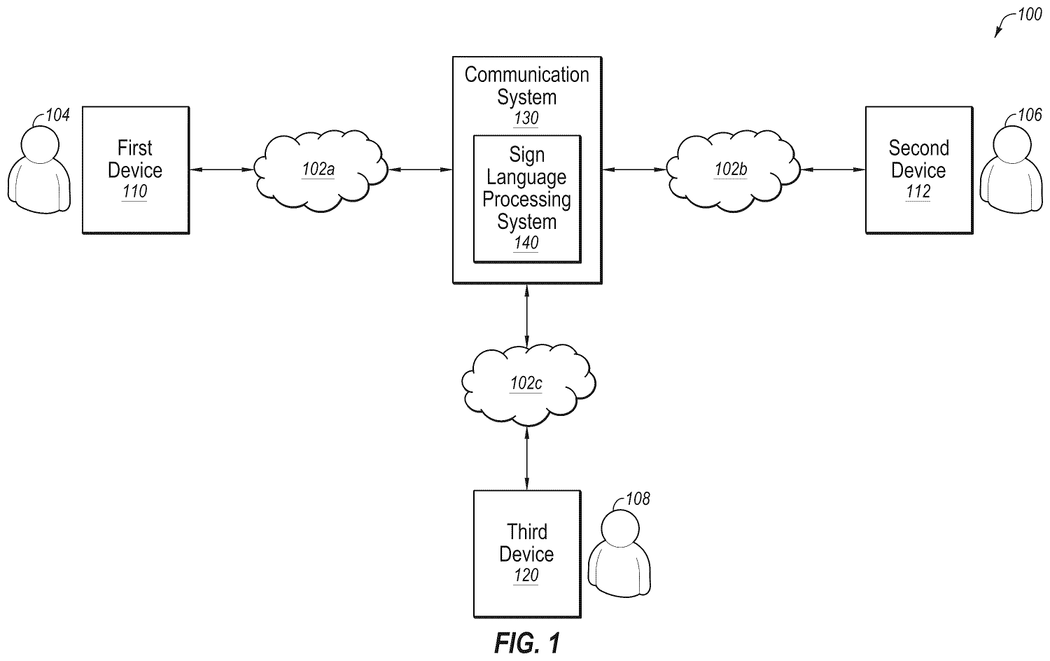

Turning to the figures, FIG. 1 illustrates an example environment 100 for sign language processing. The environment 100 may be arranged in accordance with at least one embodiment described in the present disclosure. The environment 100 may include a first network 102a; a second network 102b; a third network 102c; a first device 110; a first user 104; a second device 112; a second user 106; a third device 120; a third user 108; and a communication system 130 that includes a sign language processing system 140.

The first network 102a may be configured to communicatively couple the first device 110 and the communication system 130. The second network 102b may be configured to communicatively couple the second device 112 and the communication system 130. The third network 102c may be configured to communicatively couple the third device 120 and the communication system 130.

In some embodiments, the first network 102a, the second network 102b, and the third network 102c, referred to collectively as networks 102, may each include any network or configuration of networks configured to send and receive communications between devices and/or systems. In some embodiments, the networks 102 may each include a conventional type of network, a wired or wireless network, and may have numerous different configurations. Furthermore, the networks 102 may each include a local area network (LAN), a wide area network (WAN) (e.g., the Internet), or other interconnected data paths across which multiple devices and/or entities may communicate.

In some embodiments, the networks 102 may each include a peer-to-peer network. The networks 102 may also each be coupled to or may include portions of a telecommunications network for sending data in a variety of different communication protocols. In some embodiments, the networks 102 may each include Bluetooth® communication networks or cellular communication networks for sending and receiving communications and/or data. The networks 102 may also each include a mobile data network that may include fourth-generation (4G), fifth-generation (5G), long-term evolution (LTE), long-term evolution advanced (LTE-A), Voice-over-LTE (“VOLTE”) or any other mobile data network or combination of mobile data networks. Further, the networks 102 may each include one or more IEEE 802.11 wireless networks. In some embodiments, the networks 102 may be configured in a similar manner or a different manner. In some embodiments, the networks 102 may share various portions of one or more networks. For example, each of the networks 102 may include the Internet or some other network.

The first device 110, the second device 112, and/or the third device 114 may be any electronic or digital device. For example, the first device 110, the second device 112, and/or the third device 114 may include or may be included in a desktop computer, a laptop computer, a smartphone, a mobile phone, a tablet computer, a smart television, a wearable device such as smart glasses, or any other electronic device with a processor that is configured to enable user communication. In some embodiments, the first device 110, the second device 112, and/or the third device 114 may each include computer-readable-instructions stored on one or more computer-readable media that are configured to be executed by one or more processors to perform operations described in this disclosure.

In some embodiments, each of the second device 112 and the third device 120 may be configured to obtain audio and broadcast audio. As used in this disclosure, the term audio or audio signal may be used generically to refer to sounds that may include spoken words. Furthermore, the term “audio” or “audio data” may be used generically to include audio in any format, such as a digital format, an analog format, or a propagating wave format. In these and other embodiments, each of the second device 112 and the third device 120 may be configured to provide obtained audio to the communication system 130.

As an example of obtaining audio, the second device 112 may be configured to obtain audio from the first user 104. For example, the second device 112 may obtain the audio from a microphone of the second device 112 or from another device that is communicatively coupled to the second device 112. The third device 120 may also be configured to obtain audio from the third user 108. As an example of broadcasting audio, the second device 112 may be configured to obtain audio from the communication system 130 and broadcast the audio via a speaker.

In some embodiments, each of the first device 110 and the third device 120 may be configured to obtain video and present video. As used in this disclosure, the term video or video data may be used generically to refer to a sequence of images. Furthermore, the term video or video data may be used generically to include video in any format, such as a digital format, an analog format, a compressed format, or any other format. In these and other embodiments, each of the first device 110 and the third device 120 may be configured to provide obtained video to the communication system 130.

As an example of obtaining video, the first device 110 may be configured to obtain first video from the first user 104. For example, the first device 110 may obtain the first video from a camera of the first device 110 or from another device that is communicatively coupled to the first device 110. The third device 120 may also be configured to obtain video from the third user 108. As an example of presenting video, the third device 120 may be configured to obtain video from the communication system 130 and present the video via a display.

In some embodiments, each of the first device 110, the second device 112, and the third device 120 may be configured to establish communication sessions with other devices, such as the communication system 130. For example, each of the first device 110, the second device 112, and the third device 120 may be configured to establish an outgoing communication session, such as a telephone call, Voice over Internet Protocol (VOIP) call, video call, or conference call, among other types of outgoing communication sessions, with another device over the networks 102. In some embodiments, each of the first device 110, the second device 112, and the third device 114 may be configured to communicate, receive data from, and direct data to the communication system 130 during a communication session that involves the communication system 130.

In some embodiments, the first device 110 may be associated with the first user 104. The first device 110 may be associated with the first user 104 based on the first user 104 being the owner of the first device 110 and/or being controlled by the first user 104. For example, the first device 110 may be controlled by the first user 104 when the first device 110 is obtaining commands and input from the first user 104. In some embodiments, the first user 104 may be a sign language capable person. As used in this disclosure, the term “sign language capable person” is meant to encompass people who are deaf, people who are hard of hearing, anyone else using sign language for communication such as those who sign, understand sign language, or both. A person who communicates using sign language may be designated as a sign language capable person independent of their ability to hear or speak.

In some embodiments, the second device 112 may be associated with the second user 106. The second device 112 may be associated with the second user 106 based on the second user 106 being the owner of the second device 112 and/or being controlled by the second user 106. In some embodiments, the second user 106 may be a sign language capable person or a sign language incapable person. As used in this disclosure, the term “sign language incapable person” is meant to encompass people who cannot or choose not to communicate via sign language. A sign language incapable person may be designated as a sign language incapable person independent of their ability to sign if they choose not to sign.

In some embodiments, the third device 120 may be associated with the third user 108. The third device 120 may be associated with the third user 108 based on the third user 108 being the owner of the third device 120 and/or being controlled by the third user 108. In some embodiments, the third user 108 may be a sign language capable person that is also capable of speaking.

In some embodiments, the communication system 130 may include any configuration of hardware, such as processors, servers, databases, and data storage that are networked together and configured to perform one or more tasks. For example, the communication system 130 may include multiple computing systems, such as multiple servers that each include memory and at least one processor, which are networked together and configured to perform operations as described in this disclosure, among other operations. In some embodiments, the communication system 130 may include computer-readable-instructions on one or more computer-readable media, such as data storage or databases that are configured to be executed by one or more processors in the communication system 130 to perform operations described in this disclosure. Generally, the communication system 130 may be configured to establish and manage communication sessions between the first device 110, the second device 112, and the third device 120. The sign language processing system 140 may be a combination of hardware, such as processors, servers, databases, and data storage that are networked together and configured to perform one or more tasks. In some embodiments, the sign language processing system 140 may be configured to train one or more machine learning models using language data obtained from one or more of the first device 110, the second device 112, and the third device 120.

An example of the interaction of the elements illustrated in the environment 100 is now provided. As described below, the elements illustrated in the environment 100 may interact to establish a communication session between the first device 110 and the second device 112 to allow the first user 104 and the second user 106 to communicate. In these and other embodiments, the third device 120 may be an intermediary device that assists in translating language data obtained from the first device 110 to another form of language data appropriate for the second user 106 and directing the other form of language data to the second device 112 via the communication system 130.

In some embodiments, the first device 110 may send a notification to the communication system 130 requesting a communication session with the second device 112. Alternately or additionally, the first device 110 may send a notification to the second device 112, which may interact with the communication system 130. In response to the notification, the communication system 130 may establish a communication session with the second device 112 and with the third device 120. In these and other embodiments, the first device 110 may be communicating with the third device 120 and the second device 112 may be communicating with the third device 120. In some embodiments, the communications between the first device 110 and the third device 120 may be through the communication system 130 or may occur directly between the first device 110 and the third device 120. In these and other embodiments, the communications between the second device 112 and the third device 120 may be through the communication system 130 or may occur directly between the second device 112 and the third device 120.

During the communication session, first language data may be shared between the first device 110 and the third device 120 and second language data may be shared between the second device 112 and the third device 120. In some embodiments, the first language data may be a first type, and the second language data may be a second type that is different than the first type. In these and other embodiments, the first language data and the second language data may be provided to the sign language processing system 140. In these and other embodiments, the sign language processing system 140 may be configured to use the first language data and/or the second language data as training data for one or more machine learning models configured to convert between the first type and the second type of language data.

For example, the first device 110 may provide first video of the first user 104 that includes sign language content to the third device 120. Sign language content may include one or more video frames of a figure performing sign language. The sign language content may include the signs being performed, body expressions, and other information that may be used to convey information when communicating via sign language.

In some embodiments, the third device 120 may present the first video to the third user 108 via the third device 120. The third user 108 may interpret the sign language in the sign language content into voiced audio, spoken audio, that is a translation of the sign language content. The third device 120 may capture the voiced audio. The voiced audio, which may be referred to as first audio, may be directed to the second device 112. The second device 112 may broadcast the first audio to the second user 106. The second user 106 may respond to the translated audio by voicing second audio that may be captured by the second device 112. The second audio may be directed to the third device 120. The third device 120 may broadcast the second audio to the third user 108. The third user 108 may sign, e.g., perform sign language, that represents the words in the second audio. The third device 120 may capture second video of the signing of the third user 108 such that the second video includes sign language content. The second video may be directed to the first device 110. The first device 110 may be configured to present the second video to the first user 104. As a result, the first user 104 may communicate with the second user 106 using sign language, the second user 106 may communicate with the first user 104 via audio, and the third user 108 may provide interpretation services therebetween.

As another example, the first device 110 may provide first video of the first user 104 that includes sign language content to the third device 120. In some embodiments, the third device 120 may present the first video to the third user 108 via the third device 120. The third user 108 may interpret the sign language in the sign language content and voice audio that is a translation of the sign language content. The third device 120 may capture the voiced audio. The voiced audio, which may be referred to as first audio, may be converted to first text. In this disclosure, the term text may refer to a string of characters, including letters, numbers, and symbols of a spoken language that follows grammar and other conventions associated with the spoken language. Text may refer to generally accepted written forms of a language that would be understood generally and would be akin to written text found in typical documents such as magazines, webpages, and books meant for the general public. A specific type of text may be gloss. Gloss may be a label or a name for a sign. In American Sign Language (ASL), a gloss is an English word that is used to name the ASL sign. The gloss does not necessarily relay the meaning of the sign. Alternately or additionally, the gloss is not necessarily a transcription of the sign and does not necessarily provide information as to how to create or recognize the sign.

As an example, the first audio may be converted to first text using automated speech recognition or any other form of conversion. The first text may be directed to the second device 112 and presented by the second device 112. The second device 112 may obtain second text from the second user 106 in response to the first text. The second text may be directed to the first device 110 and presented to the first user 104. Alternately or additionally, the second text may be directed to the third device 120 and presented to the third user 108. The third user 108 may perform signs captured in the second video that represent the second text and the second video may be directed to the first device 110 and presented to the first user 104.

Other configurations of language data may be shared between the first device 110, the second device 112, and the third device 120. For example, the second device 112 may obtain audio in response to the first text. The third user 108 may perform signs captured in the second video that represent the audio.

In these and other embodiments, the language data passed between the first device 110, the second device 112, and the third device 120 may be provided to the sign language processing system 140. The sign language processing system 140 may use the language data as training data for one or more machine learning models (referred to as models) configured to translate between the different types of language data provided to the sign language processing system 140.

For example, the sign language processing system 140 may be configured to use first video and first audio and/or second video and second audio as training data for models configured to translate between audio and sign language content. For example, the sign language processing system 140 may be configured to use the second video and the second audio as training data for models that are configured for sign language generation. In these and other embodiments, sign language generation may be configured to generate sign language content from other language data. As another example, the sign language processing system 140 may be configured to use the first video and the first text as training data for models that are configured for sign language recognition. In these and other embodiments, sign language recognition may be configured to generate non-sign language information data from sign language content. As another example, the sign language processing system 140 may be configured to use first video and first text and/or second video and second text as training data for models configured to translate between text and sign language content.

In some embodiments, the sign language processing system 140 may be configured to train models for sign language generation and models for the sign language recognition during a communication session. Alternately or additionally, the sign language processing system 140 may be configured to train models for both sign language generation and the sign language recognition during a communication session. For example, the sign language processing system 140 may use the language data to train models for sign language generation and the same language data to train models for sign language recognition. Alternately or additionally, the sign language processing system 140 may use some of the language data, such as video from the first device 110 and audio from the third device 120 to train the models for sign language recognition and use video from the third device 120 and audio from the second device 112 to train models for sign language generation.

In these and other embodiments, the sign language processing system 140 may be configured to generate different models, such as for recognition and generation, based on different signing styles. A signing style may vary based on a skill level or dialect of the sign language. The dialect of sign language may refer to regional variations in how signs are produced where different areas may have differences in handshape, movement, or facial expressions when signing the same words. In these and other embodiments, the sign language processing system 140 may be configured to train models for different skill levels and dialects. Alternately or additionally, the sign language processing system 140 may construct different models based on video from the first users 104 and videos from the third users 108. In these and other embodiments, when the models are being implemented, models that are trained for a particular skill level or dialect may be selected based on the signing of an individual. For example, a system may select first models for a first individual with a first dialect and skill level that may be different from models selected for a second individual. The system may select the models based on an analysis of the signing of the individuals. For example, signing from an individual may be processed using a first model trained on data representing a first dialect or skill level and a second model trained on data representing a second dialect or skill level. Each model may produce a confidence score. If the first model's confidence score is greater than the second model's confidence score, the sign language processing system 140 may determine that the individual has a first dialect or skill level. The sign language processing system 140 may then select the first model for the individual. Alternately or additionally, the system may tune or adapt models to match a signing style of an individual.

In some embodiments, the sign language processing system 140 may use one or more segments of the language data to train the models. Alternately or additionally, a segment of language data may include one or more of words, signs, phrases, sentences, signs spanning one or more select periods of time, and portions, and sign language data such as pauses of the user signing. In these and other embodiments, the segment of language data may be used for training, then deleted. Subsequently, a new segment of language data may then be used for training, then likewise deleted, and so on.

Additionally or alternatively, one or more segments of language data may be retained and used multiple times for training. For example, the training may include multiple training epochs, each epoch using the one or more segments of language data. An epoch may include a training cycle such as a neural network training cycle. After training, the segment(s) may be deleted. The segment(s) may be deleted prior to or at the end of the communication session. Alternately or additionally, the segment(s) may be deleted within a predetermined amount of time after the end of the communication session. In these and other embodiments, the predetermined amount of time may be in a range between 0.1 and 60 seconds, 0.1 and 30 seconds, 0.1 and 10 seconds, 1.0 and 10 seconds, 1.0 and 20 seconds, or some other range. The range may be selected based on the training being performed, applicable laws in the location where the training is occurring, among other aspects of the environment 100.

Additionally or alternatively, the training process may be configured to complete training on the one or more segments within a selected period after the end of the communication session and then delete the segment(s). For example, if a communication session ends while an epoch using one or more segments from the communication session is in progress, the segments may be retained until the epoch is complete. Once the epoch is complete, the segment(s) may be deleted.

Additionally or alternatively, segments may be retained and used multiple times for training if there is sufficient processing power available to process segments multiple times. If processing power is limited, such as when communication session volumes are relatively high, a given segment may be processed fewer times (compared to when there is more processing power available), one time, or not at all.

In some embodiments, the sign language processing system 140 may use the language data from the communication session for training during the communication session. In these and other embodiments, the sign language processing system 140 may use the language data from the communication session for training only during the communication session. As such, the sign language processing system 140 may not use the language data from the communication session for training after the communication session. For example, the sign language processing system 140 may delete the language data during the communication session, at the conclusion of the communication session, or within a selected period after the end of the communication session. Thus, the language data from a communication session may not be perpetual. Rather, the language data from a communication session may be temporary and only used while the communication session is ongoing. For example, once the second device 112 or the first device 110 terminates the communication session, the communication session may end. Alternately or additionally, the communication session may end once each of the first device 110, the second device 112, and the third device 120 have terminated network connections with the communication system 130.

Modifications, additions, or omissions may be made to the environment 100 without departing from the scope of the present disclosure. For example, the environment 100 may include additional devices, such as additional devices similar to the first device 110 or the second device 112. In these and other embodiments, the language data from each of the devices or some of these devices may be provided to the sign language processing system 140.

In some embodiments, the communication system 130 or the first device 110 may be further configured to alter the video generated by the first device 110. For example, the first user 104 may not want every feature of the first user 104 to be part of the video that is presented to the third device 120. In these and other embodiments, either the first device 110 or the communication system 130 may be configured to alter the video based on input obtained from the first user 104. In these and other embodiments, the first user 104 may select or deselect alteration of the video to present the alteration or not present the alteration during the video. Alteration of the video may include altering a background, altering one or more characteristics of the first user 104 as illustrated in the video. For example, the video may be altered to modify facial, body, or other features of the first user 104. For example, the first user 104 may be obscured. In these and other embodiments, facial landmarks (e.g., eyebrow angle or lip distance on the face) may be preserved to allow the third user 108 to read facial expressions but other elements may be discarded that make the person recognizable. Alternately or additionally, emotion tags (e.g., “happy.” “concerned.” etc.) may be preserved instead of landmarks. Alternately or additionally, other parts of the first user 104 or an entirety of the first user 104 may be obscured and landmarks to allow interpretation of signs may be maintained.

In some embodiments, the video may be altered to replace the first user 104 in the video with an avatar of the first user 104. The avatar may mimic the movements of the first user 104 such that avatar performs the sign language that the first user 104 performs. Furthermore, the avatar may mimic facial expressions or other emotions conveyed by the first user 104. In these and other embodiments, the avatar may be generated by analyzing the video to determine the movements of the user and mapping the movements of the avatar to match the movements of the first user 104.

In some embodiments, the characteristics of the avatar may be varied based on input obtained from the first user 104. For example, the avatar may be a 2-D or 3-D cartoon, a photorealistic avatar featuring the face of the first user 104, an enhanced (better looking) version of the first user 104, a figure designed by the first user 104 by specifying the hairstyle, clothing, eye color, and other features meant to represent the first user 104, a Halloween character such as a skeleton, the image of another person such as a celebrity, an image selected by the first user 104 from a menu of options, a stick figure, an art deco or graphic art image, an animal, a plant, a character from a movie, or an inanimate object such as a stuffed animal or a toy.

In some embodiments, the altered video may be presented by other devices and the unaltered video may be provided to the sign language processing system 140 for use in training models. Alternately or additionally, an altered video may be stored by the sign language processing system 140 for training after a communication session rather than during the communication session. Alternately or additionally, the sign language processing system 140 may use an unaltered video as input while an altered video is presented to the second user 106 or the third user 108 or both.

In some embodiments, the communication system 130 may be configured to provide video to both the third device 120 and the second device 112. In these and other embodiments, the video provided to the third device 120 and the second device 112 may be altered for both of one of the third device 120 and the second device 112. Alternately or additionally, the communication system 130 may be configured to allow to two sign language capable people to communicate. For example, the communication system 130 may provide video conferencing between the first device 110 and the second device 112 without the third device 120. In these and other embodiments, the video from each of the first device 110 and the second device 112 may be altered as discussed above. Alternately or additionally, the altered video of the first user 104 may be provided to a gaming system. In these and other embodiments, the altered video may be stored by the sign language processing system 140 for training of models.

In some embodiments, the communication system 130 may be configured to alter the language data to remove personal or sensitive information before video and/or audio is provided to the sign language processing system 140. For example, a speech recognizer and/or sign language recognizer may be configured to determine words, signs, or phrases in the audio and/or video being provided to the sign language processing system 140 that contain potentially sensitive or personal information. Potentially sensitive or personal information may include a Social Security number, physical address, zip code, birth date, credit card information, driver's license number, passport number, bank account number, health information, employment status or history, email address, phone numbers, any numeric string, names, medical conditions or treatments, and biometric data. In these and other embodiments, in response to potentially sensitive or personal information being identified, the information may not be provided to the sign language processing system 140 for training of models.

In some embodiments, other actions may be performed with respect to the third device 120. For example, video from the first device 110 may be in American sign language (ASL). The audio captured by the third device 120 may be any language. As such, the third user 108 may act as an interpreter who translates between language types, such as sign language and spoken language, and between different forms of the language type, such as between different spoken languages, such as Spanish, French, English, Chinese, Japanese, German, etc. In these and other embodiments, the sign language processing system 140 may be configured to train models for each different spoken language to convert between the different audio/text languages and sign language. Alternately or additionally, the communication system 130 may include a translator and may translate the different spoken languages to a single spoken language that is used to train models of the sign language processing system 140. Alternately or additionally, the sign language processing system 140 may be configured to train a different model for each different sign language. For example, the sign language processing system 140 may train first models to process ASL and second models to process Chinese sign language. In these and other embodiments, the models may be trained in corresponding sign and spoken languages. For example, models may be trained using verbal Chinese and Chinese sign. In these and other embodiments, a different spoken language than the sign language may be provided to the sign language processing system 140, but the sign language processing system 140, the communication system 130, or another system may translate the different spoken language to be the same language as the sign language before the models are trained.

In some embodiments, the sign language processing system 140 may not be part of the communication system 130. In these and other embodiments, the sign language processing system 140 may be networked to the communication system 130. Alternately or additionally, the sign language processing system 140 may be part of the first device 110, the second device 112, the third device 120, or some other device. Alternately or additionally, the sign language processing system 140 may be distributed across multiple different devices. In these and other embodiments, the parameters for processing may be generated in a first device and sent to a second device for additional processing.

In some embodiments, the environment 100 may exist without the third device 120. For example, the communication system 130 may perform one or more of the actions described herein with respect to the third device 120 and the third user 108. For example, the communication system 130 may include models for sign language generation and models for sign language recognition. In these and other embodiments, the first device 110 may send video to the communication system 130. The models for the sign language recognition may generate language data, such as audio or text, that is an interpretation of sign language content in video. The communication system 130 may provide the language data to the second device 112 for presentation to the second user 106. In these and other embodiments, the second device 112 may capture language data that is not sign language from the second user 106 and provide the language data to the communication system 130. The models for sign language generation may generate video with sign language data. The video may be sent to the first device 110 for presentation to the first user 104.

In some embodiments, the models for sign language generation may generate images for the video based on the characteristics of the second user 106. For example, characteristics of the second user 106 may be provided to the communication system 130 by the second device 112 or the first device 110. For example, the first device 110 may have stored characteristics of users in their contacts that may be provided to the communication system 130 when the first device 110 requests a communication session with the second device 112. Alternately or additionally, the characteristics may be obtained from an account of the second user 106, from information stored in the communication system 130, from information about the second user 106 from online sources, such as social media, among other sources. In some embodiments, the characteristics may be derived from one or more pictures or videos of the second user 106. Alternately or additionally, the characteristics may include a description of the second user 106. The description may include hair color and length, age, skin color, apparent ethnicity, and a description of any facial hair, glasses, clothing, or jewelry, among others. In these and other embodiments, the models for sign language generation may generate an avatar based on the characteristics of the second user 106 that may be used to produce the sign language in the video generated by the models for sign language generation and provided to the first device 110.

In some embodiments, a communication session may include multiple second device 112 and/or multiple first devices 110. In these and other embodiments, the communication system 130 may be configured to identify the source of the language data for each of the other devices participating in the communication session. In these and other embodiments, the models for sign language interpretation may use different voices in the audio generated for the different first users. Alternately or additionally, the models for sign language recognition may use different avatars in the videos generated for the different second users 106

In some embodiments, multiple second users 106 may be participating via a single second device 112. In these and other embodiments, the communication system 130 and/or the second device 112 may be configured to determine which of the second users 106 are speaking at a given time. For example, the communication system 130 may obtain video from the second device 112 and determine which of the second users 106 are speaking based on the video. Alternately or additionally, the communication system 130 or the second device 112 may be configured to discern different speakers based on the audio using diarization. In these and other embodiments, the models for sign language generation may generate different avatars when the different second users 106 are speaking. Alternately or additionally, the models for sign language generation may generate avatars for each of the different second users 106 at the same time and presented at the same time and have one of the avatars perform sign language based on which of the different second users 106 are speaking.

In some embodiments, the communication system 130 as discussed may obtain video of the second user 106. In these and other embodiments, the communication system 130 may include a sentiment/emotion detector to determine the demeanor of the second user 106. The demeanor may be conveyed to the first device 110. For example, the demeanor may be reflected in the manner of signing used by the models for sign language generation. Additionally or alternatively, the demeanor may be conveyed in text presented by the first device 110 using emoticons (e.g., faces, images, moving images), font changes (e.g., bold font, font size, font style, font colors), highlights, or other decorations.

In some embodiments, the models for sign language recognition may generate text from video from the first device 110. In these and other embodiments, the text may be provided back to the first device 110. In these and other embodiments, the first device 110 may present the text to the first user 104. In these and other embodiments, the first user 104 may use the text to verify that their signs were correctly interpreted by the models for sign language recognition. In these and other embodiments, the first device 110 may generate additional video to clarify any mistakes in the interpretation. Alternately or additionally, the communication system 130 may provide the text and/or audio from the models for sign language recognition to the models for sign language generation. In these and other embodiments, the models for sign language generation may generate video with sign language content that is provided back to the first device 110 to allow the first user 104 to verify that their signs were correctly interpreted by the models for sign language recognition.

In some embodiments, the video generated by the models for sign language generation may be compressed video. Alternately or additionally, the video may not include frames of images with an avatar signing. In these and other embodiments, the video may include a series of poses describing hands and body motion. The first device 110 may convert the poses to images of a person performing the corresponding signs. The person may be a cartoon character, stick figure, avatar, or photorealistic image of a person. Alternately or additionally, the video may include landmarks that may be used by the first device 110 to generate images of a person performing the corresponding signs. Landmarks may include positions, angles, rotations, regions, velocity, and points on a human body such as joints and facial features.

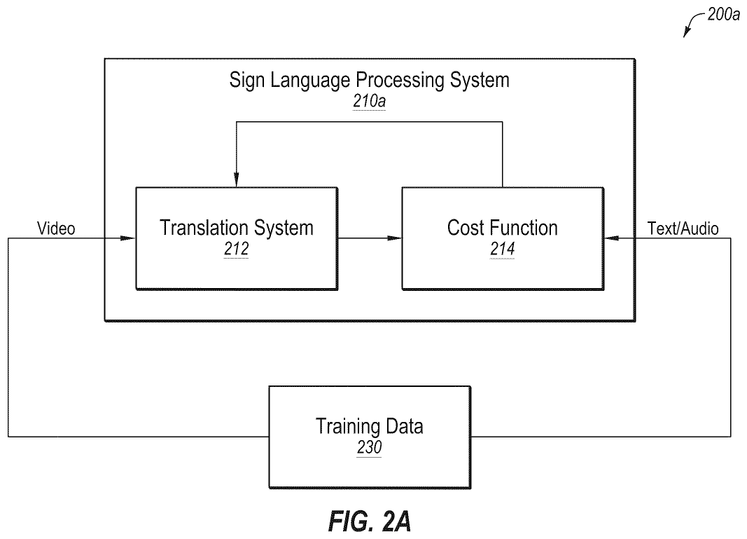

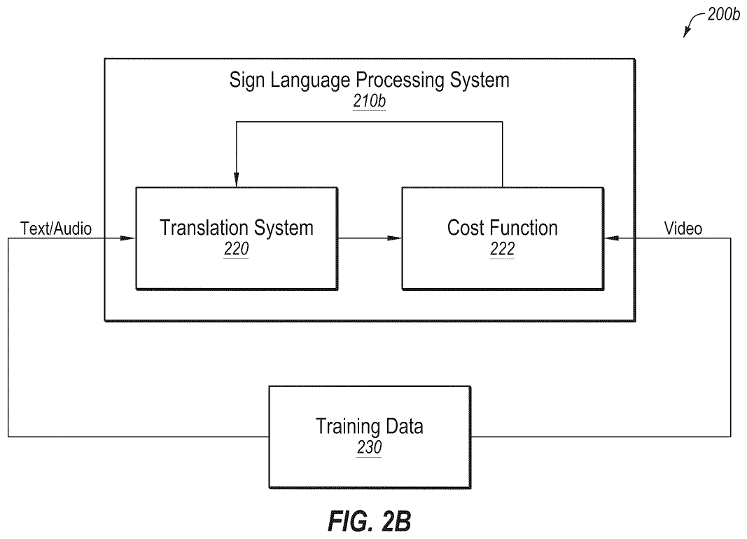

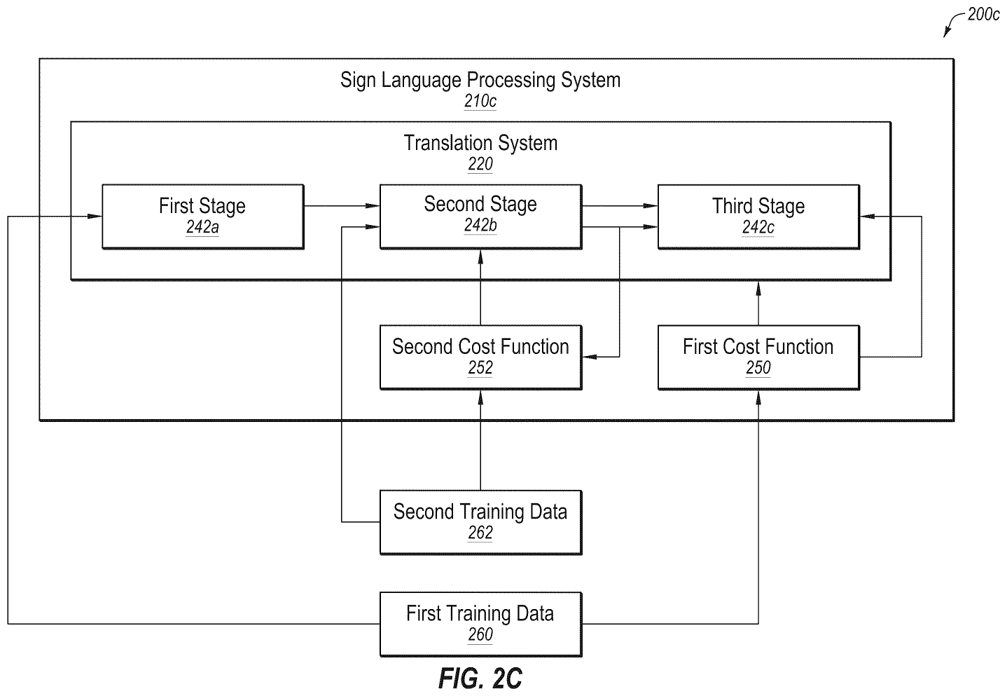

FIGS. 2A-2C illustrate example environments for training machine learning models. The environments 200 may be arranged in accordance with at least one embodiment described in the present disclosure. For example, FIG. 2A illustrates an environment 200a for training models for recognition. FIG. 2B illustrates an environment 200b for training models for generation. FIG. 2C illustrates an environment 200c for training models for recognition. FIGS. 2A-2C include examples of sign language processing systems that may be implemented in the sign language processing system 140 of FIG. 1.

In FIG. 2A, the environment 200a includes a sign language processing system 210a and training data 230. The sign language processing system 210a includes a translation system 212 and a cost function 214. The sign language processing system 210a may be an example of the sign language processing system 140 of FIG. 1 that may be configured to train models using the information data obtained from the communication sessions managed by the communication system 130.

In some embodiments, the translation system 212 may include one or more stages to achieve the functionality of the translation system 212, such as to perform sign language generation or recognition. In these and other embodiments, the stages may pass data therebetween. In some embodiments, the stages may be arranged in parallel, in series, in a combination of parallel and series, connection in recursive connections, or configured with some stages inside other stages, among others.

Each of the stages may perform one or more functions. For example, for sign language recognition to speech, the translation system 212 may include five functions, each of which may be part of a single stage In these and other embodiments, the five functions may include (1) feature extraction, (2) feature-to-pose conversion, (3) pose-to-gloss conversion, (4) gloss-to-text translation, and (5) text-to-speech synthesis. Feature extraction may include extracting features of one or more frames in a video. The features may be the aspects of the video that include information about the pose. A pose may be a representation of positions and/or orientations of parts of a human body. For example, a pose may include information on the position and rotation of finger segments, hands, arms, shoulders, head, etc. The pose may be converted to gloss in the pose-to-gloss conversion. In some embodiments, the functions may be combined in fewer stages than functions. For example, two, three, four, or all the functions may be combined in a single stage or some number of stages less than the number of functions.

In some embodiments, each stage may be trained separately, and the stages may be used together to perform translation of sign language to other language data. Alternately or additionally, two or more of the stages may be trained together or all the stages may be trained together. All the stages being trained together may be referred to as end-to-end training.

In some embodiments, each of the stages may include one or more machine learning models to perform the functions of the stage. Machine learning models may enable machines (e.g., computers, logic circuits, etc.) to use a model to process input data to generate an output based on patterns and/or associations previously learned by the model via a training process. For instance, a model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In general, machine learning models/architectures that are suitable to use in the example approaches disclosed herein may include hidden Markov models (HMMs), support vector machines (SVMs), various types of deep neural networks such as deep neural networks (DNNs) and convolutional neural networks (CNNs), transformers, transformers with attention, contrastive learning models, and generative adversarial networks (GANS). However, other types of machine learning models may additionally or alternatively be used such as, for example, sequence-to-sequence transformer-based models and reinforcement learning models, among others. In these and other embodiments, each of the models may include a set of nodes and parameters such as weights.

In general, implementing machine learning models may involve two phases, a training phase, and an inference phase. Training phases are depicted in FIGS. 2A-2C. The training stage may include adjusting the weights so that the output matches a given desired output for a given input. Training may use a batch of one or more training samples. Alternately or additionally, training may use an optimization method such as gradient descent. In these and other embodiments, the weights may be adjusted by a small amount for each batch of training samples. The adjustment amount may be determined by a gradient and a learning rate. In some embodiments, training may improve a performance of the models. Improving performance may include one or more of: improving accuracy, increasing vocabulary, adding features, improving video quality, and reducing latency. Latency may be defined as the elapsed time between the input to the translator and the corresponding translator output.

After training is complete, the model may be deployed for use in the inference phase as an executable construct that processes an input and provides an output based on the network of nodes and connections defined in the model from the training phase.

In the training phase, a model may be trained to operate in accordance with patterns and/or associations based on training data. In general, the model includes internal parameters that may guide how input data is transformed into output data, such as through a series of nodes and connections within the model to transform input data into output data. For example, a model may be trained by adjusting weights (numerical parameters) of statistical constructs such as neural networks. The weights may not reflect particular language data, but rather may describe how signs may be performed in terms of statistics such as averages and ranges. For example, the weights may define how the word “cat” is signed, including the hand shape, hand motion, where the hand moves relative to the face, how far from a typical location the hand may be, and other performance information. Thus, a model may be trained to know hand shapes, positions, and motion for a sign, alternative ways the sign may appear, how far a sign may deviate from its nominal position and motion before it is considered to be a different sign. Alternately or additionally, a model may be trained to know accompanying body movements for a sign such as turning the shoulders or shaking the head. Alternately or additionally, a model may be trained to know facial expressions that accompany signs in various contexts and how these expressions affect how the gestures should be interpreted. Alternately or additionally, a model may be trained to know ASL usage and language translation rules for translating between a spoken language and sign language grammar.

Additionally, hyperparameters may be used as part of the training process to control how the learning is performed. Hyperparameters are defined to be training parameters that are determined prior to initiating the training process and that may be updated at intervals during training. Some example hyperparameters include a learning rate, a number of layers to be used in the model, an optimization method (which defines what optimization method is used in back propagation such as, for example, the Adam optimization method, SGD, etc.), batch size, number of epochs, learning rate, validation frequency, and dropout, among others.

Referring to FIG. 2A, the translation system 212 may include one or more models that may be configured to be trained. The sign language processing system 210a may be configured to perform the training of the models of the translation system 212. In these and other embodiments, the models of the translation system 212 may be trained to recognize sign language content in video provided to the translation system 212 and output language data that corresponds to the sign language content in the video. As illustrated in FIG. 2A, the sign language processing system 210a may be configured to perform end-to-end training for the models in the translation system 212. End-to-end training may include training one or more internal models substantially simultaneously by adapting the models to produce a desired output.

In some embodiments, to perform the training, the sign language processing system 210a may use the training data 230. The training data 230 may be persistent training data, temporary training data such as videos, audio, and/or text, that are obtained during a communication session as described in FIG. 1 and are deleted at the end of the communication session, or a combination of persistent and temporary training data. For example, in some embodiments, some or all the training data may be generated during communication sessions as described in FIG. 1. Alternately or additionally, some or all the training data 230 may be created by recording audio of an individual translating sign language recorded in a video to audio data or recording video of an individual translating audio data into sign language data.

In some embodiments, the training data 230 may be training data for supervised training. In these and other embodiments, the training data 230 may include audio, text, gloss, posses, or other data that corresponds to sign language in a video. In some embodiments, to generate the training data 230, either the video or the other data may be created first. The other data may be created by a human, machine, or combination thereof. Examples of video data that may be used for training data 230 may include one or more of online video (e.g., YouTube, Vimeo, social media sites, corporate websites), public meetings, broadcast or recorded media such as movies and TV where a signer (e.g., an interpreter) appears in the video, video where an interpreter voices for a signer performing sign language in the video, purchased databases, recorded databases, interpreted presentations, video of interpreted conversations such as video calls, and data collected using smartphone apps such as games, sign language tutorials, sign language video dictionaries, and sign language interpreters. Example of audio data that may be used for training data 230 may include one or more of broadcast or recorded media such as news broadcasts, TV, movies, radio, podcasts, telephone calls, video calls, customer service calls, recordings of public meetings, conference presentations, and event presentations. In some embodiments, the sign language processing system 210a may use text for training. In these and other embodiments, examples of text data that may be used for the training data 230 may include text scraped or downloaded from web pages, e-books, printed text scanned and rendered into text using optical character recognition, transcripts of conversations between people, and chatbot transcripts such as chatbots on websites configured to provide services such as product information and customer service.

In some embodiments, text may be part of the training data 230 but gloss may be desired for training. In these and other embodiments, the text may be converted into gloss. Alternately or additionally, audio may be part of the training data 230 but text may be desired for training. In these and other embodiments, the audio may be converted into text using automated speech recognition (ASR). ASR as described in this disclosure may in some embodiments include an editor that enables a human to assist with transcription, e.g., to transcribe audio to text, to correct text from ASR, or a combination thereof.

In some embodiments, converting audio to text for training data 230 may use a speech recognizer with resources greater than those of an ASR that may run in real-time. The greater resources may provide improved accuracy. The greater resources may include the ASR using neural networks, acoustic models, language models, or other models with a greater number of parameters. Alternately or additionally, the ASR may pass audio through one or more recognizers an increased number of times. In these and other embodiments, at least one recognizer may use results from a previous recognizer to perform recognition. For example, a first recognizer may tune the model during a first pass and a second recognizer may use the tuned model during a second pass. The recognizer may determine energy parameters in a first pass and use the energy parameters, such as by using the energy parameters for energy normalization, during a second pass.

In some embodiments, greater resources may include human editing. In these and other embodiments, the audio may be transcribed using a combination of ASR, human transcription, and human editing. For example, an ASR may transcribe the audio, and an editing tool may enable a human editor to listen to the audio, read the ASR transcript, and make corrections to create an improved transcript. Additionally or alternatively, the human editor may revoice the audio and ASR may convert the human voice to text.

In some embodiments, greater resources may include an ability to process longer segments of audio in a single batch than would be typical in real-time operation. For example, a real-time ASR may process 10-second segments, whereas the ASR used for sign language training may process longer (e.g., 30-120 seconds up to multiple hours) segments.

In some embodiments, greater resources may include combining the results of multiple individual recognizers. Combining multiple recognizer outputs may use fusion or consensus to create a transcription that is more accurate than an individual recognizers alone. For example, audio may be provided to multiple recognizers or multiple configurations of a recognizer to create multiple transcripts. Each transcript may include a confidence score for each word. The transcripts may be aligned so that a hypothesis for a given word in the audio from each recognizer is grouped together with one or more hypotheses from one or more other recognizers. The confidence of each word in the group may be compared with the confidence of other words in the group and the word with the highest confidence may be selected.

In some embodiments, greater resources may include using a speech recognizer to transcribe the audio and using a post-processing step to correct speech recognition errors. The post-processing step may estimate the likelihood that the speech recognizer incorrectly transcribed a given word in the transcript and determine a candidate replacement word. If the likelihood exceeds a selected threshold, the ASR may replace the given word with the candidate replacement word. The post-processing step may use a language model to estimate the likelihood and/or to determine the candidate replacement word. The language model may be a large language model (LLM). The language model may use, as input, one or more of (1) one or more words preceding the given word, (2) one or more words following the given word, (3) a structure derived from content, and (4) a set of one or more prompts giving the LLM instructions for correcting errors. The structure may include a summary of content. The content may include content before, after, or before and after a given word. Additionally or alternatively, the post-processing step may operate on more than one word such as two words, a phrase, or a sentence. Additionally or alternatively, the post-processing step may use as input information from multiple speech recognizers, such as in a fusion arrangement as described in this disclosure.

In some embodiments, greater resources may include operating in batch mode. Batch mode may include using blocks of audio as input. A block of audio may include one or more of multiple words, multiple sentences, a segment of a conversation such as a turn from a participant, and substantially all of a conversation. The batch mode may include inputting audio following the portion of the audio being recognized. For example, a block of audio may be input to a recognizer and the block may be recognized together, with the speech recognizer determining a transcription for the block substantially simultaneously. For example, the speech recognizer may use Connectionist Temporal Classification (CTC) for training, transcription, or training and transcription.

In some embodiments, an ASR system may use video from the speaker to guide recognition. For example, the ASR system may use video of the speaker's mouth as input to help differentiate between words that sound similar but are associated with different mouth movements.

In some embodiments, greater resources may include an ability to combine techniques described above. For example, the ASR may include multiple recognizers, fused together into a single transcript. An LLM may use the output of the multiple recognizers to guide the fusion (e.g., the LLM may help select the best ASR output among those available) and to correct errors and an editor may enable a human labeler to correct errors.

In some embodiments, text may be part of the training data 230 but audio may be desired for training. In these and other embodiments, the text may be generated into audio using text to audio systems.

An example of generating video from audio for including in the training data 230 is now provided. For example, audio may be divided into segments such as sentences. A speaker may play a segment of audio to the interpreter. A motion detector may determine when the interpreter has finished interpreting the segment. Once the interpreter has finished interpreting the segment, the speaker may play another segment. The motion detector may generate a timestamp indicating when the interpreter stopped signing. An example of generating video data from text data is now provided. A display may present a segment of text to the interpreter. A motion detector may determine when the interpreter has finished interpreting the segment of text. Once the interpreter has finished interpreting the text, the display may present a new segment of text. A data recording system may end-point and label videos of the interpreter voicing or performing sign language corresponding to segments by using timestamps generated by the motion detector.

Returning to the discussion of FIG. 2A, in some embodiments, the training data 230 may be provided to the sign language processing system 210a based on the characteristics of the translation system 212. For example, when the translation system 212 is being trained to generate audio based on sign language in video, the sign language processing system 210a may be provided with audio and video. As another example, when the translation system 212 is being trained to generate text based on sign language in video, the sign language processing system 210a may be provided with text and video. In these and other embodiments, the training data 230 may include video and audio. In these and other embodiments, text may be generated from the audio using ASR.

In some embodiments, the video may be provided to the translation system 212. The translation system 212 may be configured to generate hypothesis data, such as text, gloss, posses, or audio, based on the video provided. As an example, in end-to-end training as illustrated in FIG. 2A, when the translation system 212 includes three stages, the video may be provided to a first stage. In these and other embodiments, an output of the first stage may be sent to the second stage and the output of the second stage may be sent to the third stage. The output of the third stage may be the hypothesis data.

The translation system 212 may provide the hypothesis data to the cost function 214. The cost function 214 may be further configured to obtain the data, such as language data or poses, that corresponds to the video. In these and other embodiments, the data may be the same type of hypothesis data generated by the translation system 212. In these and other embodiments, the cost function 214 may be configured to compare the hypothesis data to the data from the training data 230. For example, the cost function 214 may include a formula or method, such as a loss function, that measures similarity between the hypothesis data and the data from the training data 230, which may indicate an error rate between the hypothesis data and the data. The cost function 214 may be configured to generate feedback data that may be provided to the translation system 212 based on the comparison between the hypothesis data and the data from the training data 230. The feedback data may indicate how different the hypothesis data and the data from the training data 230 are from each other. In some embodiments, the feedback data may be an error signal indicating an amount of the difference between the hypothesis data and the data from the training data 230.

In some embodiments, the translation system 212 may adjust parameters of the one or more models in the translation system 212 based on the feedback data with the objective of more closely aligning the hypothesis data and the data. For example, adjustments may be made to models in each of the three stages using the feedback data. In these and other embodiments, for each weight in each stage a determination may be made that may indicate how each of the weights may change to reduce the difference between the hypothesis data and the data from the training data 230, e.g., the error signal. The indication may be a gradient. In these and other embodiments, the gradient may be a partial derivative of the error signal with respect to the weight. The weight for each stage may be adjusted. In these and other embodiments, each weight in each stage may be reduced by the gradient multiplied by the learning rate associated with the training of the models. Alternately or additionally, adjusting parameters of one or more models may include the objective of reducing latency to generate the hypothesis data more quickly.

In some embodiments, the sign language processing system 210a may be configured to analyze the training data 230 to determine a quality of the training data 230. The quality of the training data may indicate how well the video and the other correspond language data are matched. For example, the match may be poor if the text is an incorrect interpretation of the sign language in the video. In response to determining that the quality of the training data 230 is low, the sign language processing system 210a may not use the training data 230. In some embodiments, the sign language processing system 210a may determine a quality of the training data 230 based on the feedback data from the cost function 214 to determine a quality of the training data 230. In these and other embodiments, the feedback data may include an error rate between the hypothesis data and the data. The sign language processing system 210a may compare the error rate to a threshold rate. In response to the error rate satisfying the threshold rate, the sign language processing system 210a may use the training data 230. Alternately or additionally, the feedback data may include a confidence function that may indicate a confidence that the hypothesis data matches the data. The sign language processing system 210a may compare the confidence function to a threshold rate. In response to the confidence function satisfying the threshold rate, the sign language processing system 210a may use the training data 230. In these and other embodiments, the sign language processing system 210a may discard portions of a video or all the video that does not satisfy a threshold rate. For example, the sign language processing system 210a may discard some frames of a video and maintain other frames of a video.

Additionally or alternatively, when an ASR is used to convert audio to text, the sign language processing system 210a may determine an ASR confidence metric that indicates a likelihood that the ASR correctly transcribed the audio into text. If the ASR confidence does not satisfy a selected threshold, the sign language processing system 210a may not use the text for training.

In some embodiments, the training of the translation system 212 may be performed using stochastic gradient descent (SDG) or other training methods as an optimization method in the training. In some embodiments, training may be performed until the error rate does not change significantly any further in the training process. Additionally or alternatively, training may be performed until an acceptable amount of error is achieved. An amount of training may be based on the selected hyperparameters and the size of dataset. Alternately or additionally, the training that occurs may be based on the capability of processor or system performing the training and/or the amount of data available for training. Furthermore, training may be performed incrementally or in whole.

In FIG. 2B, the environment 200b includes a sign language processing system 210b and the training data 230. The sign language processing system 210b includes the translation system 220 and a cost function 222. In these and other embodiments, the translation system 220 may be similar to the translation system 212 and the cost function 222 may be similar to the cost function 214. As such, no further description is provided with respect to these elements in FIG. 2B. In these and other embodiments, the translation system 220 may be provided with audio and/or text data and may be configured to generate hypothesis sign language data. The translation system 220 may provide the hypothesis sign language data to the cost function 222. The cost function 222 may compare the hypothesis sign language data to the sign language data from a video from the training data 230 that corresponds to the audio and/or text data provided to the translation system 220. The cost function 222 may generate the feedback data based on the comparison. The feedback data may be used to adjust the one or more models of the translation system 220.

In FIG. 2C, the environment 200c includes a sign language processing system 210c, first training data 260, and second training data 262. The sign language processing system 210c includes a translation system 240, which includes a first stage 242a, a second stage 242b, and a third stage 242c, referred to collectively as the stages 242. The sign language processing system 210c further includes a first cost function 250 and a second cost function 252. In these and other embodiments, the first cost function 250 and the second cost function 252 may be similar to the cost function 214 and the first training data 260 and the second training data 262 may be similar to the training data 230 As such, no further description is provided with respect to these elements in FIG. 2C except for where these elements vary.

In some embodiments, the stages 242 may each include one or more neural networks or other internal functions. In these and other embodiments, each of the stages 242 may include one or more input and one or more outputs. For example, the first stage 242a may include one input and one output. The second stage 242b may include two inputs and two outputs. The third stage 242c may include two inputs and one output. As an example, the first stage 242a may be configured to obtain video and output gloss. The second stage 242b may be configured to obtain gloss, such as from the first stage 242a and the second training data 262 and output text. The third stage 242c may be configured to convert text to speech using a text-to-speech (TTS) synthesizer.

In some embodiments, a stage of the stages 242 that include a single output may be trained using end-to-end training. For example, the first stage 242a and the third stage 242c may be trained using end-to-end training using the first training data 260. In these and other embodiments, video from the first training data 260 may be provided to the translation system 240. The translation system 240 may generate audio based on sign language content in the video. The translation system 240 may provide the audio to the first cost function 250. The first cost function 250 may obtain audio corresponding to the video from the first training data 260. The first cost function 250 may generate feedback data and provide the feedback data to the translation system 240. The translation system 240 may train the one or more models of each of the stages 242.

In some embodiments, a stage of the stages 242 may include multiple outputs. In these and other embodiments, one of the outputs may be used for end-to-end training and another may be used for training of the specific stage.

In some embodiments, the output for the specific stage training may include data that corresponds to the data in the training data used for the specific stage training. In these and other embodiments, the output for the end-to-end training may include other data that corresponds to the first training data 260. For example, with respect to the second stage 242b, the inputs to the second stage 242b may be alternative input nodes that are assigned to the same set of input nodes of the models in the second stage 242b. For example, during operation, the second stage 242b may obtain gloss from the second training data 262 and may generate hypothesis text and output the hypothesis text to the second cost function 252. The second cost function 252 may compare the hypothesis text to text from the second training data 262 that corresponds to the gloss provided to the second stage 242b to generate feedback data that may be used to modify the models in the second stage 242b. In these and other embodiments, when the second stage 242b is not generating text based on input gloss from the second training data 262, the second stage 242b may be configured to generate text based on input gloss from the first stage 242a. In these and other embodiments, the models in the second stage 242b may be further modified based on feedback data generated by the first cost function 250. In these and other embodiments, the sequencing of training the second stage 242b via the second training data 262 or via the first training data 260 may vary. For example, in some embodiments, the trainings may alternate one to one or at some other ratio. Alternately or additionally, one training may include more data from the first training data 260 than from the second training data 262. For example, one training may include five segments from the first training data 260 for every two segments from the second training data 262.

In some embodiments, the first training data 260 and the second training data 262 may be different training data. For example, the first training data 260 may be training data from a communication session such as explained with respect to FIG. 1. The second training data 262 may be persistent training data that is recorded and always available for training. In these and other embodiments, the first training data 260 may be used when available and the second training data 262 may be used when the first training data 260 is not available. For example, during the night fewer or no communication sessions may occur. In these and other embodiments, the second training data 262 may be used to train at night and the first training data 260 may be used to train during the day when the first training data 260 is available for training as communication sessions are occurring.

In some embodiments, a stage of the stages 242 that include multiple outputs, both outputs may be used for end-to-end training and one of the outputs may be used for training of the specific stage. For example, with respect to the third stage 242c, the inputs to the third stage 242c may be separate input nodes that are assigned to the separate output nodes of the models in the second stage 242b. As an example, assume the first stage 242a generates poses from video and the second stage 242b operates to generate gloss from poses generated by the first stage 242a. During operation, the second stage 242b may obtain poses from the first stage 242a and may generate hypothesis gloss. Additional information regarding the video may be useful when generating text from the gloss by the third stage 242c. For example, the additional information may include one or more of gloss modifiers, information other than glosses, or attributes of glosses. In these and other embodiments, the second stage 242b may output the gloss to the third stage 242c and to the second cost function 252 on a first output and may output the additional information about the gloss on a second output to the third stage 242c. The third stage 242c may use the gloss and the additional information to generate text. As an example, the first output may indicate the gloss for “blame.” The second output may include information such as that the sign for blame was directed towards the signer (as in “blame myself”), that the “blame” gesture was exaggerated, that the sign was performed left-handed, that the signer's face indicated surprise (e.g., eyebrows raised) or contrition (lower lip thrust forward), that the signer's shoulders were slumped, that the sign was performed slowly, or other descriptions of the performance that may not be included in a gloss but may help to generate text that better corresponds to the sign language content provided to the translation system 240 for which the gloss is generated.

In these and other embodiments, the second cost function 252 may obtain gloss to compare to the hypothesis gloss generated by the second stage 242b. For example, the second cost function 252 may obtain the gloss from the first training data 260 that provided the video to the first stage 242a based on the gloss corresponding to the video and compare the gloss to the hypothesis gloss from the second stage 242b. In these and other embodiments, the second cost function 252 may generate feedback data for modifying the models of the second stage 242b based on the comparison and the first cost function 250 may generate feedback for modifying the models of all the stages 242 using the same training data. In these and other embodiments, when there is no known gloss from training data to compare to the hypothesis gloss, the hypothesis gloss may not be provided to the second cost function 252 and/or the second cost function 252 may not generate feedback data. In these and other embodiments, the second stage 242b may be trained based solely on the feedback from the first cost function 250. As such, the second stage 242b may be trained individually when there is training data specifically for the second stage 242b and trained end-to-end when there is no training data specifically for the second stage 242b. Additionally or alternatively, second stage 242b may be trained individually using the second training data 262 and end-to-end from the first training data 260. The training from multiple sources may occur alternately or simultaneously.

Modifications, additions, or omissions may be made to the environments 200 without departing from the scope of the present disclosure. For example, the environment 200 may include additional systems or devices that may perform training in parallel with the training performed by the sign language processing system 210.

As another example, the sign language processing systems 210 may include additional translation systems. For example, the sign language processing systems 210 may include translation systems 240 for recognition and generation for one or more languages, combination of languages, for different signing levels and accents, among other variations.

As another example, the translation system 240 may include more or fewer stages than the three stages 242 illustrated. In these and other embodiments, the order in which training individual stages 242 and end-to-end training occur may vary. For example, one or more of the stages 242 may be individually trained in a pre-training phase. One or more of the stages 242 may then be trained end-to-end. Additionally or alternatively, one or more of the stages 242 may be individually trained, then simultaneously or alternately trained individually and end-to-end. Additionally or alternatively, one or more of the stages 242 may be simultaneously or alternately trained individually and end-to-end. In some embodiments, the translation system 240 may include one stage, trained end-to-end using persistent and/or temporary data.

As another example, the training data used to train the translation systems may vary. For example, the training data may be persistent data that is recorded and always available for training or temporary data from a communication session such as explained with respect to FIG. 1.

In some embodiments, persistent data may be used to train a first group of one or more stages and temporary data may be used to train a second group of one or more stages. In these and other embodiments, the first group and second group may be the same groups, overlapping groups, or mutually exclusive groups. For example, the persistent data may be used to train a gloss-to-text stage, and the temporary data may be used to train multiple stages, including the gloss-to-text stage. In another example, the persistent data may be used to train a stage that converts video to gloss, and the temporary data may be used to train all the stages. In another example, the persistent data may be used to train a feature extraction stage, and the temporary data may be used to train all the other stages in the translator except the feature extraction stage.

In some embodiments, the order in which persistent data and temporary data are used may vary. For example, persistent data may be used for pretraining. In these and other embodiments, the persistent data may be used to train one or more stages in a first phase. In a second phase, the temporary data may be used to train one or more stages (which may include one or more of the stages trained in the first phase). Additionally or alternatively, the temporary data may be used to train one or more stages in a first phase and persistent data may be used to train one or more stages in a second phase. Additionally or alternatively, the temporary data and the persistent data may be used simultaneously for training, such as in overlapping time periods. Additionally or alternatively, the temporary data and the persistent data may be used alternately for training.

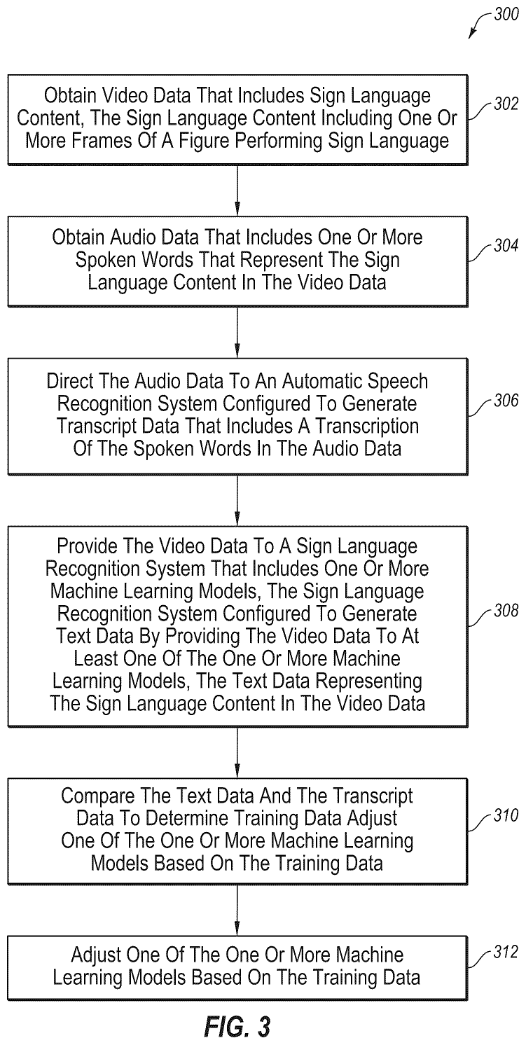

FIG. 3 illustrates a flowchart of an example method 300 to train a sign language recognition system. The method 300 may be arranged in accordance with at least one embodiment described in the present disclosure. One or more operations of the method 300 may be performed, in some embodiments, by a device or system, such as the sign language processing system 140, the sign language processing system 210a, the sign language processing system 210b, and the sign language processing system 210c described in FIGS. 1 and 2A-2C, another system described in this disclosure or another device or combination of devices. In these and other embodiments, the method 300 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 300 may begin at block 302, obtaining video data that includes sign language content, the sign language content including one or more frames of a figure performing sign language. The figure may be a person.

At block 304, obtaining audio data that includes one or more spoken words that represent the sign language content in the video data. At block 306, directing the audio data to an automatic speech recognition system configured to generate transcript data that includes a transcription of the spoken words in the audio data.

At block 308, providing the video data to a sign language recognition system that includes one or more machine learning models, the sign language recognition system configured to generate text data by providing the video data to at least one of the one or more machine learning models, the text data representing the sign language content in the video data. In some embodiments, the sign language recognition system may include a single machine learning model that generates the text data from the video data. Alternately or additionally, the sign language recognition system includes multiple machine learning models. In these and other embodiments, the machine learning model may be adjusted based on the training data. In these and other embodiments, the machine learning model may be configured to convert gloss data to the text data.

Alternately or additionally, the sign language recognition system includes a plurality of machine learning models including a feature extraction machine learning model, a sign identification learning model, and a gloss conversion machine learning model. In some embodiments, one or more of the machine learning models may include an encoder and one or more of the machine learning models may include a decoder. An encoder and decoder in one or more of the machine learning models may be configured as a transformer.

At block 310, comparing the text data and the transcript data to determine training data. At block 312, adjusting one of the one or more machine learning models based on the training data.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For example, in some embodiments, each of the machine learning models may be trained individually and then combined such that the output of one model may be used as an input of another model or in some other combination. After being combined, the machine learning models may be trained together as the sign language recognition system. In these and other embodiments, the machine learning models may be combined such that there are no distinguishing boundaries between the models and/or no distinction between the models.

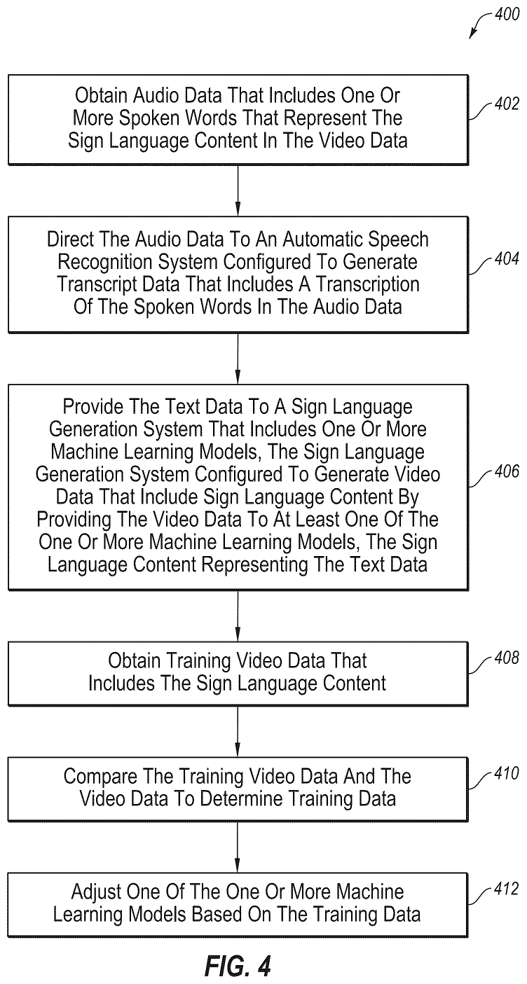

FIG. 4 illustrates a flowchart of an example method 400 to train a sign language generation system. The method 400 may be arranged in accordance with at least one embodiment described in the present disclosure. One or more operations of the method 400 may be performed, in some embodiments, by a device or system, the sign language processing system 140, the sign language processing system 210a, the sign language processing system 210b, and the sign language processing system 210c described in FIGS. 1 and 2A-2C, another system described in this disclosure or another device or combination of devices. In these and other embodiments, the method 400 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 400 may begin at block 402, where obtaining audio data that includes one or more spoken words that represent the sign language content in the video data. At block 404, directing the audio data to an automatic speech recognition system configured to generate transcript data that includes a transcription of the spoken words in the audio data.

At block 406, providing the text data to a sign language generation system that includes one or more machine learning models, the sign language generation system configured to generate video data that includes sign language content by providing the video data to at least one of the one or more machine learning models, the sign language content representing the text data.

At block 408, obtaining training video data that includes the sign language content. At block 410, comparing the training video data and the video data to determine training data. At block 412, adjusting one of the one or more machine learning models based on the training data.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

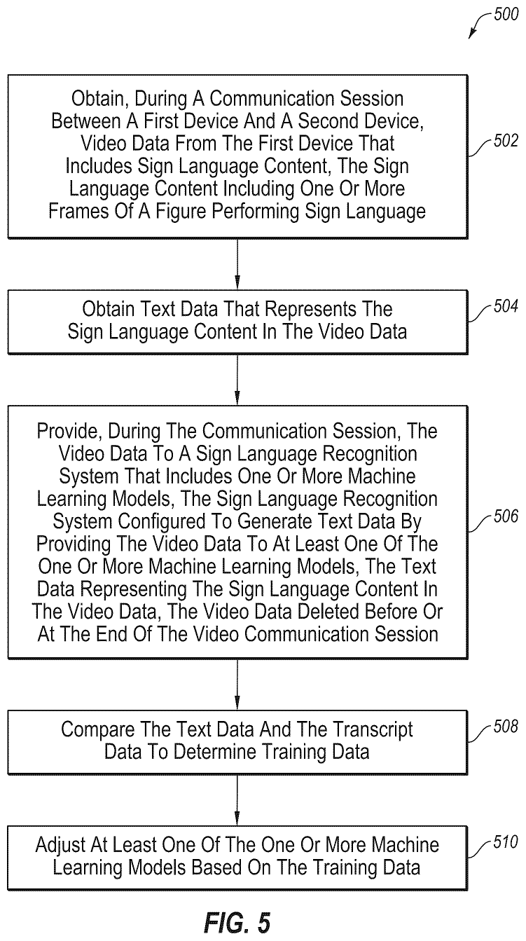

FIG. 5 illustrates a flowchart of an example method 500 to train a sign language recognition system. The method 500 may be arranged in accordance with at least one embodiment described in the present disclosure. One or more operations of the method 500 may be performed, in some embodiments, by a device or system, such as the sign language processing system 140, the sign language processing system 210a, the sign language processing system 210b, and the sign language processing system 210c described in FIGS. 1 and 2A-2C, another system described in this disclosure or another device or combination of devices. In these and other embodiments, the method 500 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 500 may begin at block 502, where obtaining, during a communication session between a first device and a second device, video data from the first device that includes sign language content, the sign language content including one or more frames of a figure performing sign language.

At block 504, obtaining text data that represents the sign language content in the video data. In some embodiments, obtaining the text data includes: obtaining, during the communication session, audio data that includes one or more spoken words that represent the sign language content in the video data; and directing the audio data to an automatic speech recognition system configured to generate transcript data that includes a transcription of the spoken words in the audio data.

At block 506, providing, during the communication session, the video data to a sign language recognition system that includes one or more machine learning models, the sign language recognition system configured to generate text data by providing the video data to at least one of the one or more machine learning models, the text data representing the sign language content in the video data, the video data is deleted before or at the end of the video communication session.

At block 508, comparing the text data and the transcript data to determine training data. At block 510, adjusting at least one of the one or more machine learning models based on the training data.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

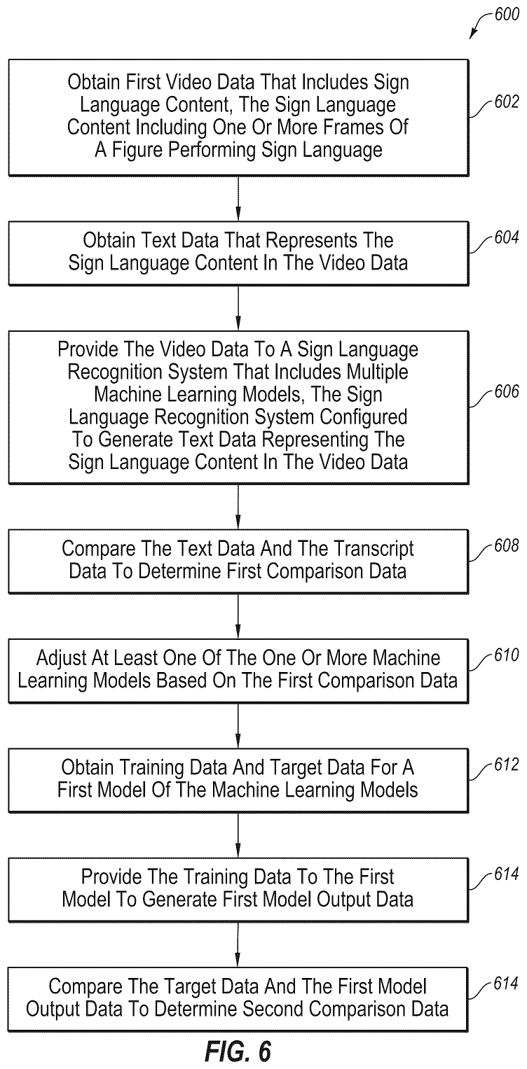

FIG. 6 illustrates a flowchart of an example method 600 to train a sign language recognition system. The method 600 may be arranged in accordance with at least one embodiment described in the present disclosure. One or more operations of the method 600 may be performed, in some embodiments, by a device or system, such as the sign language processing system 140, the sign language processing system 210a, the sign language processing system 210b, and the sign language processing system 210c described in FIGS. 1 and 2A-2C, another system described in this disclosure or another device or combination of devices. In these and other embodiments, the method 600 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 600 may begin at block 602, where obtaining first video data that includes sign language content, the sign language content including one or more frames of a figure performing sign language. At block 604, obtaining text data that represents the sign language content in the video data.

At block 606, providing the video data to a sign language recognition system that includes a plurality of machine learning models, the sign language recognition system configured to generate text data representing the sign language content in the video data.

At block 608, comparing the text data and the transcript data to determine first comparison data. At block 610, adjusting at least one of the one or more machine learning models based on the first comparison data. At block 612, obtaining training data and target data for a first model of the machine learning models.

At block 614, providing the training data to the first model to generate first model output data. At block 616, comparing the target data and the first model output data to determine second comparison data. At block 618, adjusting the first model based on the second comparison data.

In these and other embodiments, the method 600 iteratively alternates between adjusting the first model based on the second comparison data and adjusting at least one of the one or more machine learning models based on the first comparison data.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

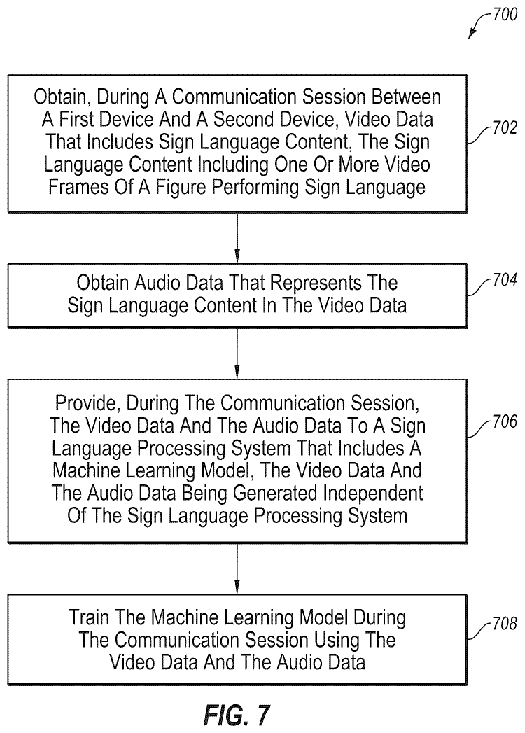

FIG. 7 illustrates a flowchart of an example method 700 for sign language processing. The method 700 may be arranged in accordance with at least one embodiment described in the present disclosure. One or more operations of the method 700 may be performed, in some embodiments, by a device or system, such as the sign language processing system 140, the sign language processing system 210a, the sign language processing system 210b, and the sign language processing system 210c described in FIGS. 1 and 2A-2C, another system described in this disclosure or another device or combination of devices. In these and other embodiments, the method 700 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 700 may begin at block 702, where video data may be obtained during a communication session between a first device and a second device that includes sign language content. In these and other embodiments, the sign language content may include one or more video frames of a figure performing sign language.

At block 704, audio data may be obtained that represents the sign language content in the video data. In some embodiments, the audio data and the video data may be obtained from different devices. In some embodiments, the audio data may be obtained before the video data.

At block 706, the video data and the audio data may be provided during the communication session to a sign language processing system that includes a machine learning model. In these and other embodiments, the video data and the audio data may be generated independent of the sign language processing system. In some embodiments, one of the first device and the second device may provide one of the audio data and the video data and the other of the first device and the second device may not provide the video data and may not provide the audio data.

At block 708, the machine learning model may be trained during the communication session using the video data and the audio data. In some embodiments, the machine learning model may be part of a sign language generation system or a sign language recognition system.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

In some embodiments, training the machine learning model during the communication session using the video data and the audio data may include directing the audio data to an automatic speech recognition system configured to generate the first text data that includes a transcription of the spoken words in the audio data. In these and other embodiments, the first text data may be used in training the machine learning model.

In some embodiments, training the machine learning model during the communication session may also include generating, by the sign language processing system, second text data by providing the video data to the machine learning model, where the second text data represents the sign language content in the video data. The training may also include comparing the first text data and the second text data and adjusting the machine learning model based on the comparison. In these and other embodiments, the steps of generating, comparing, and adjusting may occur before the end of the communication session.

Alternately or additionally, training the machine learning model during the communication session may include generating, by the sign language processing system, second video data by providing the text data to the machine learning model. In these and other embodiments, the second video data may include sign language representing the text data. The training may also include comparing the video data and the second video data and adjusting the machine learning model based on the comparison.

In some embodiments, training the machine learning model during the communication session using the video data and the audio data includes training the machine learning model using data that is not obtained from the communication session in conjunction with the video data and the audio data from the communication session.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

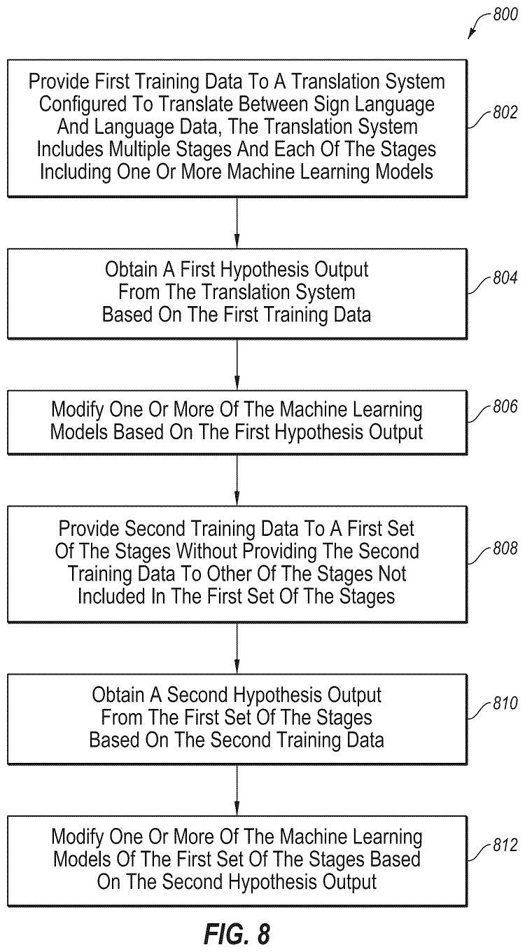

FIG. 8 illustrates a flowchart of an example method 800 for training machine learning models. The method 800 may be arranged in accordance with at least one embodiment described in the present disclosure. One or more operations of the method 800 may be performed, in some embodiments, by a device or system, such as system the sign language processing system 140, the sign language processing system 210a, the sign language processing system 210b, and the sign language processing system 210c described in FIGS. 1 and 2A-2C, another system described in this disclosure or another device or combination of devices. In these and other embodiments, the method 800 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 800 may begin at block 802, where first training data may be provided to a translation system configured to translate between sign language and language data, such as audio or text. In some embodiments, the translation system may include multiple stages and each of the multiple stages may include one or more machine learning models. In some embodiments, the translation system may be configured for sign language recognition or sign language generation. For example, FIGS. 2A-2C and the associated description provide examples of how the translation systems 212, 220, and 240 may be provided with the training data.

At block 804, a first hypothesis output may be obtained from the translation system based on the first training data. In some embodiments, the first hypothesis output may be an example of the output of the cost functions 214, 222, and 250 of FIGS. 2A-2C.

At block 806, one or more of the machine learning models may be modified based on the first hypothesis output. For example, FIG. 2C illustrates how the machine learning models of the stages 242 may be modified based on the output of the first cost function 250.

At block 808, second training data may be provided to a first set of the stages without providing the second training data to other of the stages not included in the first set of the stages. In some embodiments, the second training data may be a subset of the first training data. For example, FIG. 2C illustrates how the second stage 242b may be provided with the second training data 262.

Alternately or additionally, the first training data may be obtained from a communication session between devices and deleted before the communication session ends and the second training data may be stored before, during, and after the communication session. Alternately or additionally, the second training data may be obtained from a communication session between devices and deleted before the communication session ends and the first training data may be stored before, during, and after the communication session.

At block 810, a second hypothesis output may be obtained from the first set of the stages based on the second training data. In some embodiments, the second hypothesis output may be an example of the output of the second cost function 252 of FIG. 2C.

At block 812, one or more of the machine learning models of the first set of the stages may be modified based on the second hypothesis output. In some embodiments, the one or more of the machine learning models of the first set of the stages modified based on the second hypothesis output is the same one or more of the machine learning models modified based on the first hypothesis output. FIG. 2C illustrates how the machine learning models of the second stage 242b may be modified based on the output of the second cost function 252.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

In some embodiments, the steps of providing first training data, obtaining the first hypothesis output, and modifying based on the first hypothesis output may be end-to-end training and may be iteratively repeated and the steps of providing second training data, obtaining the second hypothesis output, and modifying based on the second hypothesis output may be sub-training and may be iteratively repeated. Sub-training may denote training a subset of stages or training on a subset of the training data. In these and other embodiments, a number of iterations for the sub-training may be different from the number of iterations for the end-to-end training. For example, the number of iterations for the sub-training may be more or less than the number of iterations for the end-to-end training. Alternately or additionally, the iterations for the sub-training may be intermixed between iterations for the end-to-end training. For example, a sub-training may occur and then an end-to-end training may occur, or a sub-training may occur and then three end-to-end trainings may occur.

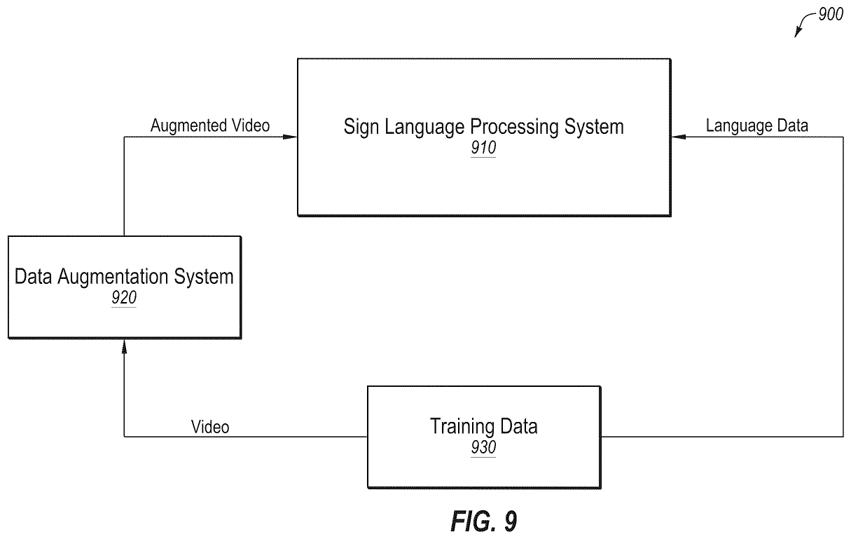

As discussed with respect to FIGS. 2A-2C, data, such as video and other language data may be used to train translation systems that may include one or more models. Models that are trained using larger data sets may receive better training. In some circumstances, it may be difficult to obtain sufficient training data. FIG. 9 illustrates an example environment 900 for data augmentation, where videos may be augmented to generate additional training data for training translation systems.

The environment 900 may be arranged in accordance with at least one embodiment described in the present disclosure. The environment 900 may include a sign language processing system 910, a data augmentation system 920, and training data 930. The sign language processing system 910 may be similar to the sign language processing systems 210a, 210b, and 210c of FIGS. 2A-2C and the training data 930 may be similar to the training data 230 of FIGS. 2A-2C. As such, no further description is provided with respect to these elements in FIG. 9.

In some embodiments, the data augmentation system 920 may be configured to obtain video from the training data 930. The video from the training data 930 may have corresponding language data, such as audio, text, and/or gloss, that may be used with the video by the sign language processing system 910 for training of one or more models, such as the training described with respect to FIG. 1 and FIGS. 2A-2C.

In some embodiments, the data augmentation system 920 may be configured to alter the video from the training data 930. The data augmentation system 920 may alter the video to create a new video that may be provided to the sign language processing system 910 for use in training. In these and other embodiments, the video from the training data 930 may be obtained during a communication session as described with respect to FIG. 1, generated based on language data using a sign language generation system, or obtained from other sources.

In some embodiments, the data augmentation system 920 may be configured to alter the video by distorting the video in a manner that may occur as video is transmitted over networks. For example, the data augmentation system 920 may alter video by causing the video to include one or more video artifacts. For example, video artifacts may include freezing (the video stops moving for a moment), skipped frames (segments of the video are lost), speedup (sometimes speeding up follows freezing to make up for delayed frames), noise, dropped video, reduced resolution, and various distortions caused by network delays, glitches, and packet loss. For example, the data augmentation system 920 may remove one or more frames of the video to introduce a skipped frame artifact. The video with the one or more frames removed may be the new video.

In some embodiments, the data augmentation system 920 may be configured to alter the video by adjusting one or more photographic variables of the video. For example, the data augmentation system 920 may regenerate the video but with different contrast, color temperature, lighting, camera perspectives, or other photographic variables. For example, the data augmentation system 920 may regenerate the video from a perspective slightly to the side and/or from below or above or closer or farther from the original camera perspective. Alternately or additionally, the video may be altered by cropping the video such that hands and arms of the figure move in and out of the frame. In these and other embodiments, a variety of different cropping sizes and positions may be used.

In some embodiments, the data augmentation system 920 may be configured to alter the video by generating a new figure in the video that performs sign language content. For example, video may include video of a figure performing sign language content. In these and other embodiments, the data augmentation system 920 may extract a spatial configuration of body parts of the figure at different frames in the video. The spatial configuration may be an arrangement or positioning of the body part in three-dimensional space. In these and other embodiments, the spatial configuration may include information such as positions of the body parts relative to each other and/or a reference point and/or the orientation of the body part. The orientation of the body part may indicate a direction or angle at which the body part is aligned. In some embodiments, the spatial configuration of the body parts of the figure may refer to a pose of the figure as the figure performs sign language. In these and other embodiments, the data augmentation system 920 may extract the spatial configuration of all the body parts illustrated in the video, a selection of body parts, or those body parts that may be used to determine a sign being generated by the figure. For example, in some embodiments, the data augmentation system 920 may extract the spatial configuration of one or more of the fingers, hands, arms, shoulders, and heads of a figure.

In some embodiments, after extracting the spatial configuration of body parts, the data augmentation system 920 may generate new video using the spatial configuration of body parts. The new video may illustrate a figure performing the same signs as the original video. However, the new video may be created so that the figure is different in appearance from the figure in the original video. For example, the figure may be varied with different features, coloring, clothes, hair style, accessories (e.g., makeup, jewelry, watches, tattoos), background, camera angle, lighting, contrast, color temperature, hair color, skin color, eye color, race, ethnicity, gender, age, weight, and mood, among others. In some embodiments, neural rendering methods such as GANs and pix2pix may be used to generate the new video. In these and other embodiments, multiple new videos may be generated from one set of spatial configurations of body parts. In these and other embodiments, each of the new videos may be altered in a different way such that none of the new videos are the same.

In some embodiments, the data augmentation system 920 may be configured to alter the video by removing one hand (including the arm) of the figure in the video so that the new video has a single hand signing. Alternately or additionally, the data augmentation system 920 may alter the video later by having one hand be placed in a neutral position at the side of the user. In these and other embodiments, the data augmentation system 920 may remove a hand by extracting the spatial configuration of body parts of the figure. After extracting the spatial configuration of body parts, the data augmentation system 920 may remove the spatial configuration of one hand. Alternately or additionally, the spatial configuration of the hand may be removed and placed in a neutral position at the side of the user. In these and other embodiments, a new video may be created using the remaining spatial configuration of body parts. Other alterations may also be performed to the new video. Alternately or additionally, the video may be processed directly to remove one hand from the video to generate a new video.

In some embodiments, a translation system may be trained using video with two hands and one hand.

Alternately or additionally, a first translation system may be trained using videos with two hands signing and a second translation system may be trained using videos with one hand signing. In these and other embodiments, one of the first translation system or the second translation system may be selected for use based on the video having sign being performed using one or two hands. Alternately or additionally, the translation system may include an input that indicates whether one or two hands is being used and adjust accordingly. Alternately or additionally, instead of removing the hand and arm, it may be moved to a neutral position such as hanging at the figure's side or holding a phone. The latter neutral position may be preferred in situations where the user is likely to sign with one hand into the camera of a phone held in the other hand.

In some embodiments, the sign language processing system 910 may have one or more translation systems. In these and other embodiments, the sign language processing system 910 may have four translation systems, (1) a right-handed, two-handed signing translation systems, (2) a right-handed, one-handed signing translation systems, (3) a left-handed, two-handed signing translation systems, and (4) a left-handed, one-handed signing translation systems. Each translation system may be trained on training data corresponding to the sign language mode to be translated. Some or all the training data may be augmented by the data augmentation system 920 for training. For example, images for right-handed data may be reversed to train left-handed models. As another example, one-handed models may be trained using data where one hand and arm are removed or moved to a neutral position. Alternately or additionally, the sign language processing system 910 may have one translation system with models configured for each of the sign language modes.

In some embodiments, the sign language processing system 910 may not be configured for left-handed or right-handed signing and may reverse the video (e.g., make a left-handed figure appear to be right-handed) as appropriate before processing. In some embodiments, the sign language processing system 910 may determine a signer's mode. i.e., whether the signer is right-handed or left-handed and whether the signer is signing with one or two hands. The sign language processing system 910 may then use a model that matches the signer's mode (or it may reverse the video, as appropriate). Alternatively or additionally, models for multiple modes may be combined. For example, the sign language processing system 910 may have a two-handed model trained on right- and left-handed, two-handed data so that the model can recognize sign language performed by one or two hands, regardless of the signer's handedness. As another example, the sign language processing system 910 may have a right-handed model that translates one- or two-handed signing and a left-handed model that recognizes one- or two-handed signing. As another example, the translation system may have a model trained on right- and left-handed and one- and two-handed data and may recognize sign language in any of the four modes.

Modifications, additions, or omissions may be made to the environments 900 without departing from the scope of the present disclosure.

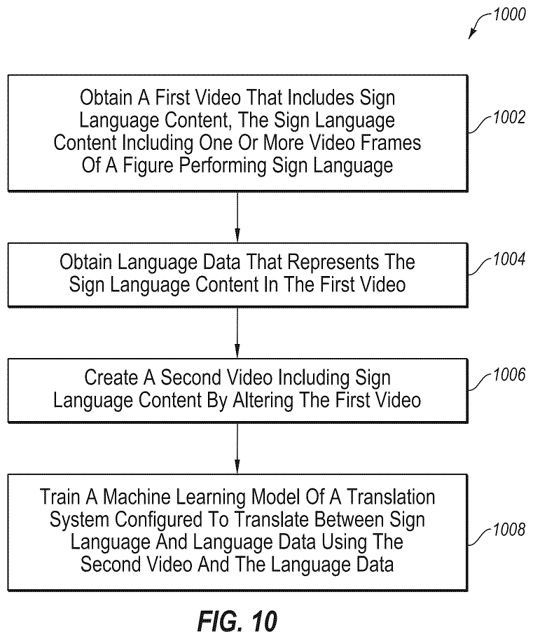

FIG. 10 illustrates a flowchart of an example method 1000 for data augmentation. The method 1000 may be arranged in accordance with at least one embodiment described in the present disclosure. One or more operations of the method 1000 may be performed, in some embodiments, by a device or system, such as the sign language processing system 140, the sign language processing system 210a, the sign language processing system 210b, the sign language processing system 210c, and the sign language processing system 910 described in FIGS. 1, 2A-2C, and 9, another system described in this disclosure or another device or combination of devices. In these and other embodiments, the method 1000 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 1000 may begin at block 1002, where a first video may be obtained that includes sign language content. In some embodiments, the sign language content may include one or more video frames of a figure performing sign language. At block 1004, language data may be obtained that represents the sign language content in the first video.

At block 1006, a second video including sign language content may be created by altering the first video. In some embodiments, creating the second video may include removing or moving a non-dominant hand of the figure in the second video. For example, in some embodiments, removing a non-dominant hand of the figure may include extracting, from the first video, a spatial configuration for each of one or more body parts of the figure, removing the spatial configurations related to a non-dominant hand of the figure, and creating the second video using the remaining spatial configurations to define signs for the sign language content.

In some embodiments, creating the second video may include generating a second figure performing sign language using the extracted spatial configurations where the second figure is visibly distinct from the figure.

At block 1008, a machine learning model of a translation system configured to translate between sign language and language data may be trained using the second video and the language data. In some embodiments, the translation system may be configured for sign language recognition or sign language generation.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For example, the method 1000 may further include distorting the second video before training the machine learning model using the second video. Alternately or additionally, the method 1000 may further include creating multiple second videos that include the second video. In these and other embodiments, each of the second videos may be created to include sign language content using the extracted spatial configurations and each of the second videos may include a figure that is visibly distinct from a figure in another of the second videos. In these and other embodiments, the machine learning model may be trained using each of the second videos and the language data.

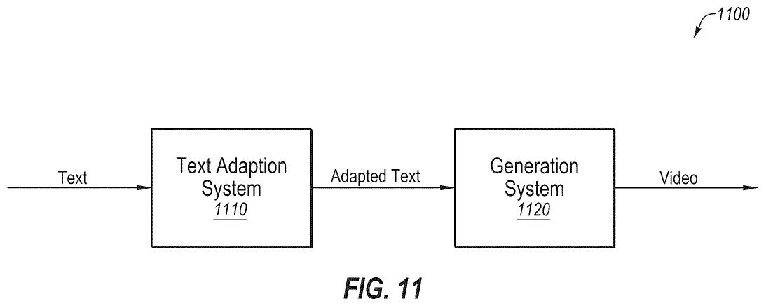

FIG. 11 illustrates an example environment 1100 for text adaptation for sign language generation. The environment 1100 may be arranged in accordance with at least one embodiment described in the present disclosure. The environment 1100 may include a text adaption system 1110 and a sign language generation system 1120. The environment 1100 may be configured to adapt text that may be used to generate video with sign language that corresponds to the text. The text may be adapted because longer sentences, complex sentences, and other forms of text, such a jargon or specialized terminology, may not translate well into sign language in the text's original form. In these and other embodiments, the environment 1100 may adapt the text, such as simplifying the text, before the text is used to generate a video that includes sign language content.

In some embodiments, the text adaption system 1110 may obtain text that may be used to generate a video that includes sign language content. The text may be obtained from any source. For example, the text may include a transcription of audio. The audio may be part of a communication session as described with respect to FIG. 1. Alternately or additionally, the audio may be part of a broadcast, such as radio, television, or broadcast in a public or private event. Alternately or additionally, the text may be sourced from a network, such as the Internet. In these and other embodiments, the text may be from a specific webpage or some other source. In these and other embodiments, the text may be sourced from any place where text-to-voice is provided. In these and other embodiments, a website, venue, or other place may provide text to sign language, such as using the environment described in FIG. 11. Alternatively or additionally, the sign language generation system 1120 may provide captions, such as captions near the bottom of the sign language video. Alternatively or additionally, the sign language generation system 1120 may provide audio corresponding to the text using text-to-speech.

In some embodiments, the text adaption system 1110 may adapt the text by changing the construct of the text so that the text is more easily understandable. In these and other embodiments, changing the construct of the text may include forming multiple shorter text strings from a longer text string. For example, different themes in a longer text string may be determined and then a shorter text string may be constructed that explains each of the themes. Alternately or additionally, adapting the text may include providing a definition for technical or complex terms, or other terms such as jargon. Alternately or additionally, adapting the text may include providing explanatory content if the content would not be readily understood. Alternately or additionally, adapting the text may include removing portions of the text when the portions of the text may not be needed for comprehension.

For example, a sentence may state “Provide exceptional vacation experiences, delivered by passionate team members committed to world-class hospitality and innovation.” In these and other embodiments, the text may be adapted to be four different sentences such as “We provide fantastic vacations.” “Our staff is passionate.” “We deliver the best H-O-S-P-I-T-A-L-I-T-Y-travel and lodging-in the world. (‘Hospitality’ is fingerspelled), and “We invent better ways to serve you.” In this example, the longer text string includes multiple themes regarding providing vacation experiences, having passionate team members, providing hospitality, and being innovative. A sentence was constructed for each of the themes. Furthermore, a definition for the complex term ‘hospitality’ and ‘innovative’ was provided.

As another example, text that may not be needed for comprehension may be removed. Text that may be not needed for comprehension may include text resulting from stuttering, repeated content, corrections, or overly wordy discourse. For example, a text sentence may include the following: “Well. I-I-I was just, you know, just kind of thinking, like, like, maybe if-if you could, you know, um, doing it, like, like, the way we talked about, you know, earlier, because, well, you know, a better idea, or- or not, but, like, just, um, something to think about. I guess?.” The text may be adapted to read “Maybe we could go forward based on what we talked about earlier.” In this example, stuttering, repeated words, and wordiness was removed.

In some embodiments, the text adaption system 1110 may adapt the text by changing the text so that the text is more easily understandable. In these and other embodiments, adapting the text may include adding text to explain the meaning of terms, clarify content, spell ambiguous words, or include world knowledge. For example, the text adapter may convert the sentence. “This cream may reduce your psoriasis” to “Apply this cream to your skin. It may reduce your psoriasis P-S-O-R-I-A-S-I-S, itchy skin.” In this manner, an unusual or unfamiliar term may be signed, then spelled out, then explained.

In some embodiments, the text adaption system 1110 may be configured to adapt the text based on characteristics of the user to which the sign language is generated based on the text to be presented. For example, the text adaption system 1110 may determine language characteristics of the user, such as an accent, cognitive level, educational background, expertise in a specific domain, or level of sign language fluency. The text adaption system 1110 may adapt the text into a form that may be better understood by the user. In some embodiments, examples of language data from the user may be provided to the text adaption system 1110. The text adaption system 1110 may adapt text to match the skill level or other characteristics of the examples.

In some embodiments, the text adaptation system 1110 may be configured to adapt the text in response to the text satisfying one or more conditions. For example, the conditions may relate to a complexity of the text or a topic of the text. In these and other embodiments, in response to the text not satisfying the one or more conditions, the text adaption system 1110 may not perform any adaption. In some embodiments, the complexity of the text may be determined based on a number of characters in the text, an average number of characters per word, an estimate of the reading level of the text, a complexity score of the text, and/or a topic of the text.

In some embodiments, the text adaption system 1110 may use one or more machine learning models to adapt the text. In these and other embodiments, the model may be trained by providing a corpus of one or more example pairs. Each pair may include an original text and adapted text. The training may use these examples to create one or more models for the text adaption system 1110. In these and other embodiments, the model may include a large language model “LLM.” In these and other embodiments, when the model is an LLM, the text adaption system 1110 may provide prompts based on the text to allow the model to adapt the text. For example, the text adaption system 1110 may include multiple prompts and, based on a review of the text, may select an appropriate prompt for the LLM to adapt the text. For example, a prompt may include “explain difficult terms, explain phrases that may be unclear, sign and spell words that may have ambiguous definitions, and add explanations based on knowledge of the topic where it may be helpful.” In some embodiments, examples of example pairs may be provided as prompts to the LLM so that the LLM knows to make similar adaptations. Additionally or alternatively, examples of gloss or text representations of the user's signing may be provided as prompts to the LLM so that the LLM can adapt text to match the characteristics of the user's signing.

In some embodiments, the sign language generation system 1120 may obtain the adapted text from the text adaption system 1110. The sign language generation system 1120 may be configured to generate sign language that corresponds to the adapted text. The sign language generation system 1120 may generate the sign language using an avatar.

In some embodiments, the sign language generation system 1120 may be trained using any of the techniques described in this disclosure. In these and other embodiments, the sign language generation system 1120 may include one or more stages that each may include one or more machine learning models. For example, in some embodiments, the sign language generation system 1120 may include a first stage configured to generate gloss from text and a second stage configured to generate sign language from gloss. Alternately or additionally, the sign language generation system 1120 may include a single stage that converts text to sign language.

Modifications, additions, or omissions may be made to the environment 1100 without departing from the scope of the present disclosure. For example, in some embodiments, the sign language generation system 1120 may be configured to adapt the text received and then generate the sign language based on the adapted text. In these and other embodiments, the environment 1100 may not include the text adaption system 1110.

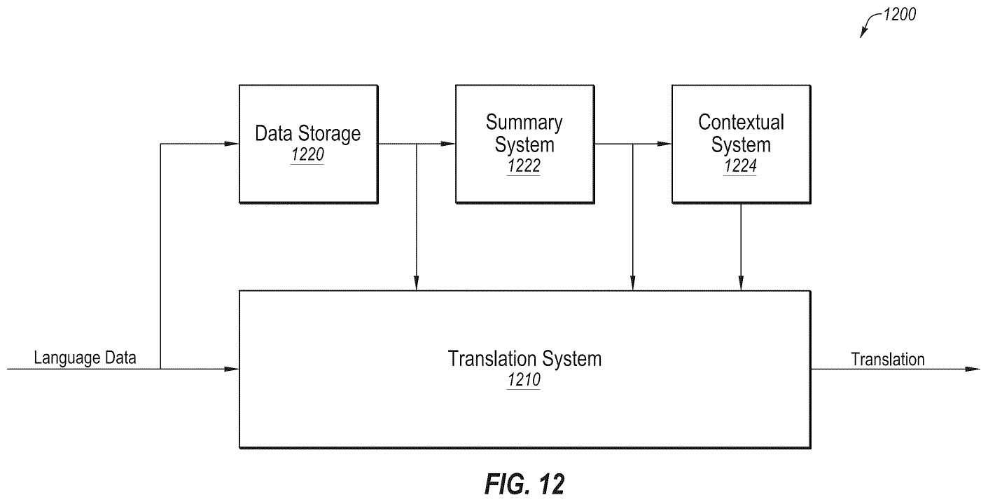

FIG. 12 illustrates an example environment 1200 for context-enhanced translation. The environment 1200 may be arranged in accordance with at least one embodiment described in the present disclosure. The environment 1200 may include a translation system 1210, a data segment storage 1220, a summary system 1222, and a contextual system 1224. The environment 1200 may be configured to enhance translation using previous information from data being translated as well as additional information related to the data being translated.

The translation system 1210 may be analogous to the translation systems discussed in this disclosure or part of a sign language processing system as discussed in this disclosure. For example, the translation system 1210 may be configured to translate between sign language and other language forms. For example, the translation system 1210 may be a sign language recognition system or sign language generation system.

In some embodiments, the environment 1200 may obtain a data stream that includes language data for translation. The data stream may be in any form of language data. For example, the data stream may include sign language, audio, or text. In these and other embodiments, the data stream may be a continuous data stream. For example, the data stream may be a stream of video that includes sign language content. In these and other embodiments, the data stream may stream into the translation system 1210 and provide different signs on a continuing basis while the data stream exists. In these and other embodiments, the data stream may be composed of data segments. In these and other embodiments, a current data segment may be a segment that is currently being provided or processed by the translation system 1210. For example, a person may be signing. A current data segment may include the one or more frames of the data stream that include a sign being signed by the person. The data stream may be provided to the data segment storage 1220 and the translation system 1210.

In some embodiments, when the translation system 1210 is a sign language recognition system, the language data obtained by the translation system 1210 may be sign language. In these and other embodiments, the translation system 1210 may generate audio or text in response to the sign language. Alternately or additionally, when the translation system 1210 is a sign language generation system, the language data obtained by the translation system 1210 may be audio or text. In these and other embodiments, the translation system 1210 may generate sign language in response to the audio or text.

In some embodiments, the data segment storage 1220 may be configured to store at least part of the data stream as the data stream is obtained by the data segment storage 1220. The data segment storage 1220 may remember elements of a conversation that may assist the translation system 1210 in interpreting subsequent parts of the conversation. For example, the data segment storage 1220 may be configured to store the data stream as stored data segments. In these and other embodiments, when a data stream commences, there may be no stored data segments. In these and other embodiments, after the data stream has been streaming, there may be multiple stored data segments.

In some embodiments, the data stream may be audio. In these and other embodiments, the data segment storage 1220 may store the audio or may be configured to convert the audio to text, such as using ASR. In these and other embodiments, the data segment storage 1220 may store the text as a representation of the audio.

In some embodiments, the data stream may be video with sign language. In these and other embodiments, the data segment storage 1220 may store the video and/or a compressed version of the video. Alternately or additionally, the data segment storage 1220 may convert the sign language to gloss or obtain gloss representations of the sign language from the translation system 1210 and store the gloss. Alternately or additionally, the data segment storage 1220 may store the sign language in the form of a sign representation. In these and other embodiments, the sign representation may be an embedding. In some embodiments, the embeddings may be encoded as vectors. For example, a gesture where the thumb touches the chin with other fingers extended as part of the ASL sign for “woman” may be encoded as a vector such as {0.21, 1.93, 0.49, −7.23, 4.90 . . . }. Additionally or alternatively, embeddings may be encoded as integers. For example, the “woman” gesture described above may be encoded as the integer 9220. Additionally or alternatively, embeddings may include glosses of sign language from video. For example, an embedding for a sequence of images portraying the sign for “woman” may be encoded as “woman.”

Alternately or additionally, the data segment storage 1220 may store a data structure constructed using one or more frames from the sign language in the data stream. For example, the data structure may include a set of images from the sign language video. Additionally or alternatively, the data structure may include a series of one or more vectors indicating the body position and velocity across one or more frames. The data structure may be used as an embedding. Additionally or alternatively, the data structure may be transformed using one or more of vector quantization, neural networks, CNNs (Convolutional Neural Networks), autoencoding, principal components analysis, spectral transforms such as FFTs and DCTs, feature extraction, wavelet transforms, discrete wavelet transforms, contrastive learning, compression, and other transformation methods to form a second data structure. The second data structure may be represented as a vector. An embedding may include the second data structure. In these and other embodiments, the second data structure may be stored by the data segment storage 1220. For example, the second data structure may be a data segment stored by the data segment storage 1220.

In some embodiments, the data segment storage 1220 may provide one or more stored data segments to the translation system 1210 and the summary system 1222. In some embodiments, the data segment storage 1220 may send all the stored data segments. Alternately or additionally, the data segment storage 1220 may send some of the stored data segments, such as segments occurring within a threshold period of the current data segment. In these and other embodiments, the threshold period may vary based on the data stream. For example, when a topic of the data stream changes, the period may reset such that only data segments associated with the current topic may be provided to the translation system 1210 and the summary system 1222.

In some embodiments, the translation system 1210 may use the stored data segments for translating the current data segment. In these and other embodiments, the stored data segments may provide context for translating the current data segment. For example, if the data stream includes signing that includes a spelling of a name and then indicates what the name sign is for the name, when the name sign is provided again, the stored data segment may provide context for the spelling of the name in the text generated by the translation system 1210.

In these and other embodiments, the stored data segments providing context for translating the current data segment may include assisting the translation system 1210 to select one or more words for the translation when the one or more words are based on the prior text. For example, the stored data segments may affect the probability of a word to be selected as a translation for the current data segment. The probably of a word may guide the translation system 1210 in selecting the next word for the translation.

For example, if the stored data segments contains prior words “I wanted to” and the next word in the data stream appears to be “say” or “disappointed” (two signs that look similar in ASL) and each word has a similar probability to be correct based on interpretation of the sign, the translation system 1210 may select “say” because “say” is more likely than “disappointed.” given the prior context. As another example, if a signer points to the side, the sign could reasonably be interpreted as “it.” “he.” “she.” or “there” in ASL. In response to the stored data segments including recent representations of signs indicating a female, the translation system 1210 may use the stored data segments to interpret the sign as “she.”

In some embodiments, the summary system 1222 may obtain the stored data segments from the data segment storage 1220. In these and other embodiments, the summary system 1222 may be configured to generate a summary of the stored data segments. In these and other embodiments, the summary may include salient points or decisions from the language data. For example, the summary may include information regarding an overarching theme of the data stream, or general topics of the data stream, or particular relevant facts from the data stream. In some embodiments, the summary system 1222 may provide the summary to the translation system 1210 and the contextual system 1224. In these and other embodiments, the translation system 1210 may use the summary to provide context to the current data segment during translation of the current data segment.

In some embodiments, the contextual system 1224 may obtain the summary from the summary system 1222. In these and other embodiments, the contextual system 1224 may be configured to obtain contextual data based on the summary, such as based on a topic in the summary, provided from the summary system 1222. The contextual data may provide context, relevance, or meaning to the current data segment with respect to the summary and/or topic from the summary. The contextual data may assist in understanding the topic more comprehensively by situating the topic within a broader framework, environment, or scenario or providing additional information regarding the topic. In these and other embodiments, the contextual system 1224 may include an LLM that may be trained to provide contextual data based on summary data provided by the summary system 1222. The contextual system 1224 may provide the contextual data to the translation system 1210. In these and other embodiments, the translation system 1210 may use the contextual data to provide context to the current data segment during translation of the current data segment.

As an example, a sign language capable person may be talking to a representative at the Social Security Administration. In these and other embodiments, the summary may contain information such as why the sign language capable person placed the call and what benefits the sign language capable person is currently receiving. The contextual data may include general information regarding how to collect benefits, how to change the mailing address on record, and other information that may be relevant in the conversation. This information may help guide the translation system 1210 in interpreting instructions from the representative on, for example, how to change the user's mailing address.

In some embodiments, the translation system 1210 may be trained by providing the translation system 1210 with contextual data, summaries, and/or stored data segments during the training to allow the translation system 1210 to learn how to use the contextual data, summaries, and/or stored data segments to better translate language data.

Modifications, additions, or omissions may be made to the environment 1200 without departing from the scope of the present disclosure. For example, the environment 1200 may include one or more of the data segment storage 1220, the summary system 1222, and/or the contextual system 1224. Thus, the example environment 1200 may only include one or any combination of two of the data segment storage 1220, the summary system 1222, and the contextual system 1224. In these and other embodiments, only one, two, or all three of the data segment storage 1220, the data summary system 1222, and the contextual system 1224 may be configured to provide data to the translation system 1210.

As another example, the environment 1200 may be part of a sign language processing system, such as the sign language processing system 140, 210, or 910 of FIGS. 1, 2A-2C, and 9. In these and other embodiments, the concepts of FIG. 11 may be incorporated into the environment 1200. For example, a text adaption system may be provided in the environment 1200 before the data segment storage 1220.

As another example, the environment 1200 may include another translation system. For example, the translation system 1210 may be a sign language generation system and the other translation system may be a sign language recognition system. In these and other embodiments, a communication session may be occurring between a sign language capable person and a sign language incapable person that may be utilizing both the sign language generation system and the sign language recognition system to allow communication between the sign language capable person and a sign language incapable person. In these and other embodiments, the context of the entire communication session may be helpful for each of the sign language generation system and the sign language recognition system. In these and other embodiments, the data segment storage 1220 for each of the sign language generation system and the sign language recognition system may store data segments based on sign language from the sign language capable person and audio from the sign language incapable person. In these and other embodiments, the summary system 1222 and the contextual system 1224 may generate outputs based on the data segments from one or both the sign language and audio.

As another example, the data segment storage 1220 may store data segments from previous data streams and may incorporate those data segments when applicable to a current data streams. For example, the data stream may be from a communication session. In these and other embodiments, data segments from previous communication sessions between the same parties may be used by the data segment storage 1220 and provided to the translation system 1210 and the summary system 1222.

As another example, the environment 1200 may be operating as a real-time environment. Alternately or additionally, the environment 1200 may operate as a near-real-time environment or non-real-time environment. In these and other embodiments, additional information may be provided to the data segment storage 1220. For example, the translation system 1210 may incorporate a delay. The delay may give the translation system 1210 access to one or more future data segments. In these and other embodiments, the future data segments may be incorporated into the data segment storage 1220 and/or may affect the summary generated by the summary system 1222 and/or the contextual data generated by the contextual system 1224. For example, in recognizing a given sign in a video recording, the translation system 1210 may be responsive to information occurring both before and after the given sign.

As another example, the translation may be provided to an LLM as a post processing step. For example, the output of the translation system 1210 may be given to an LLM along with a prompt such as, “This output was created by automated translation software and may contain errors. Please fix the errors.”

As another example, the data segment storage 1220 may be omitted, and the language data may be provided directly to the summary system 1222. As another example, the summary system 1222 may be omitted, and the language data or stored data from the data segment storage 1220 may be provided directly to the contextual system 1224. In these and other embodiments, the contextual system 1224 may use the language data to search for contextual data.

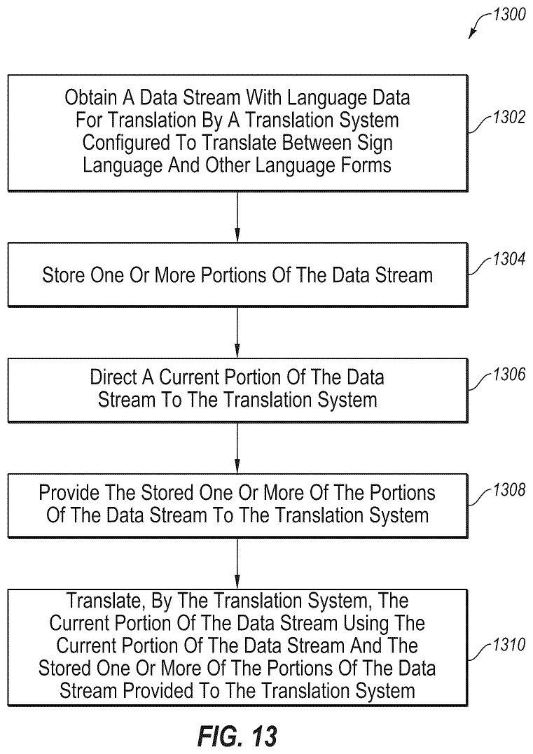

FIG. 13 illustrates a flowchart of an example method 1300 for context-enhanced translation. The method 1300 may be arranged in accordance with at least one embodiment described in the present disclosure. One or more operations of the method 1300 may be performed, in some embodiments, by a device or system, such as the sign language processing system 140, the sign language processing system 210a, the sign language processing system 210b, the sign language processing system 210c, the sign language processing system 910, the translation system 1210 described in FIGS. 1, 2A-2C, 9, and 12, another system described in this disclosure or another device or combination of devices. In these and other embodiments, the method 1300 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 1300 may begin at block 1302, where a data stream with language data for translation by a translation system configured to translate between sign language and other language forms may be obtained. In some embodiments, the translation system may be configured for sign language recognition or sign language generation. In these and other embodiments, the language data may be sign language, audio, or text.

At block 1304, one or more portions of the data stream may be stored. In some embodiments, the language data may be sign language and the stored portions of the data stream may include representations of sign language content in the data stream previously obtained and directed to the translation system. Alternately or additionally, the language data may be audio and the stored portions of the data stream may include text representing words in the audio of the data stream previously obtained and directed to the translation system.

At block 1306, a current portion of the data stream may be directed to the translation system. At block 1308, the stored one or more of the portions of the data stream may be provided to the translation system.

At block 1310, the current portion of the data stream may be translated by the translation system using the current portion of the data stream and the stored one or more of the portions of the data stream provided to the translation system. In some embodiments, the translation system may include one or more machine learning models, and the one or more machine learning models may be previously trained to translate the current portion of the data stream using stored portions of the data stream.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For example, the method 1300 may further include generating a summary of one or more of the stored one or more of the portions of the data stream and providing the summary to the translation system. In these and other embodiments, the current portion of the data stream is translated further based on the summary.

Alternately or additionally, the method 1300 may further include determining a topic of the language data in the data stream and obtaining contextual data regarding the topic. In these and other embodiments, the method 1300 may further include providing the contextual data to the translation system. In these and other embodiments, the current portion of the data stream may be translated further based on the contextual data.

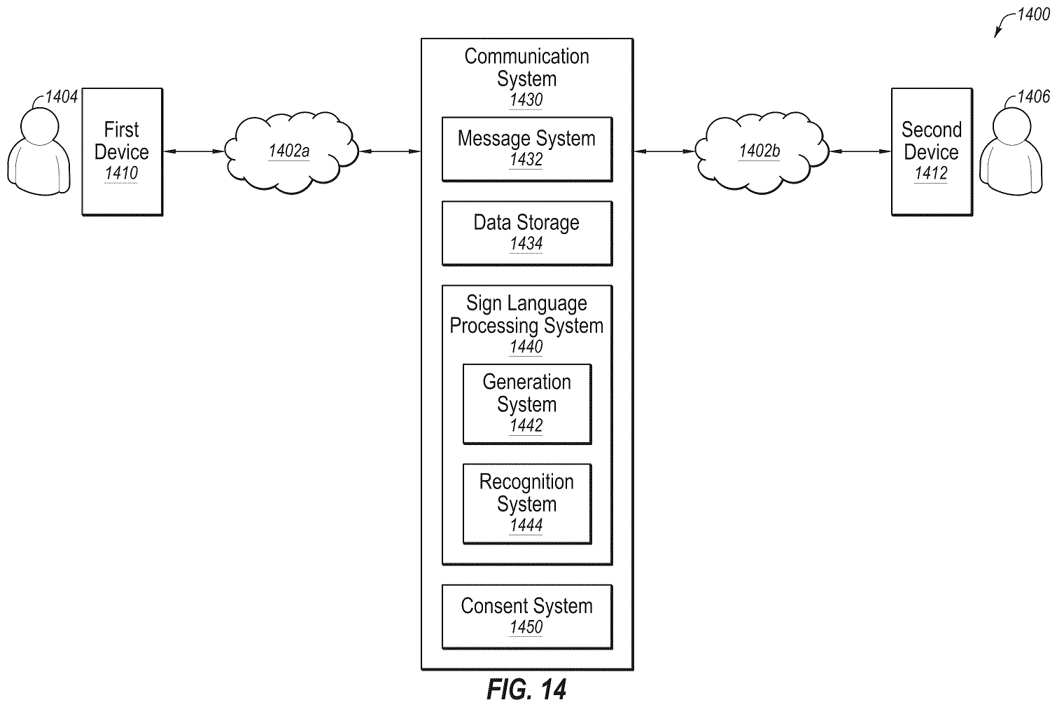

FIG. 14 illustrates an example environment 1400 for training via voice messages. The environment 1400 may be arranged in accordance with at least one embodiment described in the present disclosure. The environment 1400 may include a first network 1402a and a second network 1402b, referred to as networks 1402, a first device 1410, a second device 1412, and a communication system 1430 that includes a message system 1432, a data storage 1434, a sign language processing system 1440 that includes a sign language generation system 1442 and a sign language recognition system 1444, and a consent system 1450.

The networks 1402, the first device 1410, the second device 1412, and the communication system 1430 may be analogous to the networks 102, the first device 110, the second device 112, and the communication system 130 of FIG. 1. In these and other embodiments, the description of these elements may be applicable in the environment 1400. The sign language generation system 1442 and/or the sign language recognition system 1444 may be analogous to the translation system 212, the translation system 220, the translation systems 240, translation system 1210 of FIGS. 2A, 2B, 2C, and 12. In these and other embodiments, the description of these elements may be applicable in the environment 1400. Further, the environment 1400 may include a first user 1404 that may be associated with the first device 1410 and may be a sign language capable person. Further, the environment 1400 may include a second user 1406 that may be associated with the second device 1412 and may be a sign language incapable person.

In some embodiments, the environment 1400 may be configured to record audio messages for the first user 1404 when the first user 1404 is not available to participate in the communication session. A video message with sign language content may be generated from the recorded audio message and the video message and the recorded audio message may be used to train machine translation systems to translate between sign language and language data.

In some embodiments, the second device 1412 may send a request to the communication system 1430 for a communication session with the first device 1410. The communication system 1430 may attempt to establish the communication session. In these and other embodiments, the first device 1410 may establish the communication session in response to obtaining input from the first user 1404. When input from the first user 1404 is not obtained, the communication session may not be established. In response to the communication session not being established, the communication system 1430 may allow the second user 1406 to leave an audio message for the first user 1404.

In some embodiments, the message system 1432 may be configured to interface with the second user 1406 via the second device 1412 to allow the second user 1406 to record an audio message for the first user 1404. For example, the message system 1432 may prompt the second user 1406 to leave an audio message that may be recorded by the communication system 1430. In these and other embodiments, the audio message may be recorded and stored in the data storage 1434. In some embodiments, text of the audio message may be obtained as the audio message is received by the communication system 1430. For example, an ASR system may generate text of the audio message as the audio message is received. In these and other embodiments, the text may be stored with the data storage 1434. Alternately or additionally, text may be generated of the audio message after the audio message is obtained and stored in the data storage 1434.

In some embodiments, the audio message may be associated with the first user 1404 in the data storage 1434. In these and other embodiments, being associated with the first user 1404 may indicate that the audio message may be tagged so that the first device 1410 and/or the first user 1404 may be alerted of the audio message and the audio message or a translation of the audio message, such as a video with sign language content, may be presented to the first user 1404. In these and other embodiments, the audio message being associated with the first user 1404 may also provide context regarding whether consent is obtained with respect to the audio message. Alternately or additionally, the audio message may also be associated with the second user 1406. In these and other embodiments, the audio message being associated with the second user 1406 may context regarding whether consent is obtained with respect to the audio message.

In some embodiments, the message system 1432 may include basis instructions and/or a recording from the first user 1404. Alternately or additionally, the message system 1432 may include an interactive voice response (IVR) system. In these and other embodiments, the IVR system may be configured to provide dialogue to the second user 1406 based on interactions between the IVR system and the second user 1406. In some embodiments, the dialogue may be driven by a call flow that includes statements responsive to audio obtained from the second user 1406. Alternately or additionally, the dialogue may be driven by an LLM that analyzes the interactions with the second user 1406 and dynamically determines how to continue the dialogue with the second user 1406. In these and other embodiments, in response to the LLM concluding that the second user 1406 wishes to leave an audio message for the first user 1404 that may be translated to sign language, the LLM may indicate to the second user 1406 to begin leaving the audio message. In these and other embodiments, the LLM may be configured to interact with the second user 1406 based on one or more prompts provided to the LLM. An example prompt may include the following “Ask a caller if they want to leave a message using SignMail®. If the caller appears confused or does not know what Sign Mail is, explain that the party called by the caller is deaf person and that SignMail allows the caller to record an audio message that will be interpret it into sign language so that the deaf person can watch a signed version of the audio message from the caller. If the caller does not want to leave SignMail, say goodbye and hang up. If the caller wants to leave SignMail, say ‘Please begin your message now’ and start the recording.”

In some embodiments, the sign language processing system 1440 may be configured to translate the audio message to a video with sign language content. In these and other embodiments, the sign language recognition system 1444 may be configured to automatically generate a video message with sign language content using the audio message. In these and other embodiments, the sign language recognition system 1444 may use one or more machine learning models to generate the video. The video may include an avatar performing the sign language content. In these and other embodiments, the sign language recognition system 1444 may generate the video using the text generated based on the audio message.

In some embodiments, the sign language recognition system 1444 may generate the video after the audio message is stored in the data storage 1434 and before the first user 1404 requests to see the video. For example, the sign language recognition system 1444 may generate the video as the audio message is received or after the audio message is received and before the user requests to view the video. Alternately or additionally, the sign language recognition system 1444 may be configured to generate the video in response to a request to view a video corresponding to the audio message by the first user 1404. For example, in response to a request to view a video from the first user 1404, the sign language recognition system 1444 may generate the video and direct the video to the first device 1410 for presentation to the first user 1404. In these and other embodiments, the video may be stored in the data storage 1434. After storing the video, in response to the first user 1404 requesting the video again, the stored video may be provided to the first user 1404. Alternately or additionally, the video may not be stored and may be generated in response to a request to view the video.

In some embodiments, the sign language processing system 1440 may be configured to use the voice message, text associated with the voice message, and/or the video generated by the sign language recognition system 1444 to train one or more machine learning models of either the sign language recognition system 1444 and/or the sign language generation system 1442. In these and other embodiments, the sign language processing system 1440 may train the one or more machine learning models as described in this disclosure, such as described with respect to FIGS. 2A, 2B, and 2C, among others.

In some embodiments, the consent system 1450 may be configured to determine when consent is obtained to use the audio message and/or the text and video generated from the audio message. For example, the consent system 1450 may be configured to store information regarding consent obtained from the first user 1404 and the second user 1406. In these and other embodiments, the consent from the second user 1406 may be obtained at the time that the audio message is obtained. In these and other embodiments, the consent from the first user 1404 may be obtained when the first user 1404 subscribes to or begins using services of the communication system 1430, before the voice message is recorded, or after the video is presented to the first user 1404. In some embodiments, the consent from the first user 1404 may be obtained for all videos that may be generated by the communication system 1430. Alternately or additionally, the consent from the first user 1404 may be obtained for each video individually. Alternately or additionally, the first user 1404 may provide a general consent and revoke consent for individual videos. In these and other embodiments, the second user 1406 may provide consent the first time the second user 1406 interacts with the communication system 1430 for the current and all future interactions. Alternately or additionally, the communication system 1430 may obtain consent from the second user 1406 each time that the second user 1406 provides an audio message to the communication system 1430.

Before an audio message, text, or video is used for training, the consent system 1450 may determine if a required consent has been obtained. In response to the required consent being obtained, the consent system 1450 may indicate that the audio message, text, and/or video may be used by the sign language processing system 1440 for training. In response to the required consent not being obtained, the consent system 1450 may indicate that the audio message, text, and/or video may not be used by the sign language processing system 1440 for training. In some embodiments, the required consent may be consent from the first user 1404, the second user 1406, or both the first user 1404 and the second user 1406. The consent required may be based on the location of the first user 1404, the second user 1406, and/or the communication system 1430. The consent required may be further based on laws in force in the respective locations. The consent required may be further based on policies determined by the entity responsible for one or more of the hardware elements included in environment 1400.

In some embodiments, further training data may be obtained by the communication system 1430. For example, in some embodiments, labels for the audio, text, and/or video may be obtained. For example, the labels may provide additional information for training by the sign language processing system 1440. For example, labels for an audio message may include timestamps showing the beginning and ending of each spoken word. Labels for text may include marked up text indicating the vocal expression of the speaker at select points in the audio message. Labels for the video may include timestamps showing when each sign begins and ends in the video and/or labels identifying which sign a particular segment of video represents. In these and other embodiments, the labels may be obtained from a user associated with the communication system 1430 or an automated system.

Modifications, additions, or omissions may be made to the environment 1400 without departing from the scope of the present disclosure. For example, in some embodiments, one or more human interpreters may be used by the sign language processing system 1440. For example, the human interpreters may listen to the audio and a video of the human interpreters performing sign language may be captured. Alternately or additionally, the human interpreters may correct the videos generated by the sign language recognition system 1444.

As another example, in some embodiments, one or more human interpreters may be used by the communication system 1430 to interact with the second user 1406 in place of the message system 1432.

As another example, the communication system 1430 may be configured to provide a choice to the first user 1404 to allow the audio message associated with the first user 1404 to be translated by the sign language recognition system 1444 or a human interpreter. In these and other embodiments, the choice of the first user 1404 may be stored. In these and other embodiments, the choice may be for all voice messages until changed or for individual voice messages. In these and other embodiments, the first user 1404 may make a choice by providing input to the first device 1410, such as by selecting a button.

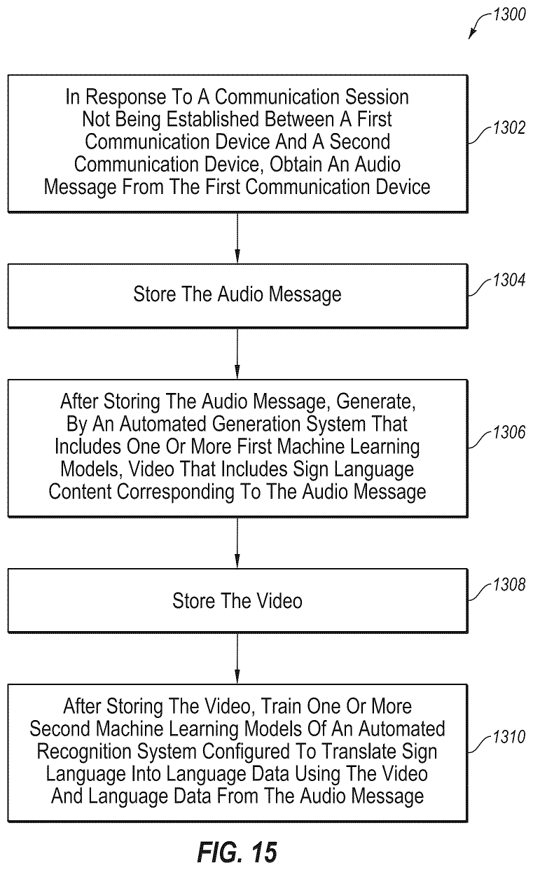

FIG. 15 illustrates a flowchart of an example method 1500 for training via voice messages. The method 1500 may be arranged in accordance with at least one embodiment described in the present disclosure. One or more operations of the method 1500 may be performed, in some embodiments, by a device or system, such as the communication system 1430 and communication system 1430 described in FIGS. 1 and 14, another system described in this disclosure or another device or combination of devices. In these and other embodiments, the method 1500 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 1500 may begin at block 1502, where an audio message may be obtained from a first communication device in response to a communication session not being established between the first communication device and a second communication device. At block 1504, the audio message may be stored.

At block 1506, after storing the audio message, video that includes sign language content corresponding to the audio message may be generated by an automated generation system that includes one or more first machine learning models. In these and other embodiments, the video may be generated in response to a request from a user associated with the second communication device to view the video. At block 1508, the video may be stored.

At block 1510, after storing the video, one or more second machine learning models of an automated recognition system configured to translate sign language into language data may be trained using the video and language data from the audio message. Alternatively or additionally, one or more third machine learning models of an automated generation system configured to translate language data into sign language may be trained using the video and language data from the audio message.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For example, the method 1500 may further include before training the automated recognition system, obtaining consent from at least one of a first user associated with the first communication device and a second user associated with the second communication device.

As another example, the method 1500 may further include after storing the video, training one or more of the first machine learning models of the automated generation system using the video and the language data.

As another example, the method 1500 may further include before obtaining the audio message, directing second audio to the second communication device. In these and other embodiments, second audio may be generated via an automated system to interact with a user of the second communication device.

As another example, the method 1500 may further include transcribing the audio message using automated speech recognition to generate text corresponding to the sign language content, wherein the text is used to train the one or more second machine learning models.

As another example, the method 1500 may further include storing multiple audio messages and corresponding videos that include the audio message and the video. In these and other embodiments, each of the audio messages may be generated from a different communication session not being established. The method 1500 may further include determining which of the audio messages and corresponding videos are usable for training and training the one or more second machine learning models of the automated recognition system using the audio messages and corresponding videos determined to be usable for training. In these and other embodiments, a first audio message and corresponding first video may be determined to be usable for training based on obtaining consent from one or more users associated with the first audio message.

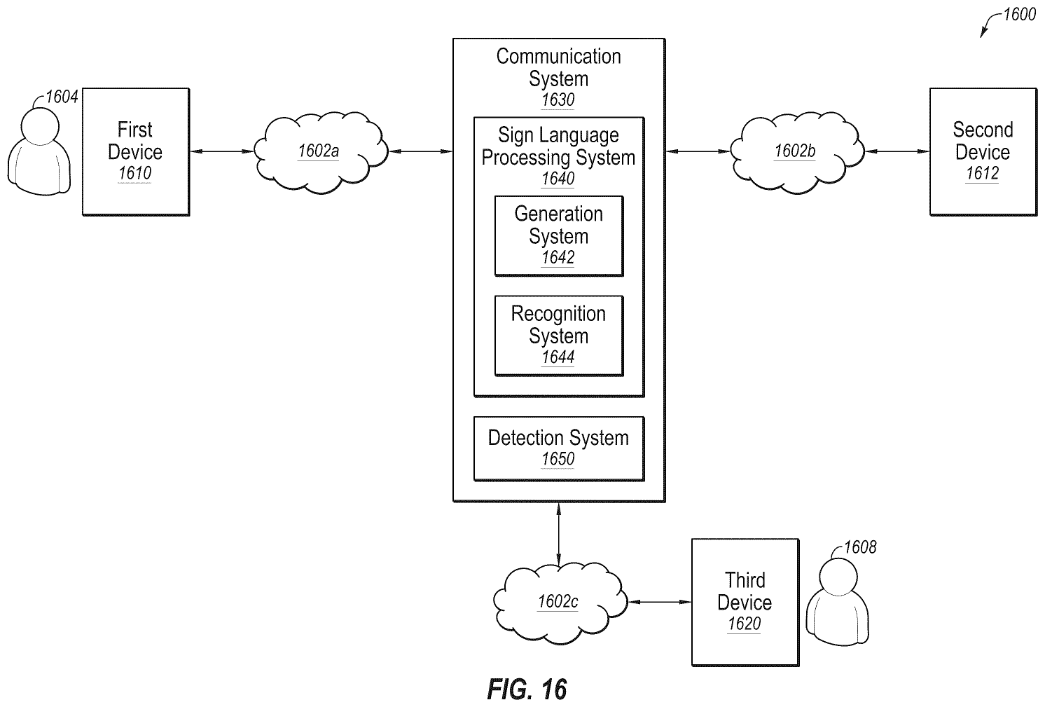

FIG. 16 illustrates an example environment 1600 for switching between translation processes. The environment 1600 may be arranged in accordance with at least one embodiment described in the present disclosure. The environment 1600 may include a first network 1602a, a second network 1602b, and a third network 1602c, referred to as networks 1602, a first device 1610, a second device 1612, a third device 1620, and a communication system 1630 that includes a sign language processing system 1640, which includes a sign language generation system 1642 and a sign language recognition system 1644, and a detection system 1650.

The networks 1602, the first device 1610, the second device 1612, the third device 1620, and the communication system 1630 may be analogous to the networks 102, the first device 110, the second device 112, the third device 120, and the communication system 130 of FIG. 1. In these and other embodiments, the description in FIG. 1 of these elements may be applicable in the environment 1600. The sign language generation system 1642 and/or the sign language recognition system 1644 may be analogous to the translation system 212, the translation system 220, the translation systems 240, translation system 1210 of FIGS. 2A, 2B, 2C, and 12. In these and other embodiments, the description of these elements may be applicable in the environment 1600. Further, the environment 1600 may include a first user 1604 that may be associated with the first device 1610 and may be a sign language capable person. Further, the environment 1600 may include a third user 1608 that may be associated with the third device 1620 and may be a sign language capable person.

In some embodiments, the communication system 1630 may be configured to select between a first translation process and a second translation process to handle a communication session between the first device 1610 and the second device 1612. In these and other embodiments, the first translation process may be performed by the sign language processing system 1640. In these and other embodiments, the first translation process may be an automated process that uses the sign language generation system 1642 to generate sign language content from audio, such as audio from the second device 1612. In these and other embodiments, the first translation process may use the sign language recognition system 1644 to generate audio from sign language content in audio, such as sign language in a video from the first device 1610. Further discussion regarding the first translation process is described with respect to FIG. 12 and may be applicable in the environment 1600.

In some embodiments, the second translation process may incorporate the third device 1620 and the third user 1608. For example, the third device 1620 may present audio to the third user 1608 and the third device 1620 may capture video of the third user 1608 performing sign language based on the audio. Alternately or additionally, the third device 1620 may present a video with sign language and the third device 1620 may capture audio with speech from the third user 1608 that is a translation of the sign language in the video. A similar process to the second translation process is described with respect to FIG. 1 and may be applicable in the environment 1600.

In some embodiments, the communication system 1630 may be configured to select automatically and independently between the first and second translation processes. In these and other embodiments, the communication system 1630 may select between the first and second translation processes based on one or more features of the communication session. In these and other embodiments, the detection system 1650 may be configured to monitor the features of the communication session and select between the first and second translation processes. In these and other embodiments, the detection system 1650 may obtain information from either of the third device 1620 and the sign language processing system 1640 in selecting between the first and second translation processes.

In some embodiments, the detection system 1650 may select the first translation process in response to the features of the communication session indicating a lower difficulty of translation between sign language and language data. The difficulty of translation may be lower when there is a limited scope of speech to translate, an expected number of topics during the communication session, an expected clarity of the audio, an expected accents of speech, among other factors. For example, for a communication session with a limited scope of speech, such as with an IVR system, the detection system 1650 may select the first translation process. As another example, for a communication session with a limited scope of speech, such as with a particular business handling routine calls, such as scheduling appointments for a hair stylist or handling routine transactions, or placing orders on a menu, the detection system 1650 may select the first translation process. As another example, for a communication session with expected clarity of audio, such as one with a good network connection, the detection system 1650 may select the first translation process. As another example, for a communication session with a second device 1612 where the speech is typically well pronounced, slow, clear, and well formulated, such as communicating with a business, the detection system 1650 may select the first translation process.

In some embodiments, in response to the features of the communication session not indicating a lower difficulty of translation between sign language and language data, the detection system 1650 may select the second translation process for a communication session.

In some embodiments, the features of the communication session may include information about the second device 1612. The information may include whether the second device 1612 is associated with a business, corporation, or other entity that may have limited topics of speech. Alternately or additionally, the information may include whether the second device 1612 is associated with an IVR system. In these and other embodiments, the detection system 1650 may determine information about the second device 1612 based on an identifier used to establish the communication session with the second device 1612. For example, a number may be used to establish a communication session with the second device 1612. Using the number, the detection system 1650 may determine information about the second device 1612 and select between the first and second translation processes.

In some embodiments, the features of the communication session may include information about the audio of the communication session. The audio of the communication session may indicate a lower difficulty of translation between sign language and language data. For example, the audio may indicate the second device 1612 is associated with a business or an IVR system. In these and other embodiments, the detection system 1650 may determine that the audio is associated with an IVR system or business by using ASR to recognize the wording and comparing the wording to an index of IVR or business phrases. Alternately or additionally, the detection system 1650 may determine that the audio is associated with an IVR system or business based on speaking rates, level of professionalism in the voice, or keywords such as, “Thank you for calling . . . ” or “Press one.” Alternately or additionally, the detection system 1650 may determine that the audio is associated with an IVR system or business by converting the audio to text using ASR and feeding the ASR output to a natural language processing classifier configured to detect IVR systems or businesses

In some embodiments, the sign language processing system 1640 may be trained to handle some IVR systems and not other IVR systems. For example, the sign language processing system 1640 may be configured to handle IVR systems for banks but not doctor's offices. Alternately or additionally, the sign language processing system 1640 may be configured to handle more basic IVR systems. For example, the sign language processing system 1640 may be configured with a vocabulary and/or exact sentences recited by an IVR system. In these and other embodiments, the sign language processing system 1640 may also be trained to recognize likely responses from the first device 1610 in response to IVR prompts. In some embodiments, in response to the IVR prompts being long, complex, or confusing, the sign language processing system 1640 may summarize or simplify the prompts using the concepts of FIG. 11. In these and other embodiments, the detection system 1650 may select the first translation process in response to identifying that the communication session is with an IVR system for which the sign language processing system 1640 is trained to handle.

In some embodiments, the sign language processing system 1640 may be configured to handle a communication session with an IVR system. For example, the sign language processing system 1640 may be configured to play DTMF signals to the IVR system to navigate the IVR menu. Alternately or additionally, the sign language generation system 1642 may use predetermined responses for responding to the IVR menu. The predetermined responses may be determined based on input from the first user 1604 and/or based on a pattern of usage by the first user 1604.

In some embodiments, the detection system 1650 may consider previous communication sessions in selecting between the first and second translation processes. In these and other embodiments, in response to the sign language processing system 1640 not handling a previous communication session with the second device 1612 well, the detection system 1650 may not select the sign language processing system 1640, e.g., the first translation process, for another communication session with the second device 1612.

In some embodiments, the detection system 1650 may decide to switch between the first translation process and the second translation process during a communication session. For example, in response to the first translation process not being able to properly translate the communication session, the detection system 1650 may switch to the second translation process. As another example, in response to the audio of the communication changing, such as when the first device 1610 is placed on hold or directed to an IVR system, the detection system 1650 may switch from the second translation process to the first translation process. In these and other embodiments, the detection system 1650 may determine the first device 1610 is placed on hold based on comparing the speech of the communication session indicating that the first device 1610 is being placed on hold. Alternately or additionally, the detection system 1650 may determine the detection system 1650 is being placed on hold in response to the audio of the communication session including silence or music. In these and other embodiments, in response to being placed on hold, the first translation process may provide sign language indicating the first device 1610 is placed on hold. In these and other embodiments, the first translation process may continue to provide the sign language for being placed on hold during the duration of being placed on hold. In these and other embodiments, the detection system 1650 may switch between the first and second translation processes multiple times during the same communication session.

In some embodiments, the third user 1608 may send a request to the detection system 1650 to switch to the first translation process. In these and other embodiments, in response to the request to switch, the detection system 1650 may direct the communication system 1630 to use the first translation process instead of the second translation process.

In some embodiments, the first user 1604 may select between the first and the second translation processes. For example, the first device 1610 may obtain input from the first user 1604 regarding selection of one of the translation processes. In these and other embodiments, the communication system 1630 may implement the translation process selected by the first user 1604. The input from the first user 1604 may apply to a current call and/or the input may apply to subsequent future calls.

Modifications, additions, or omissions may be made to the environment 1600 without departing from the scope of the present disclosure. For example, the environment 1600 may include multiple second devices 1612. In these and other embodiments, communications with one of the second devices 1612 may be handled via the first translation process and communications with another of the second devices 1612 may be handled via the second translation process.

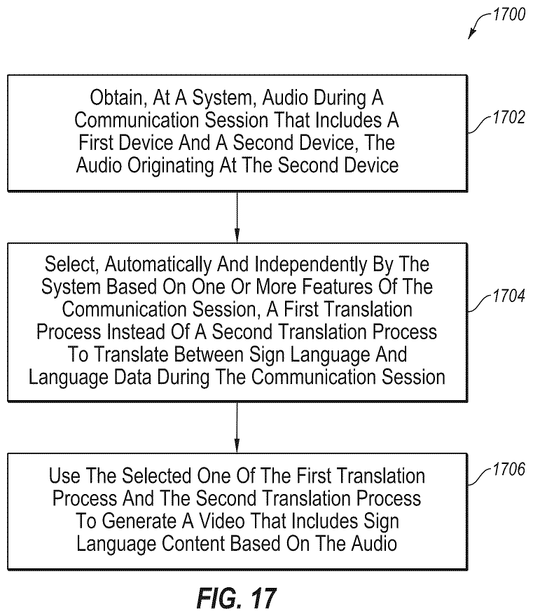

FIG. 17 illustrates a flowchart of an example method 1700 for switching between translation processes. The method 1700 may be arranged in accordance with at least one embodiment described in the present disclosure. One or more operations of the method 1700 may be performed, in some embodiments, by a device or system, such as the communication system 130, the communication system 1430, and the communication session 1630 described in FIGS. 1, 14, and 16, another system described in this disclosure or another device or combination of devices. In these and other embodiments, the method 1700 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 1700 may begin at block 1702, where audio may be obtained at a system during a communication session that includes a first device and a second device. In these and other embodiments, the audio may originate at the second device.

At block 1704, a first translation process may be selected, automatically and independently by the system based on one or more features of the communication session, instead of a second translation process to translate between sign language and language data during the communication session. In these and other embodiments, the one or more features of the communication session may include content of the audio of the communication session. In these and other embodiments, the one or more features of the communication session may include a number associated with the second device that is used to establish the communication session.

In some embodiments, each of the first translation process and the second translation process may be further configured to generate second audio for directing to the second device based on a second video obtained from the first device that includes sign language content.

At block 1706, the selected one of the first translation process and the second translation process may be used to generate a video that includes sign language content based on the audio.

In some embodiments, the first translation process may be fully automated, and the second translation process may include a third device configured to present video and audio to a user of the third device.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments. For example, the method 1700 may further include after utilizing the selected one of the first translation process and the second translation process for a first portion of the communication session, selecting the other one of the first translation process and the second translation process to translate between sign language and language data for a second portion of the communication session. In these and other embodiments, the other one of the first translation process and the second translation process may be selected based on changes to the audio in the communication session. In these and other embodiments, the changes to the audio may include the audio including silence or music. Alternately or additionally, the changes to the audio may include the audio including speech.

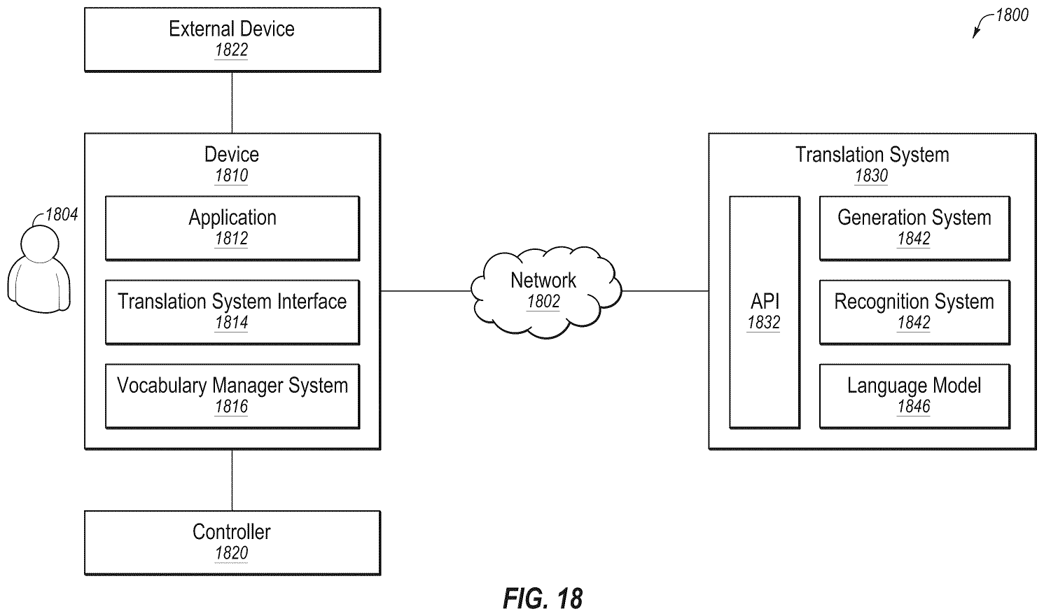

FIG. 18 illustrates an example environment 1800 for sign language processing. The environment 1800 may be arranged in accordance with at least one embodiment described in the present disclosure. The environment 1800 may include a network 1802, a device 1810, which may include an application 1812, a translation system interface 1814, and vocabulary manager system 1816, an external device 1822, a controller 1820, and a translation system 1830 that includes an API, 1832, a sign language generation system 1842, a sign language recognition system 1844, and a language model data storage 1846.

The network 1802 and the device 1810 may be analogous to the networks 102 and the first device 110 of FIG. 1. In these and other embodiments, the description of FIG. 1 of these elements may be applicable in the environment 1800. The translation system 1830, the sign language generation system 1842 and/or the sign language recognition system 1844 may be analogous to the translation system 212, the translation system 220, the translation systems 240, and the translation system 1210 of FIGS. 2A, 2B, 2C, and 12. In these and other embodiments, the description of these elements may be applicable in the environment 1800. Further, the environment 1800 may include a user 1804 that may be associated with the device 1810 and may be a sign language capable person.

In some embodiments, the translation system 1830 may be configured to provide translation between sign language and language data for the device 1810. The application program interface (API) 1832 may be configured to enable communication between the translation system 1830 and the device 1810. In some embodiments, the device 1810 may include a computing device such as a personal computer, a laptop, a smartphone, a tablet, a car, a smart display such as a smart TV, a telephone, a video calling device, a video conferencing system, a home entertainment system, a public entertainment system such as a theater system, a robot, an intelligent home device, a smart speaker, a wearable device such as smart glasses, a sales or information kiosk, or an information display in a public venue such as a retail store, warehouse, or transportation center. Alternately or additionally, the operations performed by the device 1810 may be a software package such as a smartphone application, a browser running on a computing device, an interface to computer software such as dictation or word processing software, or an interpreter application that causes the device on which the application runs to perform operations. In some embodiments, the application 1812 may be software that controls operation of the device 1810. In these and other embodiments, the application 1812 may include a dialog system or chatbot.

In some embodiments, the device 1810 may be associated with a controller 1820 that enables a person or a separate computer system to give the device 1810 instructions and to receive communication from the device 1810. The controller 1820 may be a network server, an application server, a dialog manager, a TV remote, a smartphone or tablet app, a car dashboard, a web server, or a database. In some embodiments, the controller 1820 may direct the device 1810 to connect to a specified entertainment source, connect to a specified communication channel such as a conference bridge or podcast, play a movie or TV show, connect to a specified user, or connect to a specified website or software application. The controller 1820 may be connected to or part of the device 1810 or it may be remotely located and connected to the device 1810 via one or more networks or wired or wireless connections.

In some embodiments, the device 1810 may be communicatively coupled to the translation system 1830 via the network 1802. In some embodiments, the communication between the device 1810 and the translation system 1830 may pass through the network 1802. In some embodiments, the translation system interface 1814 may manage communication with the translation system 1830 via the API 1832. In some embodiments, the translation system interface 1814 may be a software application, a plug-in such as a browser plug-in, or software configured to connect to the translation system 1830.

In some embodiments, the device 1810 may present entertainment, information, or video from a communication session. For example, the device 1810 may present video of another person. In some embodiments, a display of the device 1810 may include an inset. The inset may include a window or region on the display that shows a sign language interpreter. The inset may include a rectangular region in a corner of the display. The sign language interpreter may be an avatar, such as is generated by the sign language generation system 1842. In these and other embodiments, the translation system 1830 may obtain language data from the device 1810. The translation system 1830 may generate sign language based on the language data and provide the sign language to the device 1810 for presentation via the display. In these and other embodiments, the language data for translation may come from a movie, news broadcast, television show, internet website, software application, conference call, video call, or object.

In some embodiments, the device 1810 may be communicatively coupled with the external device 1822. In these and other embodiments, control or content data may pass from the device 1810 to the external device 1822, from the external device 1822 to the device 1810, or in both directions. In some embodiments, the external device 1822 may be a remote controlled drone, a weapon, a robot such as a home automation robot, a food ordering service such as a drive-through ordering system, a manufacturing robot, a telephone, a videophone, a smartphone, a speakerphone, a communication device associated with a person with whom the user 1804 wishes to speak, an IVR system, an external display, a home device such as an oven or an entertainment system, a communication system such as a video conferencing system, or a toy.

In some embodiments, the user 1804 may perform sign language. The device 1810 may generate video that includes the user 1804 performing sign language and send the video to the translation system interface 1814. In these and other embodiments, the translation system 1830 may generate language data that represents the sign language in the video and direct the language data back to the device 1810 via the translation system interface 1814.

In some embodiments, to allow communication between the device 1810 and the translation system 1830, the translation system interface 1814 may request a communication session with the API 1832. In these and other embodiments, the translation system interface 1814 may transmit credentials to the API. The credentials may include one or more of: a phone number, a device identifier, a device serial number or other identification code, a username, an image of the user's face for use in faceprint identification, a password, a PIN, a certificate, an encryption key, payment information such as a credit or debit card number, a payment authorization from the user 1804, and an account number. The API 1832 may use the credentials in making decisions as to whether to accept the communication session request and which services to provide. The API 1832 may obtain an identifier from the user 1804 or the device 1810 and confirm that the user 1804 or the device 1810 has an account, that the account is current, and that the user 1804 or the device 1810 is authorized to receive interpreting service. The API 1832 may further determine the preferred language of the user 1804, the home geographical region of the user 1804, the signing style of the user 1804, current geolocation, names from the contact list (e.g., the contact list on a phone) of the user 1804, types of service the user 1804 is eligible to receive, and information from a profile associated with the user 1804. The profile may include a list of terms frequently used by the user 1804, spelling of a name of the user 1804, spelling of names of associates of the user 1804, and preferences such as whether the user 1804 prefers using a sign language generation system 1842, the sign language recognition system 1844, or translation provided by a human. The API 1832 may use information received from the device 1810 in providing an interpreting service that is matched to the preferences, authorizations, language, accent, vocabulary, spelling options, and other characteristics of the user 1804.

In some embodiments, the vocabulary manager system 1816 may provide hints (information) to aid the translator system 1830 in interpreting for the user 1804. In some embodiments, the application 1812 may provide hints useful in interpreting to the vocabulary manager system 1816. The translation system interface 1814 may send hints from the vocabulary manager system 1816 to the translator system 1830. The translator system 1830 may use the hints in interpreting sign language. Hints may include videos of signs for new, domain-specific, or unusual terms, lists of vocabulary terms, language models from the language model data storage 1846 trained for a specific domain, indications of the probability specified terms will be used, and spelling for names and other terms. A domain may be an environment, company, industry, topic, task, or set of words, signs, or phrases relevant to a communication session or to the user 1804. The domain may determine the range of likely terminology in a session.

In some embodiments, hints may be used by the translation system 1830 to improve translating quality. For example, in some embodiments, a hint may include selecting a language model from the language models data storage 1846 for a specific domain or user (e.g., the user 1804). For example, if the application 1812 supports a food ordering service (e.g., online ordering, ordering at a counter, or driver-through ordering), the language model selected to be used by the translation system 1830 may be trained to match typical food ordering terms and phrases. For example, the selected language model may be trained on examples of people communicating in the domain of interest (e.g., ordering food or taking orders at a drive-through). In these and other embodiments, the translation system 1830 may be trained on data from the domain of interest.

In some embodiments, the translation system 1830 may use the selected language model in multiple manners. For example, the translation system 1830 may use the selected language model to filter output from the sign language recognition system 1844 and rule out unlikely words and phrases. Additionally or alternatively, the sign language recognition system 1844 may interpolate its own language model with the selected language model to modify words and word combinations the sign language recognition system 1844 tends to favor. Additionally or alternatively, the sign language recognition system 1844 may use the selected language model for sign language recognition by incorporating the selected language model into the sign language recognition system 1844.

In some embodiments, the translation system 1830 may adapt to content generated as the translation system 1830 is used. For example, models, parameters, and other variables of the translation system 1830 may be adjusted in response to audio, video, text, or a combination thereof. The adaptation may help to increase accuracy for the types of content, vocabulary, and other features of the content.

In some embodiments, each of the sign language generation system 1842 and the sign language recognition system 1844 may include multiple models. Each model may represent one or more domains, accents, or applications. In these and other embodiments, the translation system interface 1814 may send a message to the translation system 1830 related to the current session between the device 1810 and the translation system 1830. In these and other embodiments, the translation system 1830 may use the message to select a model for the current session.

In some embodiments, the device 1810 may be configured to assist in training or improving the translation system 1830. The device 1810 may assist in training or improving the translation system 1830 by providing additional information to the translation system 1830 for training or improvement.

For example, in some embodiments, the translation system interface 1814 may upload a set of vocabulary videos to the translation system 1830. The vocabulary videos may include examples of signs (such as a video of a person performing a sign). Each video may be labeled with the identity of the sign or signs appearing in the video. The label may include additional information such as the part of speech (e.g., noun, pronoun), entity type (e.g., person's name, product name, restaurant name, city name, name of a drug), or embeddings or synonyms (so that the VSL may know in what context to use the sign and how it fits into the grammar). The signs may be signs that are unknown to the sign language recognition system 1844, that are in a different language, that the user 1804 tends to sign differently from what the sign language recognition system 1844 expects, or other signs that the user 1804 desires to reinforce or add to the vocabulary of the sign language recognition system 1844. The sign language recognition system 1844 may use the sign videos to train and thereby expand its vocabulary or modify the way it recognizes signs. In some embodiments, the sign language generation system 1842 may use the sign videos to alter how signs are generated. Additionally or alternatively, the sign videos may be used to create one or more new or updated sign models. The new sign models may be sent to the translation system 1830. The translation system 1830 may use the new sign models in interpreting sign language.

As another example, the translation system interface 1814 may upload a spelling list to the translation system 1830. The translation system 1830 may use the spelling list to improve accuracy when spelling words. For example, if a meeting is to include a participant named “Kathi” (an unusual spelling), the spelling list may include Kathi's name and spelling so that the translation system 1830 can use the correct spelling when Kathi's name is mentioned.

As another example, the translation system interface 1814 may upload a set of vocabulary terms to the translation system 1830. The translation system 1830 may add the terms to a list of terms to be added to the vocabulary of the translation system 1830.

As another example, the translation system interface 1814 may upload a set of weight requests to the translation system 1830. In these and other embodiments, weight requests may include a list of terms that are to be emphasized or deemphasized, making them more or less likely, respectively, to be recognized. The weight request may specify a weight for each term in the list. In these and other embodiments, the sign language recognition system 1844 may use the weights to adjust probabilities associated with the listed words within the sign language recognition system 1844. Additionally or alternatively, the translation system interface 1814 may upload a “blacklist” of words to be removed and not generated or recognized or deemphasized so that they are less likely to be used by the sign language recognition system 1844. The blacklist may, for example, include profanity or other offensive terms. Additionally or alternatively, the translation system interface 1814 may upload a “whitelist” of words to be emphasized so that they are more likely to be used by a sign language generation system 1842 or recognized by a sign language recognition system 1844.

In these and other embodiments, an ASR may be used by the translation system 1830. In these and other embodiments, the information provided by the device 1810 may be used to improve the ASR as well.

In some embodiments, the user 1804 may be interacting with the application 1812. In these and other embodiments, the application may request for input from the user 1804. In these and other embodiments, the device 1810 may obtain video from the user 1804. The translation system interface 1814 may transmit the video to the API 1832. The API 1832 may pass the video to the translation system 1830. The translation system 1830 may interpret the video into text. In some embodiments, the translator may send the text via the API 1832 to the application 1812. The application 1812 may use the text in delivering service for the user 1804. The service may include connecting the device 1810 via a communication session to another person or to a machine such as an IVR system, joining a conference bridge, opening a communication session with another interpreter, playing a movie or other entertainment media, browsing a web site, interacting with a computer software application, playing a game, or enabling or launching an interpreter application. In response to launching an interpreter application, the interpreter application may generate video of the user 1804 performing sign language. In these and other embodiments, the device 1810 may send the video to the translation system 1830 to translate the sign language to text, audio, or both, present the text and/or audio to another person, such as a remote person via a communication session over a network connection or a person local to the user 1804 that is able to interact with the device 1810. In these and other embodiments, the device 1810 may collect audio that includes speech from the person, direct the speech to the translation system 1830 for generation of a video that includes sign language content based on the speech. The device 1810 may obtain the video from the translation system 1830 and present the sign language video on the device 1810.

As another example of the user 1804 interacting with the application 1812, the application 1812 may present information such as a menu or a request for information from the user 1804. The application 1812 may present the information as text, images, or video via the device 1810. Additionally or alternatively, the application 1812 may send a text string to the translation system 1830. The translation system 1830 may use the text string to generate a sign language video. The translation system 1830 may send the video to the device 1810. The device 1810 may present the video.

Additionally or alternatively, the device 1810 may request a response from the user 1804. The request may appear as text or as sign language (for example, in a video recording or performed by an avatar). The user 1804 may respond to the request by signing. In these and other embodiments, the device 1810 may generate a video with sign language from the user 1804 regarding the response of the user 1804. In these and other embodiments, the translation system 1830 may translate the sign language to other language data and provide the language data to the device 1810. The device 1810 may use the other language data as input from the user 1804. In these and other embodiments, the device 1810 may perform an action in response to obtaining the language data from the translation system 1830 that represents the input from the user 1804 in response to the request from the device 1810.

In some embodiments, when a video is sent to the translation system 1830 for translation by the device 1810, the vocabulary manager system 1816 may determine one or more hints for the translation based on a request that resulted in the generation of the video by the device 1810. For example, the device 1810 may request selection from a list of items and the user 1804 may respond by signing. In these and other embodiments, the hints may include one or more of the words (e.g., a menu or list of options) presented to the user 1804. As another example, the application 1812 may request that the user 1804 sign a command or the name of a service desired. In these and other embodiments, the hints may include a list of commands or service names from which the user 1804 may select and for which the sign language in the video is included. As another example, the application 1812 may invite the user 1804 to sign a song title, movie title, TV channel name, name of a video, software title, product order request, or grocery order. In response to the invitation, the vocabulary manager system 1816 may generate hints that may include a list of song titles, a list of movie titles, a list of TV channels, a list of video names, a list of software titles, a product list, or a grammar that includes grocery items, respectively. The vocabulary manager system 1816 may send the hints to the translation system 1830. The translation system 1830 may use the hints to translate the video to other language data. The translation system 1830 may send the language data to the application 1812. The language data may include text. The application 1812 may perform operations in response to the language data from the translation system 1830.

In another example, the application 1812 may be presenting media that includes an audio track. In these and other embodiments, the application 1812 may stream an audio signal to the translation system 1830. The audio signal may include an audio track to a video (e.g., movie, TV show, news broadcast, etc.), radio program, podcast, audio from a communication session such as a video conference call, or audio extracted from other media. The translation system 1830 may generate video based on the audio and send the video to the device 1810. The device 1810 may present the video.

In another example, the application 1812 may send text to the translation system 1830. The translation system 1830 may generate video based on the text and send the video to the device 1810. The device 1810 may present the video.

In some embodiments, the device 1810 may send requests that are repetitive. For example, the user 1804 may interact with the application 1812 in a similar manner resulting in similar requests being provided to the translation system 1830. In some embodiments, the translation system 1830 may regenerate the interpretation. Additionally or alternatively, the translation system 1830 may save requests and the resulting responses generated by the translation system 1830. In these and other embodiments, when the translation system 1830 receives a request, the translation system 1830 may compare the request to previous stored request. In response to the request matching one of the stored requests, the translation system 1830 may retrieve the previous response for the request and send the previous response to the device 1810.

Modifications, additions, or omissions may be made to the environment 1800 without departing from the scope of the present disclosure. For example, the functions described with respect to the environment 1800 for one or more of: the controller 1820, the device 1810, and the external device 1822 may be combined into fewer devices or distributed across multiple devices. For example, the process for recognizing or generating sign language may occur partly on the device 1810 and partly on the translation system 1830. For example, the device 1810 may transform the video by compressing the video or transforming the video into a format such as poses, glosses, or features. The device 1810 may send the transformed video to the translation system 1830. The translation system 1830 may translate the transformed video to other language data. Additionally or alternatively, substantially all the process for recognizing or generating sign language may occur on the device 1810. The translation system 1830 may send the language data to the device 1810 via the API 1832. As another example, the translation system 1830 may generate a set of parameters that specify the actions of a text-to-sign language avatar and send the parameters to the device 1810. The device 1810 may use the parameters to generate an avatar that performs sign language.

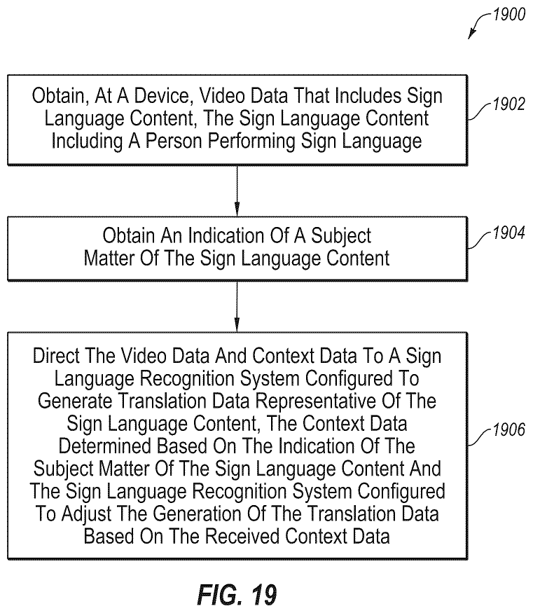

FIG. 19 illustrates a flowchart of an example method 1900 to use a sign language recognition system. The method 1900 may be arranged in accordance with at least one embodiment described in the present disclosure. One or more operations of the method 1900 may be performed, in some embodiments, by a device or system, such as translation system 1830 described in FIG. 18, another system described in this disclosure or another device or combination of devices. In these and other embodiments, the method 1900 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 1900 may begin at block 1902, where video data may be obtained at a device that includes sign language content, the sign language content including a person performing sign language. At block 1904, an indication of a subject matter of the sign language content may be obtained.

At block 1906, the video data and context data may be directed to a sign language recognition system configured to generate translation data representative of the sign language content. In these and other embodiments, the context data may be determined based on the indication of the subject matter of the sign language content. The sign language recognition system may be configured to adjust the generation of the translation data based on the received context data. In some embodiments, the context data may include a summary of the sign language content, spelling for words such as names, lists of words found in the sign language content, a title representing the conversation topic, and unusual or unfamiliar terms, among other data. For example, if the subject matter is determined to be recent stock market activity, the context data may include terms such as “S&P 500” and the name of a public company in the news. The sign language recognition system may add these new terms to its vocabulary so that the new terms may be recognized.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

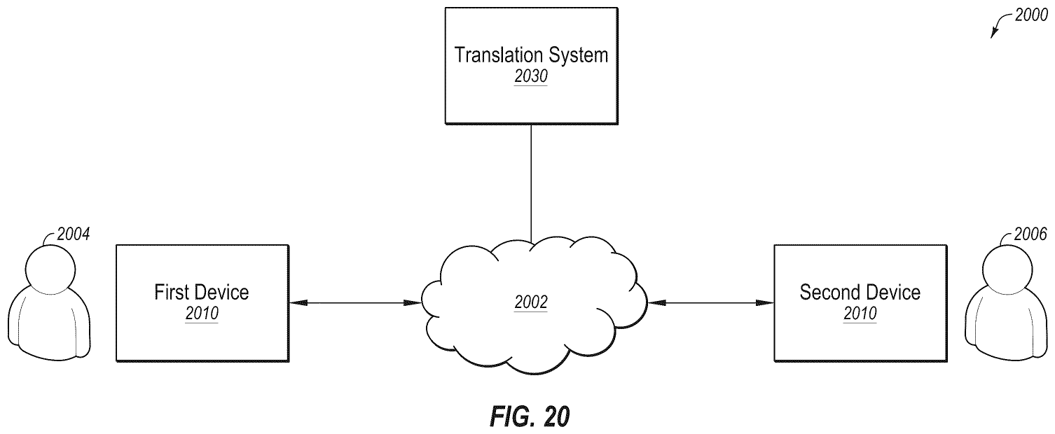

FIG. 20 illustrates an example environment 2000 for sign language processing between parties. The environment 2000 may be arranged in accordance with at least one embodiment described in the present disclosure. The environment 2000 may include a network 2002, a first device 2010, a second device 2012, and a translation system 2030.

The network 2002, the first device 2010, and the second device 2012, may be analogous to the networks 102, the first device 110, and the second device 112 of FIG. 1. In these and other embodiments, the description of FIG. 1 of these elements may be applicable in the environment 2000. The translation system 2030 may be analogous to the translation system 212, the translation system 220, the translation system 240, and the translation system 1210 of FIGS. 2A, 2B, 2C, and 12. In these and other embodiments, the description of these elements may be applicable in the environment 2000. Further, the environment 2000 may include a first user 2004 that may be associated with the first device 2010 and may be a sign language capable person. Further, the environment 2000 may include a second user 2006 that may be associated with the second device 2012 and may be a sign language incapable person.

The environment 2000 may be used for translation between the first user 2004 and the second user 2006. The environment 2000 may be useful when the first user 2004 and the second user 2006 meet for a spontaneous discussion. In these and other embodiments, the first user 2004 and second user 2006 may be in proximity such that they may see each other and speak to each other without communication devices. In these and other embodiments, the first device 2010 may include a software application configured to provide sign language interpretation, referred to with respect to FIG. 20 as interpretation software. In these and other embodiments, the second device 2012 may or may not include interpretation software. Interpretation software may be configured to obtain translations between sign language and other language data. For example, the interpretation software may communicate with the translation system 2030 to obtain translations between sign language and other language data. In these and other embodiments, the translation system 2030 may include a sign language generation system and/or a sign language recognition system as discussed in this disclosure.

The network 2002 may communicatively couple the first device 2010, the second device 2012, and the translation system 2030 such that language data may be sent between the first device 2010, the second device 2012, and the translation system 2030.

In some embodiments, the first device 2010 and/or the second device 2012 may be used to provide translation between sign language and other language data. For example, the first device 2010 may send the second device 2012 a link, text, or by some other manner connect the interpretation application of the first device 2010 to the second device 2012. In these and other embodiments, the interpretation application may set up a communication session between the first device 2010 and the second device 2012. In these and other embodiments, the second device 2012 may join the communication session using session information received from the first device 2010. For example, the second device 2012 may join the communication session using a URL, URI, bridge number, phone number, IP address, link, username, social media handle, or device address. In these and other embodiments, the first device 2010 may use one or more of several options for giving the second device 2012 session information. For example, the first device 2010 may pass the second device 2012 a link to an application to install, a call identifier, a session identifier, or a URL associated with a new call. In these and other embodiments, the communication session information may be sent via a message in one of a variety of forms including SMS, email, Teams message, social media (e.g., Facebook, WhatsApp) message, etc. In some embodiments, the communication session information may be carried via a short-range signal sent from the first device 2010 to the second device 2012. In these and other embodiments, the short-range signal may be electromagnetic, acoustic, optical (e.g., infrared), or visual (e.g., information appearing on the first device 2010 that the second device 2012 may read with a camera such as a QR code, bar code, text, or other information).

In some embodiments, the first device 2010 and the second device 2012 may connect to the translation system 2030 directly or through the other of the first device 2010 and the second device 2012. For example, the first device 2010 may connect to the translation system 2030 through the second device 2012. In these and other embodiments, the signals between the first device 2010 and the second device 2012 and the training data 230 may be passed to the translation system 2030 via the connection path. In these and other embodiments, the first device 2010 and the second device 2012 may exchange data directly therebetween over the network 2002.

An example of operation of the environment 2000 is now provided. The first user 2004 may sign and the first device 2010 and/or the second device 2012 may generate video that includes the sign of the first user 2004. The first device 2010 and/or the second device 2012 may send the video to the translation system 2030. The translation system 2030 may convert the sign language in the video to text and/or audio and provide the text and/or audio to the first device 2010 and/or second device 2012. The first device 2010 and/or second device 2012 may present the text and/or audio to the second user 2006. The first device 2010 and/or second device 2012 may capture audio and/or text from the signal representing the second user 2006. The first device 2010 and/or second device 2012 may send the audio and/or text to the translation system 2030. The translation system 2030 may translate the audio and/or text to sign language and generate a video with the sign language and provide the video to the first device 2010 and/or second device 2012. The first device 2010 and/or second device 2012 may present the video to the first user 2004. Thus, in this example, either the first device 2010 or second device 2012 may be used alone. Alternately or additionally, either of the first device 2010 and/or second device 2012 may be used for any of the actions taken, such as capturing video and audio and displaying video and audio. The data may be communicated along any path as discussed with respect to FIG. 20. In these and other embodiments, which of the first device 2010 and/or second device 2012 may perform an action and communication paths selected may depend on one or more of which connections are available, whether the second user 2006 has a device and what type, whether interpretation software is installed on the second device 2012, and whether and what type of interpretation software is installed on the first device 2010.

In some embodiments, both the first device 2010 and second device 2012 may obtain and display text corresponding to the video. Alternately or additionally, both the first device 2010 and the second device 2012 may collect audio from the second user 2006 and provide the audio to the translation system 2030. The translation system 2030 may combine the audio from both the first device 2010 and the second device 2012 into a signal representing speech of the second user 2006. For example, the translation system 2030 may use the audio from the second device 2012 as a primary input and audio from the first device 2010 as a reference for use in speech enhancement (e.g., noise cancelling, beamforming, blind source separation). As another example, the translation system 2030 may use multiple audios from the first device 2010 (such as one audio per microphone on the first device 2010) and second device 2012 and use them to improve the audio (e.g., reduce noise, eliminate background speakers).

In an example, a sign language capable person, such as a deaf person, may meet a sign language incapable person on the street. The sign language capable person may have a sign language communication application on their smartphone, e.g., the first device 2010. The sign language capable person may use the application to send a message (e.g., text, email, IM, . . . ) to the hearing friend's second device 2012. The sign language incapable person may click the link which may open a browser to a site associated with the translation system 2030. The sign language incapable person may hold up their smartphone (the second device 2012) so that the camera may capture the signs created by the sign language capable person. By using the camera on the second device 2012, the sign language capable person may sign with both hands. The microphone of the second device 2012 may also collect audio generated by the sign language incapable person. The second device 2012 may forward the audio to the translation system 2030. Alternatively or additionally, the link may allow the sign language incapable person to install a sign language communication application on the second device 2012. The application may perform functions comparable to those described for the second device 2012.

Another use case follows, the first user 2004 enters an establishment, (e.g., a place of business or other location such as a retail store or warehouse). A QR code (or bar code or another graphic identifying an interpreting service) is visible at the establishment. The establishment may have subscribed to an interpreting service and may be billed for the service. The bill may be flat rate or based on usage. The first device 2010 scans the QR code, activating the interpreting service. The service may be provided via a browser on the first device 2010. The interpreting service may be sensitive to location and may only provide service in response to the first device 2010 location being within a specified region, such as within a specified radius of the establishment or at a point on the establishment's premises. The location of the first device 2010 may be determined by GPS capability on the first device 2010 or may use other ways to determine the location of the first device 2010.

In these and other embodiments, the service may check the establishment's payment or subscription status to determine whether the account is in good standing. In response to the account being in good standing, service may be provided to the first device 2010. Otherwise, the service may not be provided.

In these and other embodiments, the service may include an automated translation system or a translation system that includes a human interpreter as described with respect to FIG. 1. The translation system may interpret for a conversation between the first user 2004 and a person at the establishment, e.g., the second user 2006. The service may use the first device 2010 to display the sign language generated by the translation system. The first device 2010 microphone may be used to obtain audio from the second user 2006. The first device 2010 speaker may be used to send the audio to the second user 2006. A camera of the first device 2010 may capture video (which may include sign language) from the first user 2004 and send the video to the translation system 2030. A speaker of the first device 2010 may play audio from the translation system 2030 to the second user 2006.

Alternately or additionally, the establishment may have a device available for use with a translation system 2030. In these and other embodiments, interpretation made using the second device may be billed to the establishment. In these and other embodiments, during or after the translation, the service may present an advertisement to the first user 2004.

In some embodiments, after a translation session is terminated, the first device 2010 or second device 2012 or both may invite their respective user(s) to perform one or more further actions. The invitation may be in response to a message from the translation system 2030. The further actions may include filling out a survey. Alternately or additionally, the first device 2010 or the second device 2012 or both may invite the user to upsell the first user 2004 or the second user 2006 an upgraded service such as an interpreting service.

In some embodiments, the first device 2010 may display one or more ads for products or services. The ads may be presented in text, sign language, audio, or a combination thereof. The services may include hearing aids, cochlear implants, translation services, upgraded versions of the service the first user 2004 experienced, tutoring (subjects may include sign language, academic subjects such as math and reading, foreign languages, etc.), Medicare/Medicaid related services, video remote interpreting (VRI) services using human interpreters, VRI services using automated interpreters, food, clothing, travel, digital services such as social media, etc. For example, after the first user 2004 has used an interpreting session, the first user 2004 may receive an advertisement. For example, if the first device 2010 browsed to a URL in response to scanning a QR code, the interpreting session may run on the browser. The browser may present the advertisement. The advertisement may be for an interpreting service. The interpreting service may be free if the first user 2004 uses automated interpreting and paid if the first user 2004 uses a human interpreter. In some embodiments, the service enables the first user 2004 to select automated interpreting or a human interpreter for individual interpreting sessions. Alternately or additionally, if the first user 2004 meets selected criteria, the interpreting service may be billed to a business or government agency and the first user 2004 and second user 2006 may not be billed.

In some embodiments, the second device 2012 may display an ad for further services such as those listed above for the first device 2010. The second device 2012 may invite the second user 2006 to install software (e.g., a smartphone app) on the second device 2012. The software may make connecting and conducting future communication sessions with a first user 2004 easier because fewer steps may be required (e.g., the second user 2006 may not need to browse to the URL of the interpreting service). For example, the second device 2012 may invite the second user 2006 to install an application similar or substantially identical to that used by the first user 2004.

In some embodiments, the interpretation service may invite the first user 2004 and/or the signal representing the second user 2006 user to install software on the first device 2010 and/or the second device 2012. The software may be an interpretation application, a sign language dictionary, a sign language tutor, a game, or an interpreting service using human interpreters.

In some embodiments, the application running on the first device 2010 or the second device 2012 may include a sign language dictionary or an invitation to install and/or purchase a sign language dictionary smartphone app. The sign language dictionary may allow a user to speak or type a word or phrase and the dictionary may show a video of one or more images indicating one or more corresponding signs. Alternately or additionally, the user may sign a word or phrase, and the dictionary may display text corresponding to an interpretation of what the user signed. Alternately or additionally, the dictionary may render the interpretation as an audio signal, for example using text-to-speech. Alternately or additionally, the dictionary may present a video of the identified sign.

In some embodiments, the sign language tutor may present text on the second device 2012 or the first device 2010, speak over the speaker, or both and invite the user to perform one or more corresponding signs or phrases. The tutor may provide an evaluation of the user's performance. If the user signs incorrectly, the tutor may present a video showing how to correctly perform the signs or phrases. Under some circumstances, the tutor may show the user video of the user performing the sign or phrase. The tutor may offer language training in exchange for the user providing consent for the tutor to record the user's sign language data.

In some embodiments, the tutor may be responsive to the user's skill level and performance on a first task in designing a second task. For example, if the user correctly executes a first task such as signing a given word, the tutor may invite the user to perform a second sign. If the user incorrectly executes the first task, the tutor may provide further instruction regarding the first task.

In some embodiments, a game may allow the user to win points by playing the game. Points may be used to obtain something of value such as free or discounted interpreting service, money, game points, merchandise, or recognition such as placing the user's name on a leaderboard.

In some embodiments, tutoring and other software (e.g., smartphone apps) may include data collection. The tutor or other software and services described herein may collect consent from the user. The consent may authorize the tutoring and other software to record specified content from one or more communication sessions with the user. The consent collection may advise the user how the data will be used, how to opt out of collection, and how to request content deletion. In these and other embodiments, the tutor or other software and services may capture one or more of: video, audio, and text from the user. The data may be uploaded to a network-based data server. The data may be used to train models for sign language recognition and generation systems, such as those described in this disclosure.

In some embodiments, the service provided by the translation system 2030 may be free. Alternately or additionally, the first user 2004, the second user 2006, or a third party, such as a government, employer of the first user 2004 or the second user 2006, or some entity associated with one of the first user 2004, the second user 2006, or some entity associated with a location of the first user 2004 and the second user 2006. In some embodiments, the communication session may generate a billing record so that the responsible party is advised of the cost and can pay.

In these and other embodiments, determining the cost and/or payer may be based on the following: the cost may be billed at multiple rates and charged to one or more parties, depending on the situation. For example, the translation system 2030 may be free or less expensive than a human interpreter. The service may be billed at a flat rate for unrestricted (within generous limits) minutes. The service may be supported by ads. The service may be billed at a first rate when the first user 2004 pays, a second rate when an employer pays, a third rate when a business owner pays, and a fourth rate when the government pays. One or more of these rates may be free to selected responsible parties up to a specified number of minutes. In some embodiments, the service may be at one rate (e.g., free) if a user, such as the first user 2004 meets specified criteria (such as being registered in a government fund or being eligible to receive the service free based on the user's disabilities) and at one or more other rates otherwise.

In some embodiments, the translation system 2030 may include a billing rules engine. The billing rules engine may generate a bill, or a billing record used in billing one or more responsible parties. The billing rules engine may send the billing record to the one or more responsible parties. The billing rules engine may charge multiple responsible parties, attributing a portion of the cost to each responsible party. The billing rules engine may determine the cost of the communication session. Additionally or alternatively, the billing rules engine may forward communication session information to a system that determines the cost of the communication session.

In some embodiments, the billing rules engine may be responsive to one or more of the following factors: the status of one or more of the first user 2004, the second user 2006, and the responsible party. For example, a status of the first user 2004 may be as an individual on a qualified communication session (on a video call, for example, where the billing rules engine may bill the government), as an individual on a non-qualified call (an in-person conversation, for example, where the billing rules engine may bill the first user 2004), as a customer (based, for example, on the presence of the first user 2004 on a vendor's property), or as an employee (where the billing rules engine may bill the employer).

In some embodiments, an indication of status of the first user 2004 may be stored in a telecommunications relay service user registration database. In some embodiments, the indication may include whether the first user 2004 is registered, whether the registration is correct and complete, and whether the registration is current. For example, the billing rules engine may query the database, determine that the first user 2004 is certified to receive interpreting services, instruct the translation system 2030 to provide interpreting services to the first user 2004, generate a communication session detail record, and forward the record to a billing organization tasked with reporting billing information to the payer.

In some embodiments, an indication of one or more services that one or more calling parties (e.g., the first user 2004, the second user 2006) may be subscribed to may be obtained by the billing rules engine. The indication may include the status (e.g., free subscriber, basic subscriber, premier subscriber) of the subscription.

In some embodiments, the billing rules engine may be responsive to one or more of the following factors regarding billing a communication session (e.g. call): the type of call, such as a 911 call, an emergency call, a personal call, a business call, a test call, a free call, a toll-free call, a long-distance call, an international call, an IVR call, a voice call, a video call, and a paid call. For example, the billing rules engine may charge a government entity for personal calls and the relevant associated business for business calls.

In some embodiments, the billing rules engine may be responsive to one or more of the following factors regarding billing a communication session: the type of user, which may include one or more of: a second user 2006, a first user 2004, a skilled signer, an unskilled signer, a non-signer, a business representative, a government representative, a product developer, an interpreter, and an IVR. For example, service for a first user 2004 may be billed to a third party. As another example, service for a second user 2006 may be billed to the second user 2006. Other factors related to the user that may affect billing may include language, current geographical region, place of residence, disabilities (including, but not limited to hearing or speaking ability), whether the user tends to sign one-handed or two-handed, and whether the user signs left-handed. In these and other embodiments, whether the user signs one- or two-handed and whether the user signs left-handed or right-handed may be determined by analyzing the video that includes sign language content from the user.

In some embodiments, the billing rules engine may be responsive to one or more of the following factors regarding billing a communication session: the type of interpreter, which may include the interpreter including a human or being completely automated.

Modifications, additions, or omissions may be made to the environment 2000 without departing from the scope of the present disclosure. For example, in some embodiments, the translation system 2030 may incorporate a human interpreter such as the third user 108 of FIG. 1.

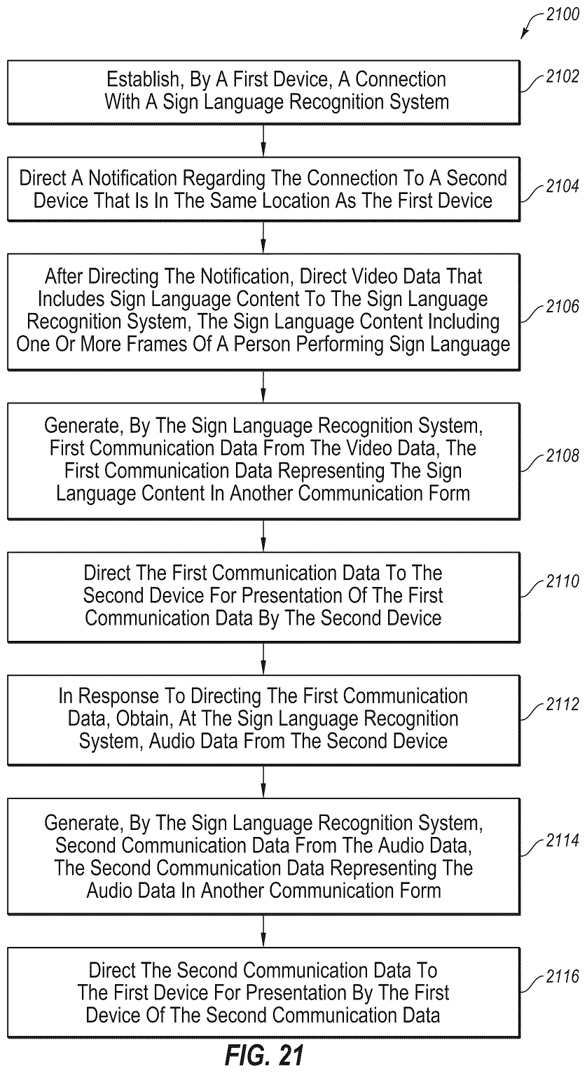

FIG. 21 illustrates a flowchart of an example method 2100 for sign language processing between parties. The method 2100 may be arranged in accordance with at least one embodiment described in the present disclosure. One or more operations of the method 2100 may be performed, in some embodiments, by a device or system, such as system or device in environment 200 described in FIG. 20, another system described in this disclosure or another device or combination of devices. In these and other embodiments, the method 2100 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 2100 may begin at block 2102, where a connection with a sign language recognition system may be established by a first device.

At block 2104, a notification regarding the connection may be directed to a second device. The second device may be in proximity to the first device. The notification may be a URL to access a webpage for a connection session between the sign language recognition system and the first device. The second device may connect to the sign language recognition system via the URL. The notification may be directed to the second device via any communication method.

At block 2106, after directing the notification, video data that includes sign language content may be directed to the sign language recognition system. In some embodiments, the sign language content may include one or more frames of a person performing sign language.

At block 2108, first communication data from the video data may be generated by the sign language recognition system. The first communication data may represent the sign language content in another communication form. The first communication data may be audio data or text data that represents the sign language content.

At block 2110, the first communication data may be directed to the second device for presentation of the first communication data by the second device.

At block 2112, in response to directing the first communication data, audio data from the second device may be obtained at the sign language recognition system.

At block 2114, second communication data from the audio data may be generated by the sign language recognition system. In these and other embodiments, the second communication data may represent the audio data in another communication form. The second communication data may be video data with sign language content that represents the audio data or text data. At block 2116, the second communication data may be directed to the first device for presentation by the first device of the second communication data.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

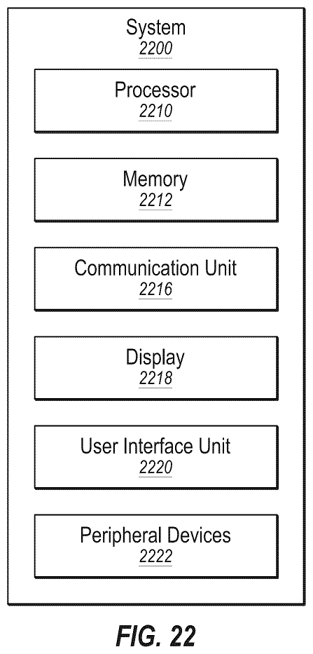

Multiple other embodiments regarding sign language recognition and interpretation are also described in U.S. patent application Ser. No. 18/459,415, filed on Aug. 31, 2023, entitled “Automatic Sign Language Interpreting.” and U.S. Provisional Patent Application No. 63/374,241, filed on Sep. 1, 2022, both of which are incorporated herein by reference in their entireties. The embodiments described in this disclosure may be combined with the ideas, concepts, and embodiments described in U.S. patent application Ser. No. 18/459,415 and U.S. Provisional Patent Application No. 63/374,241. For example, the inventor of this application, U.S. patent application Ser. No. 18/459,415, and U.S. Provisional Patent Application No. 63/374,241 are the same or is a co-inventor. Thus, the inventor contemplates that concepts described in U.S. patent application Ser. No. 18/459,415 and U.S. Provisional Patent Application No. 63/374,241 may be combined with concepts described in this disclosure to accomplish ideas with respect to sign language interpretation, recognition, and all other aspects with respect to the current disclosure. FIG. 22 illustrates an example system 2200 that may be used during transcription presentation. The system 2200 may be arranged in accordance with at least one embodiment described in the present disclosure. The system 2200 may include a processor 2210, memory 2212, a communication unit 2216, a display 2218, a user interface unit 2220, and a peripheral device 2222, which all may be communicatively coupled. In some embodiments, the system 2200 may be part of any of the systems or devices described in this disclosure.

For example, the system 2200 may be configured to perform the functions and/or task of the systems and/or devices described in the environments disclosed in this disclosure. For example, each of the systems and/or devices described in the environments disclosed in this disclosure may include one or more of the elements of the system 2200.

Generally, the processor 2210 may include any suitable special-purpose or general-purpose computer, computing entity, or processing device including various computer hardware or software modules and may be configured to execute instructions stored on any applicable computer-readable storage media. For example, the processor 2210 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 22, it is understood that the processor 2210 may include any number of processors distributed across any number of networks or physical locations that are configured to perform individually or collectively any number of operations described herein. In some embodiments, the processor 2210 may interpret and/or execute program instructions and/or process data stored in the memory 2212. In some embodiments, the processor 2210 may execute the program instructions stored in the memory 2212.

For example, in some embodiments, the processor 2210 may execute program instructions stored in the memory 2212 that are related to transcription presentation such that the system 2200 may perform or direct the performance of the operations associated therewith as directed by the instructions. In these and other embodiments, the instructions may be used to perform one or more operations of the method described in this disclosure.

The memory 2212 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 2210.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store particular program code in the form of computer-executable instructions or data structures and which may be accessed by a general-purpose or special-purpose computer. Combinations of the above may also be included within the scope of computer-readable storage media.

Computer-executable instructions may include, for example, instructions and data configured to cause the processor 2210 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 700 F.3d 1346 (Fed. Cir. 2007). Combinations of the above may also be included within the scope of computer-readable media.

The communication unit 2216 may include any component, device, system, or combination thereof that is configured to transmit or receive information over a network. In some embodiments, the communication unit 2216 may communicate with other devices at other locations, the same location, or even other components within the same system. For example, the communication unit 2216 may include a modem, a network card (wireless or wired), an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, etc.), and/or the like. The communication unit 2216 may permit data to be exchanged with a network and/or any other devices or systems described in the present disclosure.

The display 2218 may be configured as one or more displays, like an LCD, LED, Braille terminal, or other type of display. The display 2218 may be configured to present video, text captions, user interfaces, and other data as directed by the processor 2210.

The user interface unit 2220 may include any device to allow a user to interface with the system 2200. For example, the user interface unit 2220 may include a mouse, a track pad, a keyboard, buttons, camera, and/or a touchscreen, among other devices. The user interface unit 2220 may receive input from a user and provide the input to the processor 2210. In some embodiments, the user interface unit 2220 and the display 2218 may be combined.

The peripheral devices 2222 may include one or more devices. For example, the peripheral devices may include a microphone, an imager, and/or a speaker, among other peripheral devices. In these and other embodiments, the microphone may be configured to capture audio. The imager may be configured to capture images. The images may be captured in a manner to produce video or image data. In some embodiments, the speaker may broadcast audio received by the system 2200 or otherwise generated by the system 2200.

Modifications, additions, or omissions may be made to the system 2200 without departing from the scope of the present disclosure. For example, in some embodiments, the system 2200 may include any number of other components that may not be explicitly illustrated or described. Further, depending on certain implementations, the system 2200 may not include one or more of the components illustrated and described.

An example of how the embodiments described in this disclosure may be combined is now provided. In some embodiments, the communication system 130 may include the environment 200a, 200b, or 200c of FIGS. 2A-2C. The communication system 130 may perform any one of methods illustrated in FIGS. 3-9. Alternately or additionally, the communication system 130 may include the environment 900 of FIG. 9, the environment 1100 of FIG. 11, or the environment 1200 of FIG. 12. In these and other embodiments, the communication system 130 may perform the methods illustrated in FIGS. 10 and 13. In some embodiments, the communication system 1430 or 1630 may perform one or more of the operations of the communication system 130. In some embodiments, the concepts from the translation system 1830 and/or 2030 may be implemented in the environment 100 or the communication system 130.

In some embodiments, the communication system 1430 may include the environment 200a, 200b, or 200c of FIGS. 2A-2C. The communication system 1430 may perform any one of methods illustrated in FIGS. 3-9. Alternately or additionally, the communication system 1430 may include the environment 900 of FIG. 9, the environment 1100 of FIG. 11, or the environment 1200 of FIG. 12. In these and other embodiments, the communication system 1430 may perform the method illustrated in FIG. 10. In some embodiments, the communication system 1430 may perform one or more of the operations of the communication system 130. In some embodiments, the concepts from the translation system 1830 and/or 2030 may be implemented in the environment 1400 or the communication system 1430.

In some embodiments, the communication system 1630 may include the environment 200a, 200b, or 200c of FIGS. 2A-2C. The communication system 1630 may perform any one of methods illustrated in FIGS. 3-9. Alternately or additionally, the communication system 1630 may include the environment 900 of FIG. 9, the environment 1100 of FIG. 11, or the environment 1200 of FIG. 12. In these and other embodiments, the communication system 1630 may perform the method illustrated in FIG. 10. In some embodiments, the communication system 1630 may perform one or more of the operations of the communication system 130. In some embodiments, the concepts from the translation system 1830 and/or 2030 may be implemented in the environment 1800 or the communication system 1830.

In some embodiments, the translation system 1830 may be generated using ideas from or implement any of the concepts discussed in FIGS. 1-17 or FIG. 20. In some embodiments, the translation system 2030 may be generated using ideas from or implement any of the concepts discussed in FIGS. 1-19. Thus, the concepts discussed with respect to FIGS. 1-20 illustrate concepts that may be implemented in a variety of ways, devices, and systems all with respect to translating between sign language and language data. Thus, concepts from any one of the figures may be implemented with respect to any of the figures.

The subject technology of the present disclosure is illustrated, for example, according to various aspects described below. Various examples of aspects of the subject technology are described as numbered examples (1, 2, 3, etc.) and sub examples (1.1, 1.2, 1.3, etc.) for convenience. These are provided as examples and do not limit the subject technology. The aspects of the various implementations described herein may be omitted, substituted for aspects of other implementations, or combined with aspects of other implementations unless context dictates otherwise. For example, one or more aspects of example 1 below may be omitted, substituted for one or more aspects of another example (e.g., example 2) or examples, or combined with aspects of another example. As another example, one or more aspects of sub example 1.1 below may be omitted, substituted for one or more aspects of another sub example (e.g., example 1.2) or examples, or combined with aspects of another example The following is a non-limiting summary of some example implementations presented herein.

Example 1.1 may include a method comprising:
obtaining, during a communication session between a first device and a second device, video data that includes sign language content, the sign language content including one or more video frames of a figure performing sign language;
obtaining audio data that represents the sign language content in the video data;
providing, during the communication session, the video data and the audio data to a sign language processing system that includes a machine learning model, the video data and the audio data being generated independent of the sign language processing system; and
training the machine learning model during the communication session using the video data and the audio data.

Example 1.2: The method of example 1.1, wherein the audio data and the video data are obtained from different devices.

Example 1.3: The method of example 1.1, wherein one of the first device and the second device provides one of the audio data and the video data and the other of the first device and the second device does not provide the video data and does not provide the audio data.

Example 1.4: The method of example 1.1, wherein the machine learning model is part of a sign language generation system or a sign language recognition system.

Example 1.5: The method of example 1.1, wherein the audio data is obtained before the video data.

Example 1.6: The method of example 1.1, wherein training the machine learning model during the communication session using the video data and the audio data includes directing the audio data to an automatic speech recognition system configured to generate the first text data that includes a transcription of the spoken words in the audio data, the first text data used in training the machine learning model.

Example 1.7: The method of example 1.6, wherein training the machine learning model during the communication session includes:
generating, by the sign language processing system, second text data by providing the video data to the machine learning model, the second text data representing the sign language content in the video data;
comparing the first text data and the second text data; and
adjusting the machine learning model based on the comparison.

Example 1.8: The method of example 1.7, wherein the steps of generating, comparing, and adjusting occur before the end of the communication session.

Example 1.9: The method of example 1.6, wherein training the machine learning model during the communication session includes:
generating, by the sign language processing system, second video data by providing the text data to the machine learning model, the second video data including sign language representing the text data;
comparing the video data and the second video data; and
adjusting the machine learning model based on the comparison.

Example 1.10: The method of example 1.1, wherein training the machine learning model during the communication session using the video data and the audio data includes training the machine learning model using data that is not obtained from the communication session in conjunction with the video data and the audio data from the communication session.

Example 1.11: The method of example 1.1, wherein the video data and the audio data are deleted at the end of the communication session.

Example 1.12: The method of example 1.1, wherein the video data and the audio data are deleted once they have been used to train the machine learning model.

Example 1.13: The method of example 1.1, wherein the video data and the audio data are deleted within a predetermined amount of time after the end of the communication session.

Example 2.1 includes A method comprising:
providing first training data to a translation system configured to translate between sign language and language data, the translation system includes a plurality of stages and each of the plurality of stages including one or more machine learning models;
obtaining a first hypothesis output from the translation system based on the first training data;
modifying one or more of the machine learning models based on the first hypothesis output;
providing second training data to a first set of the plurality of stages without providing the second training data to other of the plurality of stages not included in the first set of the plurality of stages;
obtaining a second hypothesis output from the first set of the plurality of stages based on the second training data; and
modifying one or more of the machine learning models of the first set of the plurality of stages based on the second hypothesis output.

Example 2.2: The method of example 2.1, wherein the translation system is configured for sign language recognition or sign language generation.

Example 2.3: The method of example 2.1, wherein the one or more of the machine learning models of the first set of the plurality of stages modified based on the second hypothesis output is the same one or more of the machine learning models modified based on the first hypothesis output.

Example 2.4: The method of example 2.1, wherein the modifying the one or more of the machine learning models based on the first hypothesis output includes modifying all the machine learning models in the translation system based on the first hypothesis output.

Example 2.5: The method of example 2.1, wherein the second training data is a subset of the first training data.

Example 2.6: The method of example 2.1, wherein the first training data is obtained from a communication session between devices and deleted before the communication session ends and the second training data is stored before, during, and after the communication session.

Example 2.7: The method of example 2.1, wherein the second training data is obtained from a communication session between devices and deleted substantially at the end of the communication session and the first training data is stored before, during, and after the communication session.

Example 2.8: The method of example 2.1, wherein the steps of providing first training data, obtaining the first hypothesis output, and modifying based on the first hypothesis output comprises end-to-end training and is iteratively repeated and the steps of providing second training data, obtaining the second hypothesis output, and modifying based on the second hypothesis output comprises sub-training and is iteratively repeated.

Example 2.9: The method of example 2.8, wherein a number of iterations for the sub-training are different than number of iterations for the end-to-end training.

Example 2.10: The method of example 2.8, wherein the iterations for the sub-training are intermixed between iterations for the end-to-end training.

Example 3.1 includes a method comprising:
obtaining a first video that includes sign language content, the sign language content including one or more video frames of a figure performing sign language;
obtaining language data that represents the sign language content in the first video;
extracting, from the first video, a spatial configuration for each of one or more body parts of the figure;
creating a second video including sign language content using the extracted spatial configurations; and
training a machine learning model of a translation system configured to translate between sign language and language data using the second video and the language data.

Example 3.2: The method of claim 1, wherein creating the second video includes:
removing the spatial configurations related to a non-dominant hand of the figure; and
creating the second video using the remaining spatial configurations to define signs for the sign language content.

Example 3.3: The method of claim 2, wherein the second video include one or more frames with a single hand performing sign language.

Example 3.4: The method of claim 1, wherein creating the second video includes generating a second figure performing sign language using the extracted spatial configurations where the second figure is visibly distinct from the figure.

Example 3.5: The method of claim 1, further comprising creating a plurality of second videos that include the second video, each of the plurality of second videos created to include sign language content using the extracted spatial configurations and each of the plurality of second videos including a figure that is visibly distinct from a figure in another of the second videos, wherein the machine learning model is trained using each of the plurality of second videos and the language data.

Example 3.6: The method of claim 1, wherein the translation system is configured for sign language recognition or sign language generation.

Example 3.7: The method of claim 1, further comprising distorting the second video before training the machine learning model using the second video.

Example 3.8: A method comprising:
obtaining a first video that includes sign language content, the sign language content including one or more video frames of a figure performing sign language;
obtaining language data that represents the sign language content in the first video;
creating a second video including sign language content by altering the first video; and
training a machine learning model of a translation system configured to translate between sign language and language data using the second video and the language data.

Example 3.9: The method of example 3.8, wherein creating the second video includes removing a non-dominant hand of the figure in the second video.

Example 3.10: The method of example 3.8, further comprising extracting, from the first video, a spatial configuration for each of one or more body parts of the figure, wherein creating the second video includes generating a second figure performing sign language using the extracted spatial configurations where the second figure is visibly distinct from the figure.

Example 3.11: The method of example 3.8, wherein the translation system is configured for sign language recognition or sign language generation.

Example 3.12: The method of example 3.8, further comprising distorting the second video before training the machine learning model using the second video.

Example 4.1 includes a method comprising:
obtaining a data stream with language data for translation by a translation system configured to translate between sign language and other language forms;
storing one or more portions of the data stream;
directing a current portion of the data stream to the translation system;
providing the stored one or more of the portions of the data stream to the translation system; and
translating, by the translation system, the current portion of the data stream using the current portion of the data stream and the stored one or more of the portions of the data stream provided to the translation system.

Example 4.2: The method of example 4.1, further comprising:
generating a summary of one or more of the stored one or more of the portions of the data stream; and
providing the summary to the translation system, wherein the current portion of the data stream is translated further based on the summary.

Example 4.3: The method of claim 1, further comprising:
determining a topic of the language data in the data stream;
obtaining contextual data regarding the topic; and
providing the contextual data to the translation system, wherein the current portion of the data stream is translated further based on the contextual data.

Example 4.4: The method of claim 3, further comprising:
generating a summary of one or more of the stored one or more portions of the data stream; and
providing the summary to the translation system, wherein the current portion of the data stream is translated further based on the summary.

Example 4.5: The method of claim 1, wherein the translation system is configured for sign language recognition or sign language generation.

Example 4.6: The method of claim 1, wherein the language data is sign language, audio, or text.

Example 4.7: The method of claim 1, wherein the language data is sign language and the one or more portions of the data stream include representations of sign language content in the data stream previously obtained and directed to the translation system.

Example 4.8: The method of claim 1, wherein the language data is audio and the one or more portions of the data stream include text representing words in the audio of the data stream previously obtained and directed to the translation system.

Example 4.9: The method of claim 1, wherein the translation system includes one or more machine learning models, and the one or more machine learning models are previously trained to translate the current portion of the data stream using stored portions of the data stream.

Example 5.1 includes a method comprising:
in response to a communication session not being established between a first communication device and a second communication device, obtaining an audio message from the first communication device;
storing the audio message;
after storing the audio message, generating, by an automated generation system that includes one or more first machine learning models, video that includes sign language content corresponding to the audio message;
storing the video; and
after storing the video, training one or more second machine learning models of an automated recognition system configured to translate sign language into language data using the video and language data from the audio message.

Example 5.2: The method of example 5.1, further comprising before training the automated recognition system, obtaining consent from at least one of a first user associated with the first communication device and a second user associated with the second communication device.

Example 5.3: The method of example 5.1, further comprising after storing the video, training one or more of the first machine learning models of the automated generation system using the video and the language data.

Example 5.4: The method of example 5.1, further comprising before obtaining the audio message, directing second audio to the first communication device.

Example 5.5: The method of example 5.4, wherein second audio is generated via an automated system to interact with a user of the first communication device.

Example 5.6: The method of example 5.1, wherein the video is generated in response to a request from a user associated with the second communication device to view the video.

Example 5.7: The method of example 5.1, further comprising transcribing the audio message using automated speech recognition to generate text corresponding to the sign language content, wherein the text is used to train the one or more second machine learning models.

Example 5.8: The method of example 5.1, further comprising:
storing a plurality of audio messages and corresponding videos that include the audio message and the video, each of the audio messages generated from a different communication session not being established;
determining which of the plurality of audio messages and corresponding videos is usable for training; and
training the one or more second machine learning models of the automated recognition system using the audio messages and corresponding videos determined to be usable for training.

Example 5.9: The method of claim 8, wherein a first audio message and corresponding first video is determined to be usable for training based on obtaining consent from one or more users associated with the first audio message.

Example 5.9: A method comprising:
in response to a communication session not being established between a first communication device and a second communication device, obtaining an audio message from the first communication device;
storing the audio message;
after storing the audio message, generating, by an automated generation system that includes one or more first machine learning models, video that includes sign language content corresponding to the audio message; and
storing the video.

An Example 6.1 includes a method comprising:
obtaining, at a system, audio during a communication session that includes a first device and a second device, the audio originating at the second device;
selecting, automatically and independently by the system based on one or more features of the communication session, a first translation process instead of a second translation process to translate between sign language and language data during the communication session; and
using the selected one of the first translation process and the second translation process to generate a video that includes sign language content based on the audio.

Example 6.2: The method of example 6.1, wherein the one or more features of the communication session include content of the audio of the communication session.

Example 6.3: The method of example 6.1, wherein the one or more features of the communication session include a number associated with the second device.

Example 6.4: The method of example 6.1, wherein each of the first translation process and the second translation process are further configured to generate second audio for directing to the second device based on a second video obtained from the first device that includes sign language content.

Example 6.5: The method of example 6.1, further comprising after utilizing the selected one of the first translation process and the second translation process for a first portion of the communication session, selecting the other one of the first translation process and the second translation process to translate between sign language and language data for a second portion of the communication session.

Example 6.6: The method of example 6.5, wherein the other one of the first translation process and the second translation process is selected based on changes to the audio in the communication session.

Example 6.7: The method of example 6.6, wherein the changes to the audio include the audio including silence or music.

Example 6.8: The method of example 6.6, wherein the changes to the audio include the audio including speech.

Example 6.9: The method of example 6.1, wherein the first translation process is fully automated, and the second translation process includes a third device configured to present video and audio to a user of the third device.

Example 7.1 includes a method comprising:
obtaining, at a device, video data that includes sign language content, the sign language content including a person performing sign language;
obtaining an indication of a subject matter of the sign language content;
directing the video data and context data to a sign language recognition system configured to generate translation data representative of the sign language content, the context data determined based on the indication of the subject matter of the sign language content and the sign language recognition system configured to adjust the generation of the translation data based on the received context data.

Example 8.1 includes a method comprising:
establishing, by a first device, a connection with a sign language recognition system;
directing a notification regarding the connection to a second device that is in the same location as the first device;
after directing the notification, directing video data that includes sign language content to the sign language recognition system, the sign language content including one or more frames of a person performing sign language;
generating, by the sign language recognition system, first communication data from the video data, the first communication data representing the sign language content in another communication form;
directing the first communication data to the second device for presentation of the first communication data by the second device;
in response to directing the first communication data, obtaining, at the sign language recognition system, audio data from the second device;
generating, by the sign language recognition system, second communication data from the audio data, the second communication data representing the audio data in another communication form; and
directing the second communication data to the first device for presentation by the first device of the second communication data.

As indicated above, the embodiments described herein may include the use of a special purpose or general-purpose computer (e.g., the processor 2210 of FIG. 22) including various computer hardware or software modules, as discussed in greater detail below. Further, as indicated above, embodiments described herein may be implemented using computer-readable media (e.g., the memory 2212 of FIG. 22) for carrying or having computer-executable instructions or data structures stored thereon.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations.” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first.” “second.” “third.” etc., are not necessarily used herein to connote a specific order or number of elements. Generally, the terms “first,” “second,” “third,” etc., are used to distinguish between different elements as generic identifiers. Absence a showing that the terms “first.” “second.” “third,” etc., connote a specific order, these terms should not be understood to connote a specific order. Furthermore, absence a showing that the terms first.” “second.” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

1. A method comprising:
obtaining a first video that includes sign language content, the sign language content including one or more video frames of a figure performing sign language;
obtaining language data that represents the sign language content in the first video;
extracting, from the first video, a spatial configuration for each of one or more body parts of the figure;
creating a second video including sign language content using the extracted spatial configurations; and
training a machine learning model of a translation system configured to translate between sign language and language data using the second video and the language data.

2. The method of claim 1, wherein creating the second video includes:
removing the spatial configurations related to a non-dominant hand of the figure; and
creating the second video using the remaining spatial configurations to define signs for the sign language content.

3. The method of claim 2, wherein the second video include one or more frames with a single hand performing sign language.

4. The method of claim 1, wherein creating the second video includes generating a second figure performing sign language using the extracted spatial configurations where the second figure is visibly distinct from the figure.

5. The method of claim 1, further comprising creating a plurality of second videos that include the second video, each of the plurality of second videos created to include sign language content using the extracted spatial configurations and each of the plurality of second videos including a figure that is visibly distinct from a figure in another of the second videos,
wherein the machine learning model is trained using each of the plurality of second videos and the language data.

6. The method of claim 1, wherein the translation system is configured for sign language recognition or sign language generation.

7. The method of claim 1, further comprising distorting the second video before training the machine learning model using the second video.

8. The method of claim 1, wherein the machine learning model is trained using the first video.

9. At least one non-transitory computer-readable media configured to store one or more instructions that, in response to being executed by a system, cause or direct the system to perform the method of claim 1.

10. A method comprising:
obtaining a first video that includes sign language content, the sign language content including one or more video frames of a figure performing sign language;
obtaining language data that represents the sign language content in the first video;
creating a second video including sign language content by altering the first video; and
training a machine learning model of a translation system configured to translate between sign language and language data using the second video and the language data.

11. The method of claim 10, wherein creating the second video includes removing a non-dominant hand of the figure in the second video.

12. The method of claim 10, wherein creating the second video includes moving a non-dominant hand of the figure in the second video to a neutral position.

13. The method of claim 10, further comprising extracting, from the first video, a spatial configuration for each of one or more body parts of the figure, wherein creating the second video includes generating a second figure performing sign language using the extracted spatial configurations where the second figure is visibly distinct from the figure.

14. The method of claim 10, wherein the translation system is configured for sign language recognition or sign language generation.

15. The method of claim 10, further comprising distorting the second video before training the machine learning model using the second video.

16. A system comprising:
one or more computer readable mediums including instructions;
one or more computing systems coupled to the one or more computer readable mediums and configured to execute the instructions to cause or direct the system to perform operations, the operations comprising:
obtaining a first video that includes sign language content, the sign language content including one or more video frames of a figure performing sign language;
obtaining language data that represents the sign language content in the first video;
creating a second video including sign language content by altering the first video; and
training a machine learning model of a translation system configured to translate between sign language and language data using the second video and the language data.

17. The system of claim 16, wherein creating the second video includes removing a non-dominant hand of the figure in the second video.

18. The system of claim 16, wherein creating the second video includes moving a non-dominant hand of the figure in the second video to a neutral position.

19. The system of claim 16, wherein the operations further comprise extracting, from the first video, a spatial configuration for each of one or more body parts of the figure, wherein creating the second video includes generating a second figure performing sign language using the extracted spatial configurations where the second figure is visibly distinct from the figure.

20. The system of claim 16, wherein the translation system is configured for sign language recognition or sign language generation.
